(19) United States
(12) Patent Application Publication
(10) Pub. No.: US 2007/0146740 A1
(43) Pub. Date: Jun. 28, 2007

(54) Printing method, printing apparatus, printing system and test pattern

(75) Inventor: Masahiko Yoshida, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: Seiko Epson Corporation, Nagano-ken (JP)

(21) Appl. No.: 10/576,493

(22) PCT Filed: Oct. 28, 2004
(86) PCT No.: PCT/JP04/16005

§ 371 Date: Apr. 20, 2006

(30) Foreign Application Priority Data
Oct. 31, 2003 (JP) 2003-373773
Jan. 6, 2004 (JP) 2004-001423

(51) Int. Cl. G06K 15/00

(52) U.S. Cl. 358/1.8; 358/1.12

(57) ABSTRACT

In accordance with the present invention, a printing method for printing an image onto a medium includes printing a correction pattern by ejecting ink from a plurality of nozzles moving in a predetermined movement direction and forming, in an intersecting direction intersecting the movement direction, a plurality of lines extending along the movement direction and constituted by a plurality of dots, measuring a darkness of the correction pattern line by line, and printing the image with a plurality of the lines formed in the intersecting direction, while correcting the darkness of each line in accordance with correction values each corresponding to the darkness of each of the measured lines.

### TECHNICAL FIELD

The present invention relates to printing methods, printing apparatuses, printing systems, and test patterns.

The present application claims priority upon Japanese Patent Application No. 2003-373773 filed on Oct. 31, 2003, and Japanese Patent Application No. 2004-001423 filed on Jan. 6, 2004, which are herein incorporated by reference.

### BACKGROUND ART

Inkjet printers that form dots by ejecting ink onto paper serving as a medium to form dots are known as printing apparatuses for printing images. Such printers alternately repeat a dot formation operation of forming dots on the paper by ejecting ink from a plurality of nozzles, which move in a predetermined movement direction, and a carrying operation of carrying the paper in an intersecting direction that intersects with the movement direction (hereinafter, also referred to as the “carrying direction”) by a carry unit. Thus, a plurality of raster lines made of a plurality of dots and extending along the movement direction are formed in the intersecting direction, thus printing an image. It should be noted that the carrying operation and the dot formation operation depend on the processing mode, and for different processing modes, also the combination of nozzles forming adjacent raster lines differs.

Now, with such a printer, darkness non-uniformities extending parallel to the movement direction can be occasionally observed in such images made of a multitude of raster lines. The reason for such darkness non-uniformities lies mainly in the machining precision of the nozzles. More specifically, there are two cases: the case of variations in the ink ejection amount among the nozzles, and the case that the positions at which dots are formed on paper by ejecting ink from the nozzles (referred to as “dot formation positions” in the following) deviate in the carrying direction from the target positions.

A conventional method for suppressing such darkness non-uniformities is to print one type of correction pattern, specify the nozzle causing the darkness non-uniformities by measuring the correction pattern with a darkness measurement device, and to adjust the amount of ink ejected from that nozzle so as to match that of the other nozzles when actually printing an image (see JP H6-166247A).

In this method, darkness data is correlated with the nozzles, so that it is possible to address the first case, namely the case of darkness non-uniformities caused by variations in the amount of ink ejected from the nozzles.

### DISCLOSURE OF INVENTION

### Problems to be Solved by the Invention

On the other hand, as shown in FIG. 25, the darkness non-uniformities due to the second case are caused by the fact that the spacing between the raster lines R made of a plurality of dots becomes periodically wider and narrower. That is to say, adjacent raster lines R with a wide spacing between them macroscopically appear light, whereas raster lines R with a narrow spacing between them macroscopically appear dark. Thus, the state of the spacing depends on the combination of nozzles forming the adjacent raster lines.

Therefore, this conventional method of correlating the nozzles with the darkness data of the correction pattern cannot address the darkness non-uniformities due to the second case.

The present invention has been devised in view of these problems.

### Means for Solving the Problems

In one aspect of the present invention, a printing method for printing an image onto a medium comprises:

printing a correction pattern by ejecting ink from a plurality of nozzles moving in a predetermined movement direction and forming, in an intersecting direction intersecting the movement direction, a plurality of lines extending along the movement direction and constituted by a plurality of dots;

measuring a darkness of the correction pattern line by line; and

printing the image with a plurality of the lines formed in the intersecting direction, while correcting the darkness of each line in accordance with correction values each corresponding to the darkness of each of the measured lines.

It should be noted that the present invention can also be viewed from other angles. Other features of the present invention will become clear through the accompanying drawings and the description of the present specification.

### BRIEF DESCRIPTION OF DRAWINGS

FIG. 1 is an explanatory diagram of the overall configuration of a printing system.

FIG. 2 is an explanatory diagram of processes carried out by a printer driver.

FIG. 3 is a flowchart of halftone processing through dithering.

FIG. 4 is a diagram showing a dot creation ratio table.

FIG. 5 is a diagram that shows how dots are to be judged on or off according to dithering.

FIG. 6A is a dither matrix used in determining large dots, and FIG. 6B is a dither matrix used in determining medium dots.

FIG. 7 is an explanatory diagram of a user interface of the printer driver.

FIG. 8 is a block diagram of the overall configuration of a printer.

FIG. 9 is a schematic view of the overall configuration of the printer.

FIG. 10 is a transverse sectional view of the overall configuration of the printer.

FIG. 11 is a flowchart of the processing during the printing operation.

FIG. 12 is an explanatory diagram showing the arrangement of nozzles.

FIG. 13 is an explanatory diagram of the drive circuit of a head unit.

FIG. 14 is a timing chart for explaining the various signals.

FIGS. 15A and 15B are explanatory diagrams of an interlaced mode.

FIG. 16 is a diagram showing the size relationship between the print region and a paper during bordered printing.

FIG. 17 is a diagram showing the size relationship between the print region and the paper during borderless printing.

FIGS. 18A to 18C are explanatory diagrams showing the positional relationship between grooves provided in the platen and the nozzles.

FIG. 19 is a first reference table showing the print modes corresponding to the various combinations between the margin format mode and the image quality mode.

FIG. 20 is a second reference table showing the processing modes corresponding to the various print modes.

FIG. 21A is a diagram illustrating the various processing modes.

FIG. 21B is a diagram illustrating the various processing modes.

FIG. 22A is a diagram illustrating the various processing modes.

FIG. 22B is a diagram illustrating the various processing modes.

FIG. 23A is a diagram illustrating the various processing modes. FIG. 23B is a diagram illustrating the various processing modes.

FIG. 24A is a diagram illustrating the various processing modes. FIG. 24B is a diagram illustrating the various processing modes.

FIG. 25 is a diagram illustrating the darkness non-uniformities that occur in a monochrome printed image.

FIG. 26 is a flowchart showing the overall procedure of the method for inhibiting darkness non-uniformities using a test pattern of the first embodiment.

FIG. 27 is a flowchart of Step S120 in FIG. 26.

FIG. 28 is a diagram showing a test pattern of the first embodiment.

FIG. 29A is a diagram showing by which of the nozzles the raster lines constituting the correction pattern are formed. FIG. 29B is a diagram showing by which of the nozzles the raster lines constituting the correction pattern are formed.

FIG. 30A is a cross-sectional view of a scanner, and FIG. 30B is a top view thereof.

FIG. 31 is a diagram illustrating an example of darkness correction values of a correction pattern.

FIG. 32 is a schematic diagram of a recording table.

FIGS. 33A to 33C show recording tables for the first upper edge processing mode, the first intermediate processing mode and the first lower edge processing mode, respectively.

FIG. 34 is a schematic diagram of a correction value table.

FIGS. 35A to 35C show correction value tables for the first upper edge processing mode, the first intermediate processing mode and the first lower edge processing mode, respectively.

FIG. 36 is a flowchart of Step S140 in FIG. 26.

FIG. 37 is a diagrammatic view showing an array of pixel data according to RGB image data.

FIG. 38 is a diagrammatic view showing an array of pixel data according to RGB image data.

FIG. 39 is a diagram showing a test pattern of a first specific example according to a second embodiment.

FIG. 40 is a diagram showing a recording table of the first specific example.

FIG. 41 is a graph for illustrating the linear interpolation that is carried out in the first specific example.

FIG. 42 is a diagram showing a test pattern of a second specific example according to a second embodiment.

FIG. 43 is a diagram showing a recording table of the second specific example.

FIG. 44 is a graph for illustrating the linear interpolation that is carried out in the second specific example.

### LIST OF REFERENCE NUMERALS

1 . . . printer,
20 . . . carry unit, 21 . . . paper supply roller, 22 . . . carry motor (PF motor),
23 . . . carry roller,
24 . . . platen, 24a, 24b . . . grooves, 24c, 24d . . . absorbing material,
25 . . . paper discharge roller,
30 . . . carriage unit, 31 . . . carriage,
32 . . . carriage motor (CR motor),
40 . . . head unit, 41 . . . head,
50 . . . sensor, 51 . . . linear encoder, 52 . . . rotary encoder,
53 . . . paper detection sensor, 54 . . . paper width sensor,
60 . . . controller, 61 . . . interface section, 62 . . . CPU,
63 . . . memory, 64 . . . unit control circuit,
644A . . . original drive signal generation section, 644B . . . drive signal shaping section,
100 . . . scanner, 101 . . . document, 102 . . . document glass,
104 . . . reading carriage, 106 . . . exposure lamp, 108 . . . linear sensor,
1100 . . . computer,
1200 . . . display device,
1300 . . . input devices, 1300A . . . keyboard, 1300B . . . mouse,
1400 . . . recording/reproducing devices,
1400A . . . flexible disk drive,
1400B . . . CD-ROM drive,
1000 . . . printing system,
1102 . . . video driver, 1104 . . . application program,
1110 . . . printer driver,
A . . . print region, Aa . . . abandonment region, S . . . paper,
CP, CPc, CPca, CPcb, CPcc . . . correction patterns,
CPm, CPma, CPmb, CPmc . . . correction patterns,
CPy, CPya, CPyb, CPyc . . . correction patterns,
CPk, CPka, CPkb, CPkc . . . correction patterns,
CP1, CP2, CP3 . . . correction patterns,
R, R1 to R137, r1 to r12 . . . raster lines
TP . . . test pattern

### BEST MODE FOR CARRYING OUT THE INVENTION

===Overview of the Disclosure===

1. A printing method for printing an image onto a medium, the method comprising:

printing a correction pattern by ejecting ink from a plurality of nozzles moving in a predetermined movement direction and forming, in an intersecting direction intersecting the movement direction, a plurality of lines extending along the movement direction and constituted by a plurality of dots;

measuring a darkness of the correction pattern line by line; and

printing the image with a plurality of the lines formed in the intersecting direction, while correcting the darkness of each line in accordance with correction values each corresponding to the darkness of each of the measured lines.

With this printing method, it is possible to effectively reduce variations in the darkness among lines, and to advantageously inhibit darkness non-uniformities.

In the foregoing printing method, it is preferable that a plurality of the lines are formed in the intersecting direction by repeating in alternation a dot formation operation of forming dots on the medium by ejecting ink from a plurality of the nozzles moving in the movement direction and a carrying operation of carrying the medium in the intersecting direction.

With this printing method, it is possible to effectively reduce variations in the darkness among lines, and to advantageously inhibit darkness non-uniformities.

In the foregoing printing method, it is preferable that:

a printing apparatus printing the image onto the medium,
includes a plurality of types of processing modes for respectively executing print processes in which at least one of the carrying operation and the dot formation operation differs;
prints, with at least two of the processing modes, a correction pattern corresponding to each of the processing modes on a medium, and has the correction values, which are obtained by measuring the darkness of the correction pattern line by line, in correspondence with each line; and

corrects the darkness of the image line by line, in accordance with the correction values corresponding to each line of the image, when printing the image in any of the processing modes with which the correction pattern was printed.

With this printing method, a correction pattern is printed for each of at least two processing modes, the darkness of each correction pattern is measured line by line, and thus, for each of the at least two processing modes, there is a darkness correction value for each line. Then, when printing the image using any of those at least two processing modes, the darkness of each line is corrected in accordance with the correction values corresponding to the lines of that image. Consequently, even in the case of printing an image in any of the at least two processing modes, the optimum correction values for each processing mode can be applied to each line of the image, so that the variations of the darkness between lines can be reduced effectively, and darkness non-uniformities can be advantageously inhibited.

In the foregoing printing method, it is preferable that the correction pattern corresponding to each of the processing modes is printed to fit on a single medium.

With this printing method, it is possible to save medium.

In the foregoing printing method, it is preferable that a plurality of the nozzles is lined up along the intersecting direction to constitute a nozzle row.

With this printing method, the nozzles are lined up in the intersecting direction, so that the range over which dots are formed by a single dot formation operation is broadened, and the printing time can be shortened.

In the foregoing printing method, it is preferable that:

a printing apparatus printing the image onto the medium comprises the nozzle row for each color of ink;

the correction value is prepared for each of the colors by printing the correction pattern for each of the colors; and

the darkness of the image is corrected color by color, based on the correction values for each of the colors.

With this printing method, a nozzle row is provided for each color of ink, so that it is possible to perform multi-color printing. Moreover, the darkness of the image is corrected for each color in accordance with the correction values of each color, so that it is possible to advantageously inhibit darkness non-uniformities of the image in multi-color printing.

In the foregoing printing method, it is preferable that the at least two processing modes include at least either a downstream edge processing mode for printing an image at an edge portion on a downstream side, with respect to the intersecting direction, of the medium, and an upstream edge processing mode for printing an image at an edge portion on an upstream side, with respect to the intersecting direction, of the medium.

With this printing method, it is possible to advantageously inhibit darkness non-uniformities of the image that is printed at an edge portion on a downstream side or an edge portion on an upstream side of the medium.

In the foregoing printing method, it is preferable that the downstream edge processing mode and the upstream edge processing mode respectively are modes for printing an image provided without a margin at the edge portion.

With this printing method, it is possible to advantageously inhibit darkness non-uniformities in images that are printed by so-called borderless printing, that is, without providing a margin at the edge portion on the downstream side or the edge portion on the upstream side of the medium.

In the foregoing printing method, it is preferable that the downstream edge processing mode and the upstream edge processing mode respectively include modes for printing an image provided with a margin at the edge portion.

With this printing method, it is possible to advantageously inhibit darkness non-uniformities in images that are printed by so-called bordered printing, that is, with a margin at the edge portion on the downstream side or the edge portion on the upstream side of the medium.

In the foregoing printing method, it is preferable that the correction pattern printed by the upstream edge processing mode is printed at the edge portion on the upstream side of the medium.

With this printing method, the correction pattern of the upstream edge processing mode for printing an image without providing a margin at the edge on the upstream side is actually printed at the edge on the upstream side of the medium. Consequently, the state of the darkness non-uniformities when actually printing on the medium can be accurately recreated on this correction pattern, and thus, it is possible to even more advantageously inhibit darkness non-uniformities that occur at the edge on the upstream side of the medium.

In the foregoing printing method, it is preferable that the correction pattern printed by the downstream edge processing mode is printed at the edge portion on the downstream side of the medium.

With this printing method, the correction pattern of the downstream edge processing mode for printing an image without providing a margin at the edge on the downstream side is actually printed at the edge on the downstream side of the medium. Consequently, the state of the darkness non-uniformities when actually printing on the medium can be accurately recreated on this correction pattern, and thus, it is possible to even more advantageously inhibit darkness non-uniformities that occur at the edge on the downstream side of the medium.

In the foregoing printing method, it is preferable that the at least two processing modes include an intermediate processing mode for printing an image on a portion between the edge portion on the upstream side of the medium and the edge portion on the downstream side of the medium with respect to the intersecting direction.

With this printing method, it is possible to advantageously inhibit darkness non-uniformities that occur at the portion between the edge on the upstream side and the edge on the downstream side of the medium.

In the foregoing printing method, it is preferable that the intermediate processing mode and at least one of the downstream edge processing mode and the upstream edge processing mode have a different carry amount in the carrying operation.

With this printing method, the carry amount of the carrying operation differs for the case of printing without providing a margin at the edge portions and the case of printing the portion besides the edge portions. Consequently, it is possible to apply so-called upper edge processing (corresponds to the downstream edge processing), lower edge processing (corresponds to the upstream edge processing) and intermediate processing used ordinarily for borderless printing.

In the foregoing printing method, it is preferable that there is also a correction value for a region that is judged to be further upstream than the edge portion on the upstream side, or for a region that is judged to be further downstream than the edge portion on the downstream side in the intersecting direction of the medium on which the image is printed; and

this correction value is obtained by arranging the medium at a position corresponding to the region, printing the correction pattern on this medium, and measuring the darkness of this correction pattern line by line.

With this printing method, there is also a correction value for a region that is judged to be further upstream than the edge portion on the upstream side, and for a region that is judged to be further downstream than the edge portion on the downstream side. Consequently, using this correction value, it is possible to correct the darkness line by line also in this region, and thus to reliably inhibit darkness non-uniformities that may occur at the edge portion during borderless printing.

In the foregoing printing method, it is preferable that ruled lines extending along the movement direction for specifying a line during the measurement when measuring the darkness of the correction pattern line by line are formed in the correction pattern at a predetermined spacing in the intersecting direction.

With this printing method, the ruled lines are used to specify lines during the measurement in the correction pattern. Consequently, it is possible to easily and reliably associate the lines with the correction values obtained by the measurement.

In the foregoing printing method, it is preferable that image data for printing the image is prepared, and the image data has a gradation value of the darkness for each dot formation unit formed on the medium;

if a correction value is not associated with the formation units,

then a creation ratio corresponding to the gradation value of the formation units is read from a creation ratio table in which gradation values are associated with dot creation ratios, and dots are formed in the formation units on the medium in accordance with the read creation ratio; and

if a correction value is associated with the formation units,

then when reading the creation ratio corresponding to the gradation value from the creation ratio table, the creation ratio corresponding to a value obtained by changing the gradation value by the correction value is read, and dots are formed in the formation units on the medium in accordance with the read creation ratio.

With this printing method, it is possible to print an image by forming dots in the formation units on the medium, in accordance with the image data. Moreover, a simplification of the configuration can be achieved, because the creation ratio table is used for both the image data with which a correction value is associated and the image data with which no correction value is associated.

In the foregoing printing method, it is preferable that:

image data for printing the image is prepared, and the image data has a gradation value of the darkness for each dot formation unit formed on the medium;

if a correction value is not associated with the formation units,

then a creation ratio corresponding to the gradation value of the formation units is read from a creation ratio table in which gradation values are associated with dot creation ratios, and dots are formed in the formation units on the medium in accordance with the read creation ratio; and

if a correction value is associated with the formation units,

then a dot creation ratio corresponding to the gradation value of the formation unit is read from a creation ratio table obtained by changing the creation ratio of the above-mentioned creation ratio table by the correction value, and dots are formed in the formation units on the medium in accordance with the read creation ratio.

With this printing method, the image can be printed by forming dots in each formation unit on the medium, in accordance with the image data. Moreover, the creation ratio table for the image data associated with correction values and the creation ratio table for the image data not associated with correction values are provided separately. Consequently, when converting the gradation value of the image data into the creation ratio, it is sufficient to read the creation ratio corresponding to the gradation value in the corresponding creation ratio table, and thus, it is possible to perform the processes in shorter time.

In the foregoing printing method, it is preferable that, the dot creation ratio indicates a proportion of a number of dots formed inside a region that has a uniform gradation value and that is provided with a predetermined number of the formation units, to that predetermined number.

With this printing method, it is possible to express the darkness of the image through the number of dots that are formed in that region.

In the foregoing printing method, it is preferable that all lines in the correction pattern are printed based on the same gradation value.

With such a printing apparatus, all lines are printed with the same gradation value, that is, lines that are adjacent in the intersecting direction are printed with the same gradation value. Consequently, darkness non-uniformities formed with those adjacent lines, for example darkness non-uniformities that become conspicuous due to a change in the spacing of these lines, can be accurately evaluated through this correction pattern.

In the foregoing printing method, it is preferable that an average value, across all lines, of darkness measurement values measured line by line is taken as a target value of darkness, and a correction ratio obtained by dividing a deviation between this target value and the darkness measurement value of each line by the target value is taken as the correction value.

With this printing method, it is possible to effectively reduce darkness variations among the lines.

In the foregoing printing method, it is preferable that the nozzles can form dots of a plurality of sizes, and the relation between the creation ratios and the gradation values is given for each of the sizes in the creation ratio table.

With such a printing apparatus, it is possible to express darkness through dots of a plurality of sizes, so that it is possible to express even finer images.

In the foregoing printing method, it is preferable that a darkness of the correction pattern is measured optically using a darkness measurement device.

With this printing method, the darkness is measured using a darkness measurement apparatus, so that it is possible to quantitatively evaluate the darkness, and to improve the reliability of the correction value.

In the foregoing printing method, it is preferable that the print processes in which the carrying operation differs from one another are print processes in which the pattern according to which the carry amount of each carrying operation changes is different from one another, and the print processes in which the dot formation operation differs from one another are print processes in which the pattern according to which the nozzles that is used in each dot formation operation changes is different from one another.

With this printing method, the processing mode differs for each change pattern of the carry amount, so that the correction pattern is printed for each of those change patterns, and then there is a correction value for each change pattern. Consequently, it is possible to respond to the change of the combination of nozzles forming adjacent lines, changing for each change pattern, and thus, it is possible to correct each line with the most suitable correction value.

Moreover, the processing mode differs for each change pattern of the nozzles that are used, so that the correction pattern is printed for each of those change patterns, and then there is a correction value for each change pattern. Consequently, it is possible to respond to the change of the combinations of nozzles forming adjacent lines, changing for each change pattern, and thus, it is possible to correct each line with the most suitable correction value.

With a printing method including all of the foregoing elements, substantially all of the abovementioned effects are attained, so that it is possible to attain the above-noted object in the most advantageous manner.

A printing apparatus printing an image onto a medium comprises:

nozzles for ejecting ink;

a carry unit for carrying the medium; and

a controller for making a plurality of the nozzles that move in a predetermined movement direction eject ink to form, in an intersecting direction, a plurality of lines extending along the movement direction and constituted by a plurality of dots, by performing in alternation a dot formation operation of forming dots on the medium and a carrying operation of carrying the medium with the carry unit in the intersecting direction intersecting the movement direction, to print an image, the controller printing the image by printing a correction pattern with a plurality of the lines formed in the intersecting direction, while correcting a darkness of each of the lines in accordance with correction values each corresponding to a darkness of each line in the correction pattern.

With this printing apparatus, it is possible to effectively reduce variations in the darkness among lines, and to advantageously inhibit darkness non-uniformities.

A printing system comprises:

a computer; and

a printing apparatus connected communicably to the computer; the printing apparatus including:
nozzles for ejecting ink;
a carry unit for carrying the medium; and
a controller for making a plurality of the nozzles that move in a predetermined movement direction eject ink to form, in an intersecting direction, a plurality of lines extending along the movement direction and constituted by a plurality of dots, by performing in alternation a dot formation operation of forming dots on the medium and a carrying operation of carrying the medium in an intersecting direction intersecting the movement direction with the carry unit, to print an image, the controller printing the image, by printing a correction pattern by forming a plurality of the lines in the intersecting direction, while correcting a darkness of each of the lines in accordance with the correction values each corresponding to a darkness of each line in the correction pattern.

With this printing system, it is possible to effectively reduce variations in the darkness among lines, and to advantageously inhibit darkness non-uniformities.

A test pattern comprising:

a correction pattern constituted by a plurality of lines;

wherein the correction pattern:
is printed on a medium by ejecting ink from a plurality of nozzles moving in a predetermined movement direction, by performing in alternation a dot formation operation of forming dots on the medium and a carrying operation of carrying the medium in an intersecting direction intersecting the movement direction, and forming, in the intersecting direction, a plurality of lines extending along the movement direction and constituted by a plurality of dots; and
a darkness of the correction pattern is measured line by line in order to obtain correction values each corresponding to the darkness of each line.

With this test pattern, it is possible to effectively reduce variations in the darkness among lines, and to advantageously inhibit darkness non-uniformities.

===Configuration of the Printing System===

Referring to the drawings, the following is an explanation of a printing system for which a test pattern can be used. It should be noted that this test pattern is used to suppress darkness non-uniformities in the image printed by this printing system. A method for suppressing such darkness non-uniformities is explained further below.

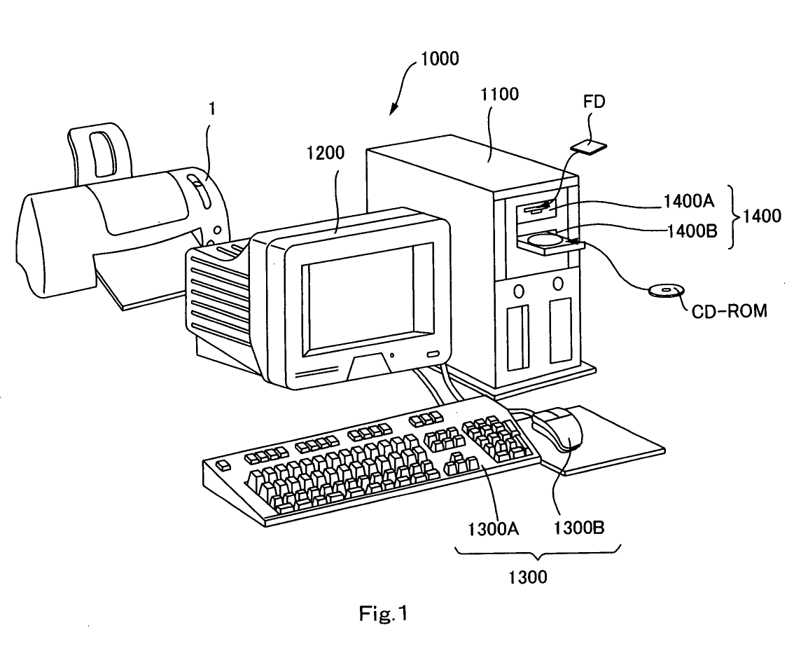

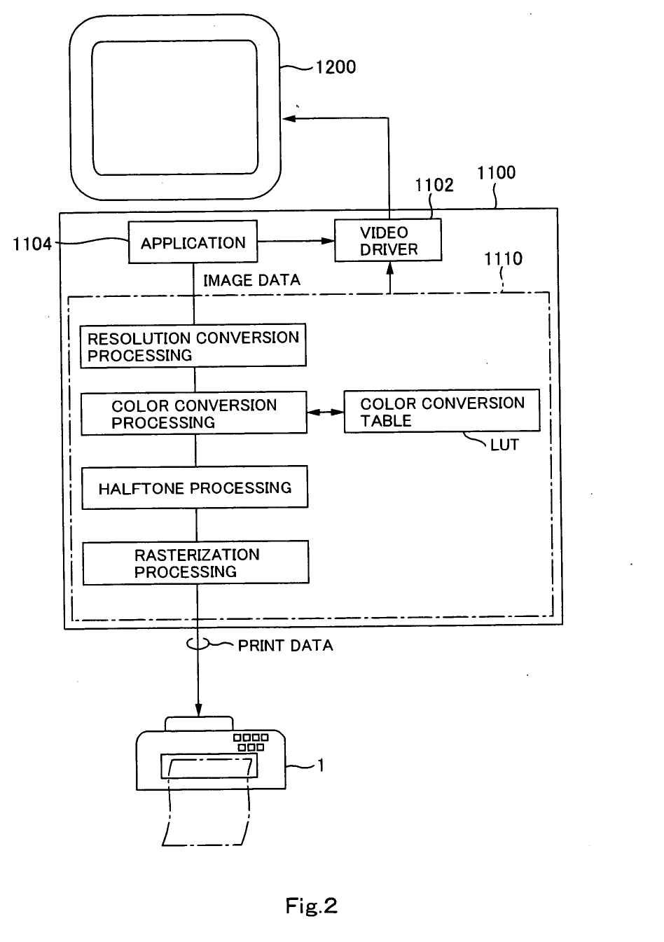

FIG. 1 is an explanatory diagram showing the external structure of the printing system. A printing system 1000 is provided with a printer 1, a computer 1100, a display device 1200, input devices 1300, and recording/reproducing devices 1400. The printer 1 is a printing apparatus for printing images on a medium such as paper, cloth, or film. The computer 1100 is communicably connected to the printer 1, and outputs print data corresponding to an image to be printed to the printer 1 in order to print the image with the printer 1. The display device 1200 has a display, and displays a user interface such as an application program or a printer driver 1110 (see FIG. 2). The input devices 1300 are for example a keyboard 1300A and a mouse 1300B, and are used to operate the application program or adjust the settings of the printer driver 1110, for example, through the user interface that is displayed on the display device 1200. A flexible disk drive 1400A and a CD-ROM drive 1400B can be employed as the recording/reproducing devices 1400, for example.

The printer driver 1110 is installed on the computer 1100. The printer driver 1110 is a program for achieving the function of displaying the user interface on the display device 1200, and the function of converting image data that has been output from the application program into print data. The printer driver 1110 is recorded on a recording medium (computer-readable recording medium) such as a flexible disk FD or a CD-ROM. The printer driver 1110 can also be downloaded onto the computer 1100 via the Internet. It should be noted that this program is made of code for achieving various functions.

It should be noted that “printing apparatus” in a narrow sense means the printer 1, but in a broader sense it means the system constituted by the printer 1 and the computer 1100.

===Printer Driver===

<Regarding the Printer Driver>

FIG. 2 is a schematic explanatory diagram of the basic processes carried out by the printer driver 1110. Structural elements that have already been described are assigned identical reference numerals and thus their further description is omitted.

On the computer 1100, computer programs such as a video driver 1102, an application program 1104, and a printer driver 1110 operate under an operating system installed on the computer. The video driver 1102 has the function of displaying, for example, the user interface on the display device 1200 in accordance with display commands from the application program 1104 and the printer driver 1110. The application program 1104, for example, has a function for image editing or the like and creates data related to an image (image data). A user can give an instruction to print an image edited with the application program 1104 via the user interface of the application program 1104. Upon receiving the print instruction, the application program 1104 outputs the image data to the printer driver 1110.

The printer driver 1110 receives the image data from the application program 1104, converts the image data into print data, and outputs the print data to the printer 1. The image data has pixel data as the data for the pixels of the image to be printed. The gradation values of the pixel data are then converted in accordance with the later-described processing stages, and are ultimately converted at the print data stage into data for the dots to be formed on the paper (data such as the color and the size of the dots). It should be noted that “pixels” are virtual square boxes on the paper to be printed that define the positions where the ink lands to form dots. The pixels correspond to the “dot formation units” in the claims.

Print data is data in a format that can be interpreted by the printer 1, and includes the pixel data and various command data. Here, “command data” refers to data for instructing the printer 1 to carry out a specific operation, and is data indicating the carry amount, for example.

In order to convert the image data that is output from the application program 1104 into print data, the printer driver 1110 carries out such processes as resolution conversion, color conversion, halftoning, and rasterization. The following is a description of the processes carried out by the printer driver 1110.

Resolution conversion is a process for converting image data (text data, image data, etc.) output from the application program 1104 to the resolution for printing an image on paper (that is, the spacing between dots when printing; also referred to as “print resolution”). For example, when the print resolution has been specified as 720×720 dpi, then the image data obtained from the application program 1104 is converted into image data having a resolution of 720×720 dpi.

In this conversion method, for example, if the resolution of the image data is lower than the specified print resolution, then new pixel data is generated between adjacent pixel data by linear interpolation, whereas if the resolution is higher than the specified print resolution, then pixel data is culled at a constant ratio, thus adjusting the resolution of the image data to the print resolution.

Also, in this resolution conversion process, the size of the print region, which is the region onto which ink is actually ejected, is adjusted based on the image data. This size adjustment is performed by trimming, for example, the pixel data that corresponds to the edge portions of the paper in the image data, in accordance with the margin format mode, the image quality mode, and the paper size mode, which are described later.

It should be noted that the pixel data in the image data has gradation values of many levels (for example, 256 levels) expressed in RGB color space. The pixel data having such RGB gradation values is hereinafter referred to as “RGB pixel data,” and the image data made of this RGB pixel data is referred to as “RGB image data.”

Color conversion processing is processing for converting the RGB pixel data of the RGB image data into data having gradation values of many levels (for example, 256 levels) expressed in CMYK color space. C, M, Y and K are the ink colors of the printer 1. Hereinafter, the pixel data having CMYK gradation values is referred to as CMYK pixel data, and the image data made of this CMYK pixel data is referred to as CMYK image data. Color conversion processing is carried out by the printer driver 1110, with reference to a table that correlates RGB gradation values and CMYK gradation values (color conversion lookup table LUT).

Halftone processing is processing for converting CMYK pixel data having many gradation values into CMYK pixel data having few gradation values, which can be expressed by the printer 1. For example, through halftone processing, CMYK pixel data representing 256 gradation values is converted into 2-bit CMYK pixel data representing four gradation values. The 2-bit CMYK image data indicates, for example, “no dot formation,” “small dot formation,” “medium dot formation,” and “large dot formation” for each color.

Dithering or the like is used for such a halftone processing to create 2-bit CMYK pixel data with which the printer 1 can form dispersed dots. Halftone processing through dithering is described later. It should be noted that the method used for halftone processing is not limited to dithering, and it is also possible to use gamma-correction or error diffusion or the like.

Rasterization is processing for changing the CMYK image data that has been subjected to halftone processing into the data order in which it is to be transferred to the printer 1. Data that has been rasterized is output to the printer 1 as print data.

<Halftone Processing Through Dithering>

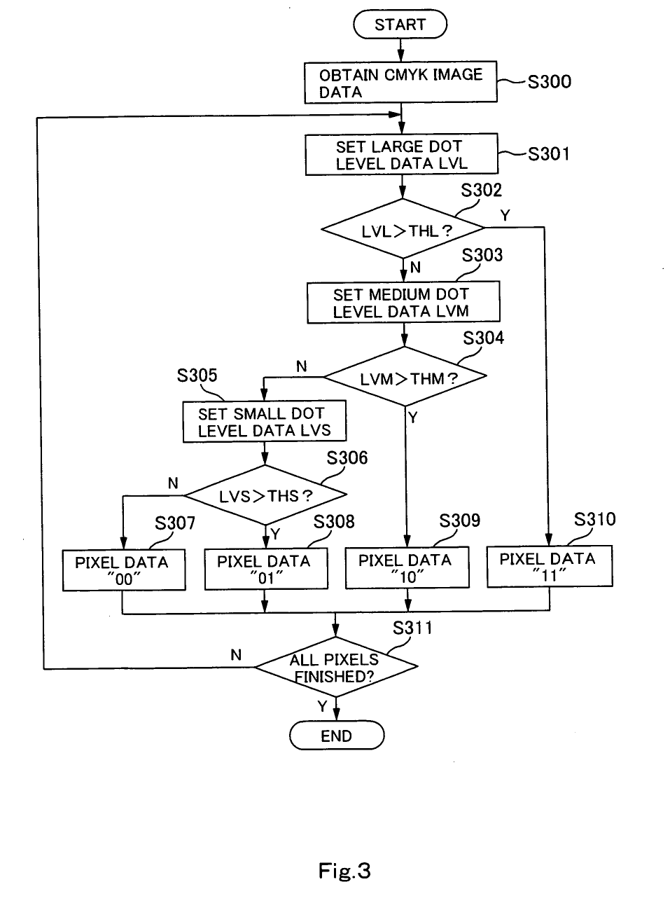

Here, halftone processing through dithering is described in more detail. FIG. 3 is a flowchart of halftone processing through dithering. The following steps are executed in accordance with this flowchart.

First, in Step S300, the printer driver 1110 obtains the CMYK image data. The CMYK image data is made of image data expressed by 256 gradation values for each ink color C, M, Y, and K. In other words, the CMYK image data includes C image data for cyan (C), M image data for magenta (M), Y image data for yellow (Y), and K image data for black (K). This C, M, Y, and K image data is respectively made of C, M, Y, and K pixel data indicating the gradation values of that ink color.

It should be noted that the following description can be applied to any of the C, M, Y, and K image data, and thus the K image data is described as a representative example.

The printer driver 1110 performs the processing of the steps S301 to S311 for all of the K pixel data in the K image data while successively changing the K image data to be processed, and converts the K image data into 2-bit data representing one of “no dot formation,” “small dot formation,” “medium dot formation” and “large dot formation” mentioned above.

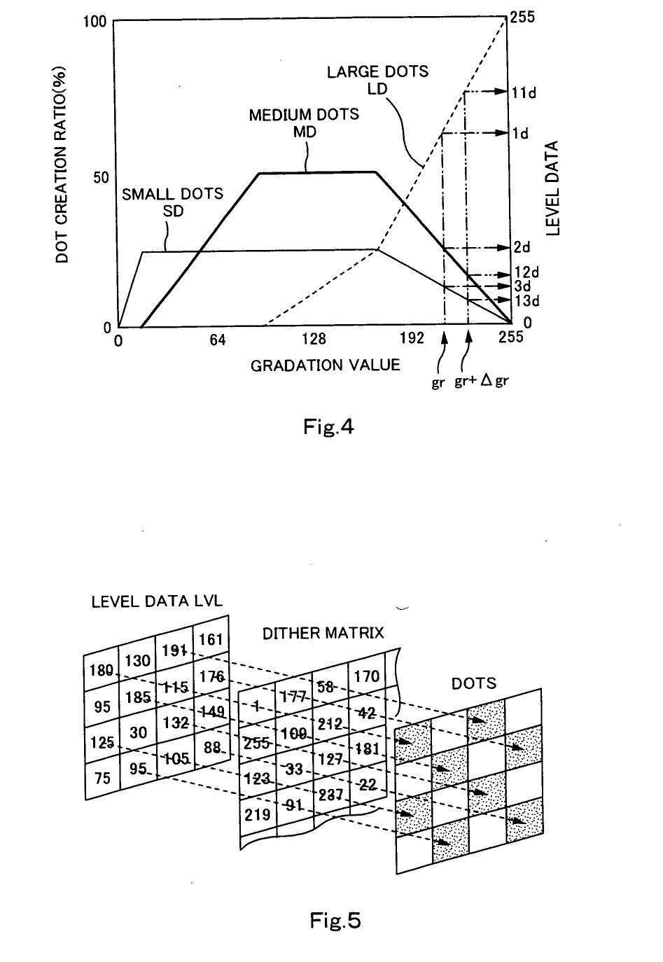

More specifically, first, in Step 301, the large dot level data LVL is set as follows, in accordance with the gradation value of the K pixel data being processed. FIG. 4 is a diagram showing a creation ratio table that is used for setting the level data for large, medium, and small dots. The horizontal axis in this diagram is the gradation value (0-255), the vertical axis on the left is the dot creation ratio (%), and the vertical axis on right is the level data (0-255). Here, the “dot creation ratio” means the proportion of pixels in which dots are formed among all the pixels in a uniform region reproduced with a constant gradation value. The profile SD shown by the thin solid line in FIG. 4 indicates the creation ratio of small dots, the profile MD shown by the thick solid line indicates the creation ratio of medium dots, and the profile LD shown by the dashed line indicates the creation ratio of large dots. Moreover, “level data” refers to data that is obtained by converting the dot creation ratio into 256 gradation values ranging from 0 to 255.

That is to say, in Step S301, the level data LVL corresponding to the gradation value is read from the profile LD for large dots. For example, as shown in FIG. 4, if the gradation value of the K pixel data to be processed is gr, then the level data LVL is determined to be 1d using the profile LD. In practice, the profile LD is stored in form of a one-dimensional table in a memory (not shown) such as a ROM within the computer 1100, and the printer driver 1110 determines the level data by referencing this table.

In Step S302, it is then determined whether or not the level data LVL that has been set like this is larger than a threshold value THL. Here, determination of whether the dots are on or off is performed using dithering. The threshold value THL is set to a different value for each pixel block of a so-called dither matrix. This embodiment uses a matrix in which the values from 0 to 254 appear in the fields of a 16×16 square pixel block.

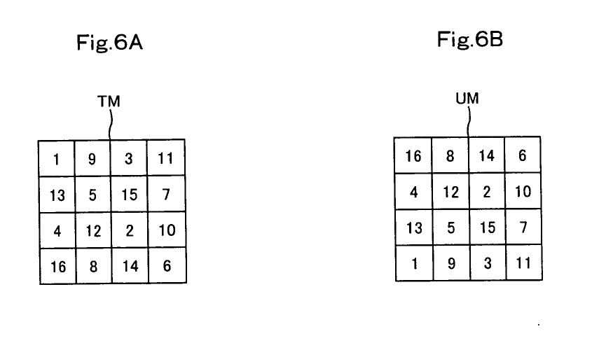

FIG. 5 is a diagram that shows how dots are to be judged on or off according to dithering. For the sake of illustration, FIG. 5 shows only some of the K pixel data. First, as shown in the figure, the level data LVL of the K pixel data is compared with the threshold value THL of the pixel block on the dither matrix that corresponds to that K pixel data.

Then, if the level data LVL is larger than the threshold value THL, the dot is set to on, and if the level data LVL is smaller, the dot is set to off. The hatched pixel data in the figure indicates K pixel data in which the dot is set to on. In other words, in Step S302, if the level data LVL is larger than the threshold value THL, then the procedure advances to Step S310, and otherwise the procedure advances to Step S303. Here, if the procedure advances to Step S310, then the printer driver 1110 assigns the binary value of “11” indicating that the pixel data represents a large dot to the K pixel data being processed and stores this value, and then the procedure advances to Step S311. Then, in Step 311, it is determined whether or not all of the K pixel data has been processed. If the processing is finished, then the halftone processing is ended, and if processing is not finished, then the processing shifts to the K pixel data that has not yet been processed, and the procedure returns to Step S301.

On the other hand, if the procedure advances to Step S303, then the printer driver 1110 sets the level data LVM for medium dots. The level data LVM for medium dots is set by the creation ratio table noted above, based on the gradation value. The setting method is the same as for setting the level data LVL of large dots. That is to say, in the example shown in FIG. 4, the level data LVM is determined to be 2d.

Then, in Step S304, it is judged whether the medium dots are on or of f by comparing the level data LVM of the medium dots with the threshold value THM. The method for determining whether the dots are on or off is the same as that for the large dots. However, the threshold value THM that is used in the judgment is a value that is different from the threshold value THL used in the case of the large dots as shown below. That is, if the dots are determined to be on or off using the same dither matrix for the large dots and the medium dots, then the pixel blocks where the dots are likely to be on will be the same in both cases. That is, there is a high possibility that when a large dot is off, the medium dot will also be off. As a result, there is a risk that the creation ratio of medium dots will be lower than the desired creation ratio. In order to avert this problem, in the present embodiment, different dither matrixes are used for the two. That is, by changing the pixel blocks that tend to be on for the large dots and the medium dots, it is possible to ensure that the large dots and the medium dots are formed appropriately.

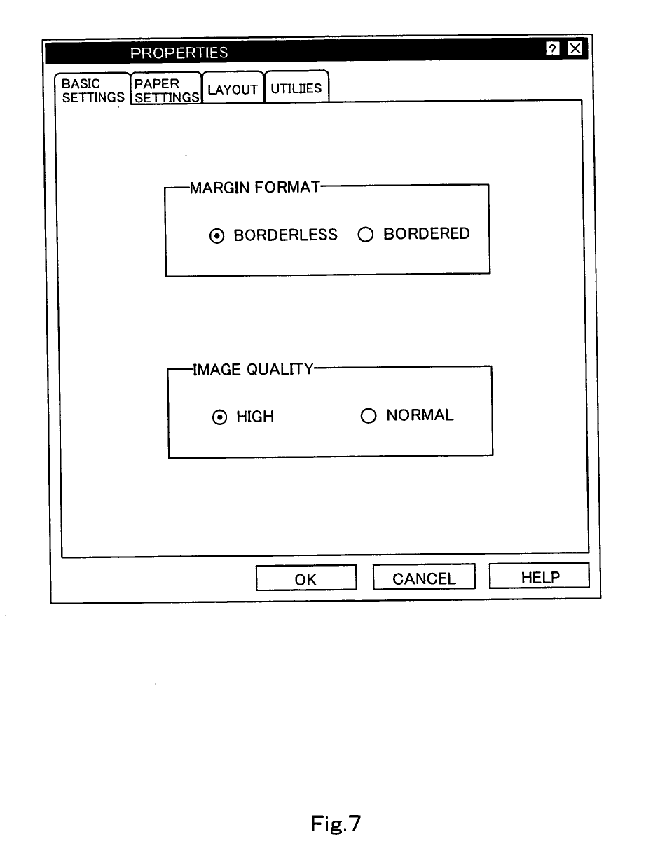

FIG. 6A and FIG. 6B show the relationship between the dither matrix that is used for assessing large dots and the dither matrix that is used for assessing medium dots. In this embodiment, a first dither matrix TM as shown in FIG. 6A is used for the large dots, and a second dither matrix UM as shown in FIG. 6B, which is obtained by mirroring these threshold values symmetrically at the center in the carrying direction, is used for the medium dots. As explained previously, the present embodiment uses a 16×16 matrix, but for convenience of illustration, FIG. 6 shows a 4×4 matrix. It should be noted that it is also possible to use large dot dither matrixes and medium dot dither matrixes that are completely different.

Then, in Step S304, if the medium dot level data LVM is larger than the medium dot threshold value THM, then it is determined that the medium dot should be on, and the procedure advances to Step S309, and otherwise the procedure advances to Step S305. Here, if the procedure advances to Step S309, then the printer driver 1110 assigns the binary value of “10” indicating that the pixel data represents a medium dot to the K pixel data being processed and stores this value, and then the procedure advances to Step S311. Then, in Step 311, it is determined whether or not all of the K pixel data has been processed. If the processing is finished, then the halftone processing is ended, and if processing is not finished, then the processing shifts to the K pixel data that has not yet been processed, and the procedure returns to Step S301.

On the other hand, if the procedure advances to Step S305, then the small dot level data LVS is set in the same way that the level data of the large dots and the medium dots is set. The dither matrix for the small dots is preferably different from those for the medium dots and the large dots, in order to prevent a drop in the creation ratio of small dots as discussed above.

In Step S306, if the level data LVS is larger than the threshold value THS for small dots, then the printer driver 1110 advances to Step S308, and otherwise it advances to Step S307. Here, if the procedure advances to Step S308, then a binary value of “01” for pixel data that indicates a small dot is assigned to the K pixel data being processed and this value is stored, and then the procedure advances to Step S311. Then, in Step 311, it is determined whether or not all of the K pixel data has been processed. If processing is not finished, then the processing shifts to the K pixel data that has not yet been processed, and the procedure returns to Step S301. On the other hand, if processing is finished, then halftone processing for the K image data is ended, and halftone processing is performed in the same manner for the image data of the other colors.

If, on the other hand, the procedure has advanced to Step S307, then the printer driver 1110 assigns a binary value of “00” indicating the absence of a dot to the K pixel data being processed and stores this value. Then the procedure advances to Step S311. Then, in Step 311, it is determined whether or not all of the K pixel data has been processed. If processing is not finished, then the processing shifts to the K pixel data that has not yet been processed, and the procedure returns to Step S301. On the other hand, if processing is finished, then halftone processing for the K image data is ended, and halftone processing is performed in the same way for the image data of the other colors.

<Regarding the Settings of the Printer Driver>

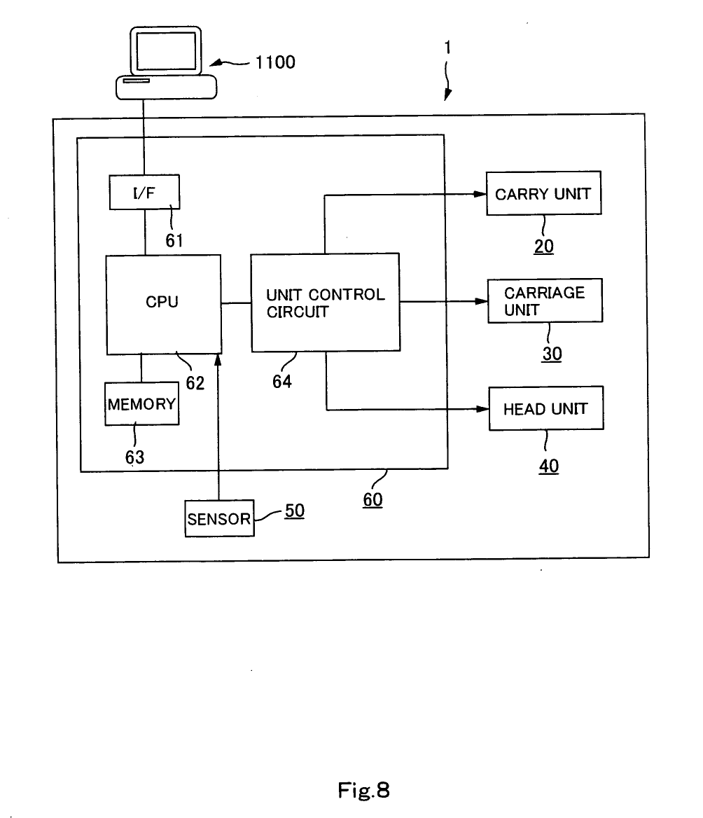

FIG. 7 is an explanatory diagram of the user interface of the printer driver 1110. The user interface of the printer driver 1110 is displayed on a display device via the video driver 1102. The user can use the input device 1300 to change the various settings of the printer driver 1110. The settings for margin format mode and image quality mode are prearranged as the basic settings, and settings such as paper size mode are prearranged as the paper settings. These modes are described later.

===Configuration of the Printer===

<Regarding the Configuration of the Inkjet Printer>

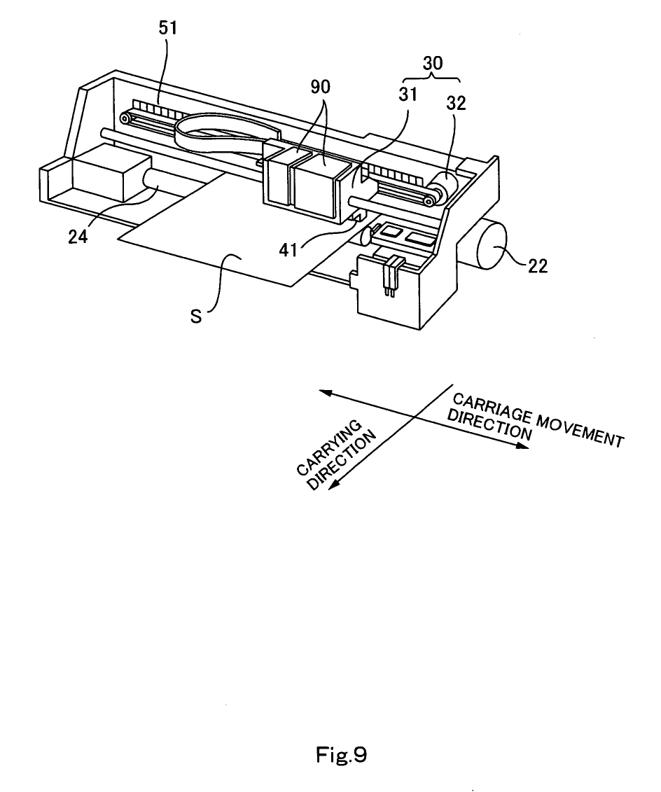

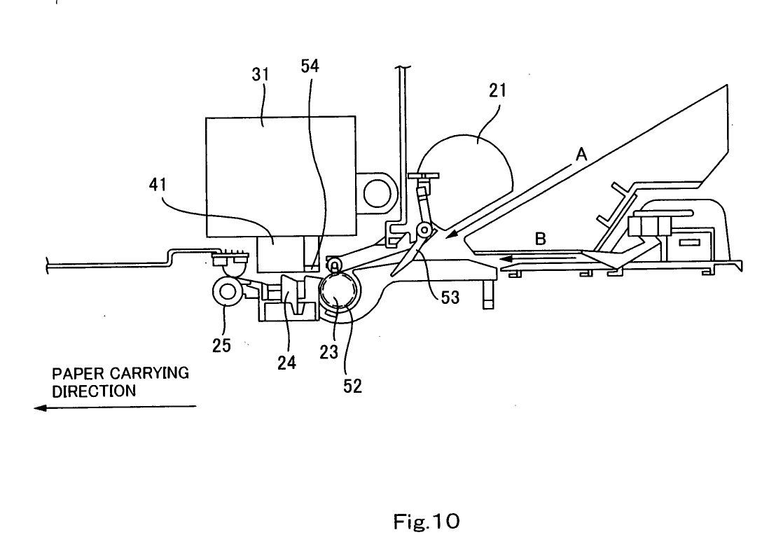

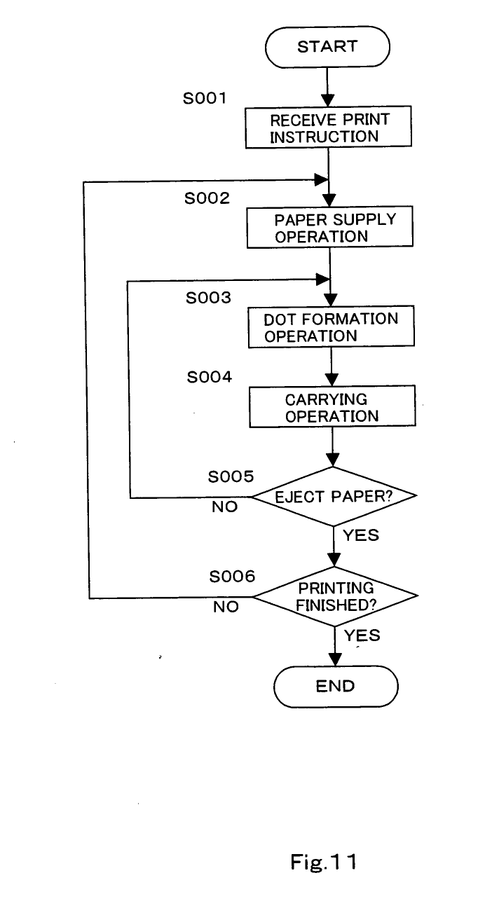

FIG. 8 is a block diagram of the overall configuration of the printer of this embodiment. Also, FIG. 9 is a schematic diagram of the overall configuration of the printer of this embodiment. FIG. 10 is lateral sectional view of the overall configuration of the printer of this embodiment. The basic structure of the printer according to the present embodiment is described below.

The inkjet printer 1 of this embodiment has a carry unit 20, a carriage unit 30, a head unit 40, a sensor 50, and a controller 60. The printer 1, which receives print data from the computer 1100, which is an external device, controls the various units (the carry unit 20, the carriage unit 30, and the head unit 40) using the controller 60. The controller 60 controls the units in accordance with the print data that is received from the computer 1100 to form an image on a paper. The sensor 50 monitors the conditions within the printer 1, and outputs the results of this detection to the controller 60. The controller receives the detection results from the sensor, and controls the units based on these detection results.

The carry unit 20 is for feeding a medium (for example, paper S) into a printable position and carrying the paper in a predetermined direction (hereinafter, referred to as the carrying direction) by a predetermined carry amount during printing. The carry unit 20 has a paper supply roller 21, a carry motor 22 (hereinafter referred to as PF motor), a carry roller 23, a platen 24, and a paper discharge roller 25. The paper supply roller 21 is a roller for automatically supplying paper that has been inserted into a paper insert opening to the printer 1. The paper supply roller 21 has a cross-sectional shape in the shape of the letter D, and the length of its circumference section is set longer than the carrying distance to the carry roller 23, so that the paper can be carried up to the carry roller 23 using this circumference section. The carry motor 22 is a motor for carrying paper in the carrying direction, and is constituted by a DC motor. The carry roller 23 is a roller for carrying the paper S that has been supplied by the paper supply roller 21 up to a printable region, and is driven by the carry motor 22. The platen 24 supports the paper S during printing. The paper discharge roller 25 is a roller for discharging the paper S, on which printing has finished, from the printer 1. The paper discharge roller 25 is rotated in synchronization with the carry roller 23.

The carriage unit 30 is provided with a carriage 31 and a carriage motor 32 (hereinafter, also referred to as “CR motor”). The carriage motor 32 is a motor for moving the carriage 31 back and forth in a predetermined direction (hereinafter, this is also referred to as the “carriage movement direction”), and is constituted by a DC motor. A later-described head 41 is held by the carriage 31. Thus, also this head 41 can be moved back and forth in the carriage movement direction by moving the carriage 31 back and forth. The carriage 31 detachably retains an ink cartridge containing ink. Note that the carriage movement direction corresponds to the “movement direction” in the claims.

The head unit 40 is for ejecting ink onto paper. The head unit 40 has the above-mentioned head 41, which includes a plurality of nozzles, and ejects ink intermittently from these nozzles. When the head 41 is moved in the carriage movement direction by moving the carriage 31, raster lines made of dots and extending in the carriage movement direction are formed on the paper by intermittently ejecting ink while moving. Note that these raster lines correspond to the “lines” in the claims.

The sensor 50 includes a linear encoder 51, a rotary encoder 52, a paper detection sensor 53, and a paper width sensor 54, for example. The linear encoder 51 is for detecting the position of the carriage 31 in the carriage movement direction. The rotary encoder 52 is for detecting the amount of rotation of the carry roller 23. The paper detection sensor 53 is for detecting the position of the front edge of the paper to be printed. The paper detection sensor 53 is provided in a position where it can detect the position of the front edge of the paper as the paper is being fed toward the carry roller 23 by the paper supply roller 21. It should be noted that the paper detection sensor 53 is a mechanical sensor that detects the front edge of the paper through a mechanical mechanism. More specifically, the paper detection sensor 53 has a lever that can be rotated in the paper carrying direction, and this lever is arranged so that it protrudes into the path over which the paper is carried. In this way, the front edge of the paper comes into contact with the lever and the lever is rotated, and thus the paper detection sensor 53 detects the position of the front edge of the paper by detecting the movement of the lever. The paper width sensor 54 is attached to the carriage 31. The paper width sensor 54 is an optical sensor and detects whether or not paper is present by its light-receiving section detecting reflected light of the light that has been irradiated onto the paper from the light-emitting section. The paper width sensor 54 detects the positions of the edges of the paper while being moved by the carriage 41, so as to detect the width of the paper.

The controller 60 is a control unit for carrying out control of the printer 1. The controller 60 has an interface section 61, a CPU 62, a memory 63, and a unit control circuit 64. The interface section 61 is for exchanging data between the computer 1100, which is an external device, and the printer 1. The CPU 62 is an arithmetic processing device for carrying out overall control of the printer 1. The memory 63 is for ensuring a working region and a region for storing the programs for the CPU 62, for instance, and includes storage means such as a RAM, an EEPROM, or a ROM. The CPU 62 controls the various units via the unit control circuit 64 in accordance with programs stored in the memory 63.

<Regarding the Printing Operation>

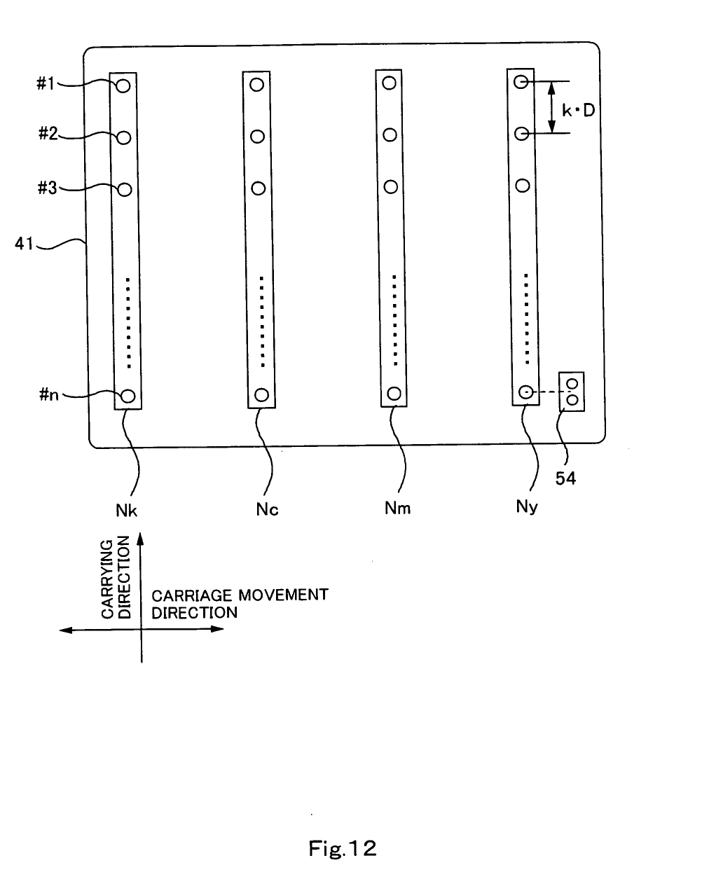

FIG. 11 is a flowchart of the operation during printing. The various operations that are described below are achieved by the controller 60 controlling the various units in accordance with a program stored in the memory 63. This program includes code for executing the various processes.

Receive Print Command (S001): The controller 60 receives a print command via the interface section 61 from the computer 1100. This print command is included in the header of the print data transmitted from the computer 1100. The controller 60 then analyzes the content of the various commands included in the print data that are received and uses the various units to perform the following paper supply operation, carrying operation, and dot formation operation, for example.

Paper Supply Operation (S002): First, the controller 60 performs the paper supply operation. The paper supply operation is a process for supplying paper to be printed into the printer 1 and positioning the paper at a print start position (also referred to as the “indexing position”). The controller 60 rotates the paper supply roller 21 to feed the paper to be printed up to the carry roller 23. The controller 60 rotates the carry roller 23 to position the paper that has been fed from the paper supply roller 21 at the print start position. When the paper has been positioned at the print start position, at least some of the nozzles of the head 41 are in opposition to the paper.

Dot Formation Operation (S003): Next, the controller 60 performs the dot formation operation. The dot formation operation is an operation of intermittently ejecting ink from the head 41 moving in the carriage movement direction, so as to form dots on the paper. The controller 60 drives the carriage motor 32 to move the carriage 31 in the carriage movement direction. Then, the controller 60 causes ink to be ejected from the head 41 in accordance with the print data while the carriage 31 is moving. Dots are formed on the paper when ink ejected from the head 41 lands on the paper.

Carrying Operation (S004): Next, the controller 60 performs the carrying operation. The carrying operation is a process for moving the paper relative to the head 41 in the carrying direction. The controller 60 drives the carry motor to rotate the carry roller and carry the paper in the carrying direction. Through this carrying operation, the head 41 becomes able to form dots at positions that are different from the positions of the dots formed in the preceding dot formation operation.

Paper Discharge Judgment (S005): Next, the controller 60 determines whether or not to discharge the paper that is being printed. The paper is not discharged if there is still data for printing the paper that is being printed. Then, the controller 60 repeats in alternation the dot formation operation and the carrying operation until there is no longer any data for printing, gradually printing an image made of dots on the paper. When there is no longer any data for printing the paper that is being printed, the controller 60 discharges that paper. The controller 60 discharges the printed paper to the outside by rotating the paper discharge roller. It should be noted that whether or not to discharge the paper can also be determined based on a paper discharge command included in the print data.

Judgment Whether Printing is Finished (S006): Next, the controller 60 determines whether or not to continue printing. If the next sheet of paper is to be printed, then printing is continued and the paper supply operation for the next sheet of paper is started. If the next sheet of paper is not to be printed, then the printing operation is finished.

<Regarding the Configuration of the Head>

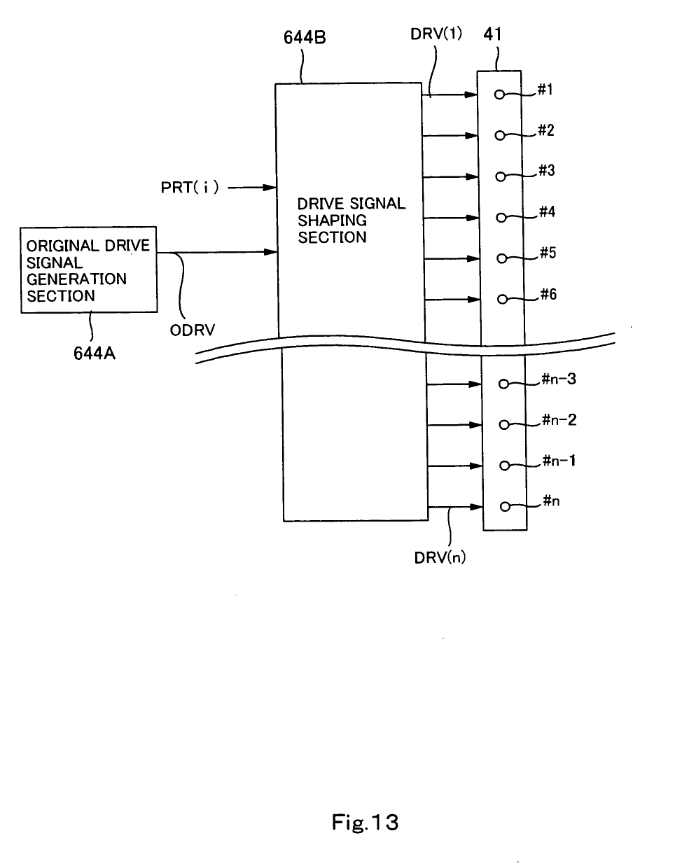

FIG. 12 is an explanatory diagram showing the arrangement of the nozzles in the lower surface of the head 41. A black ink nozzle row Nk, a cyan ink nozzle row Nc, a magenta ink nozzle row Nm, and a yellow ink nozzle row Ny are formed in the lower surface of the head 41. Each nozzle row is provided with n (for example, n=180) nozzles, which are ejection openings for ejecting the inks of various colors.

The plurality of nozzles of the nozzle rows are arranged in a row at a constant spacing (nozzle pitch: k·D) in the carrying direction. Here, D is the minimum dot pitch in the carrying direction (that is, the spacing at the highest resolution of the dots formed on the paper S). Also, k is an integer of 1 or more. For example, if the nozzle pitch is 180 dpi ( 1/180 inch), and the dot pitch in the carrying direction is 720 dpi ( 1/720), then k=4.

The nozzles of the nozzle rows are each assigned a number (#1 to #n) that becomes smaller the more downstream the nozzle is located. That is, the nozzle #1 is positioned more downstream in the carrying direction than the nozzle #n. Each nozzle is provided with a piezo element (not shown) as a drive element for driving the nozzle and letting it eject ink droplets.

<Regarding the Driving of the Head>

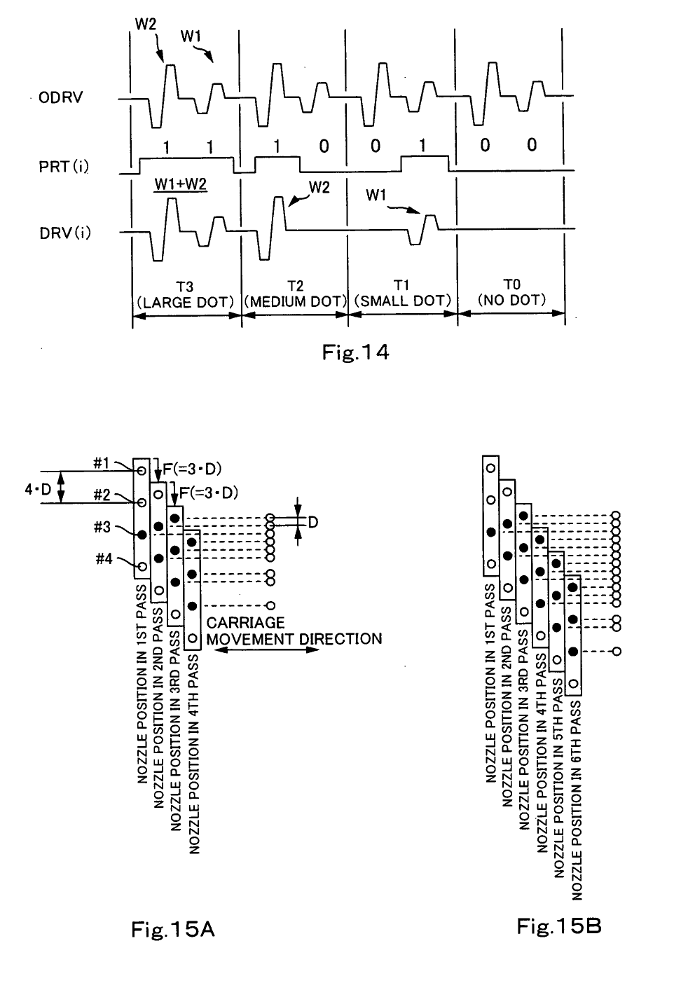

FIG. 13 is an explanatory diagram of the drive circuit of the head unit 40. This drive circuit is provided within the unit control circuit 64 mentioned earlier, and as shown in the drawing, it is provided with an original drive signal generation section 644A and a drive signal shaping section 644B. In this embodiment, a drive circuit for these nozzles #1 to #n is provided for each nozzle row, that is, for each nozzle row of the colors black (K), cyan (C), magenta (M), and yellow (Y), such that the piezo elements are driven individually for each nozzle row. The number in parentheses at the end of the name of each of the signals in the diagram indicates the number of the nozzle to which that signal is supplied.

When a voltage of a predetermined duration is applied between electrodes provided at both ends of the piezo elements, the piezo elements expand for the duration of voltage application and deform a lateral wall of the ink channel. As a result, the volume of the ink channel shrinks in accordance with the expansion of the piezo elements, and an amount of ink that corresponds to this shrinkage is ejected from the nozzles #1 to #n of the various colors as ink droplets.

The original drive signal generation section 644A generates an original drive signal ODRV that is shared by the nozzles #1 to #n. The original drive signal ODRV is a signal that includes a plurality of pulses during the time in which the carriage 31 traverses the length of a single pixel.

The drive signal shaping section 644B receives a print signal PRT(i) together with an original signal ODRV that is output from the original signal generation section 644A. The drive signal shaping section 644B shapes the original signal ODRV in correspondence with the level of the print signal PRT(i) and outputs it toward the piezo elements of the nozzles #1 to #n as a drive signal DRV(i). The piezo elements of the nozzles #1 to #n are driven in accordance with the drive signal DRV from the drive signal shaping section 644B.

<Regarding the Drive Signals of the Head>

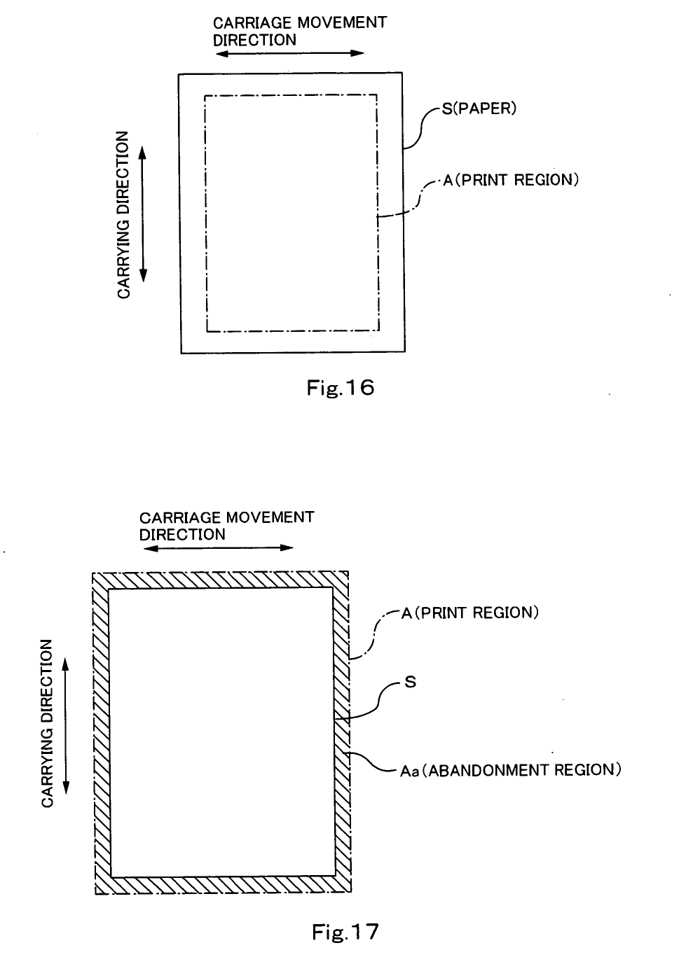

FIG. 14 is a timing chart for explaining the various signals. That is, this figure shows a timing chart for the various signals, namely the original signal ODRV, the print signal PRT(i), and the drive signal DRV(i).

The original signal ODRV is a signal that is supplied from the original signal generation section 644A and shared by the nozzles #1 to #n. In this embodiment, the original signal ODRV includes two pulses, namely a first pulse W1 and a second pulse W2, within the period during which the carriage 31 traverses the length of a single pixel. It should be noted that the original signal ODRV is output from the original signal generation section 644A to the drive signal shaping section 644B.

The print signal PRT is a signal corresponding to the pixel data for a single pixel. That is, the print signal PRT is a signal corresponding to the pixel data included in the print data. In this embodiment, the print signals PRT(i) are signals having two bits of information per pixel. The drive signal shaping section 644B shapes the original signal ODRV in correspondence with the signal level of the print signal PRT and outputs the drive signal DRV.

The drive signal DRV is a signal that is obtained by blocking the original signal ODRV in correspondence with the level of the print signal PRT. That is, when the level of the print signal PRT is “1”, then the drive signal shaping section 644B allows the drive pulse for the original signal ODRV to pass unchanged and sets it as the drive signal DRV. On the other hand, when the level of the print signal PRT is “0”, the drive signal shaping section 644B blocks the pulse of the original signal ODRV. It should be noted that the drive signal shaping section 644B outputs the drive signal DRV to the piezo elements that are provided nozzle by nozzle. The piezo elements are then driven in accordance with the drive signal DRV.

When the print signal PRT(i) corresponds to the two bits of data “01”, then only the first pulse W1 is output in the first half of the pixel period. Accordingly, a small ink droplet is ejected from the nozzle, forming a small-sized dot (small dot) on the paper. When the print signal PRT(i) corresponds to the two bits of data “10” then only the second pulse W2 is output in the second half of a single pixel interval. Accordingly, a medium-sized ink droplet is ejected from the nozzle, forming a medium-sized dot (medium dot) on the paper. When the print signal PRT(i) corresponds to the two bits of data “11” then both the first pulse W1 and the second pulse W2 are output during a single pixel interval. Accordingly, a small ink droplet and a medium droplet are ejected from the nozzle, forming a large-sized dot (large dot) on the paper. When the print signal PRT(i) corresponds to the two bits of data “00” then neither the first pulse W1 or the second pulse W2 are output during the pixel period. In this case, no ink droplet of any size is ejected from the nozzle, and no dot is formed on the paper.

As described above, the drive signal DRV(i) in a single pixel period is shaped so that it can have four different waveforms corresponding to the four different values of the print signal PRT(i).

===Regarding the Print Modes===

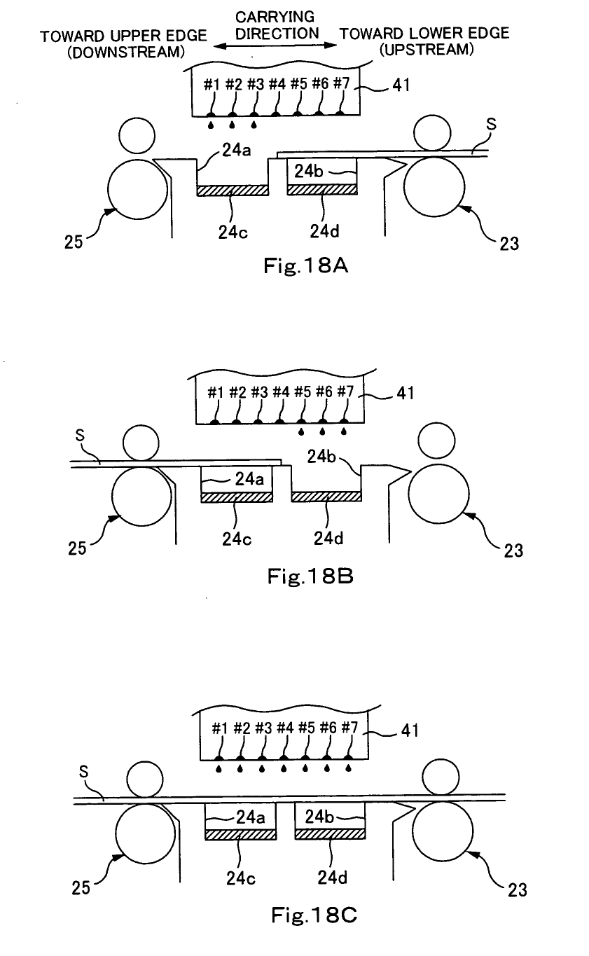

Here, a print mode that can be executed by the printer 1 of the present embodiment are described using FIG. 15A and FIG. 15B. As this print mode, the interlaced mode can be executed. By using this print mode, individual differences between the nozzles, such as in the nozzle pitch and the ink ejection properties, are lessened by spreading them out over the image to be printed, and thus an improvement in image quality can be attained.

FIGS. 15A and 15B are explanatory diagrams of the interlaced mode. It should be noted that for the sake of simplifying the description, the nozzle rows shown in place of the head 41 are illustrated to be moving with respect to the paper S, but the diagrams show the relative positional relationship between the nozzle rows and the paper S, and in fact it is the paper S that moves in the carrying direction. In the diagrams, the nozzles represented by black circles are the nozzles that actually eject ink, and the nozzles represented by white circles are nozzles that do not eject ink. FIG. 15A shows the nozzle positions in the first through fourth passes and shows how the dots are formed by those nozzles. FIG. 15B shows the nozzle positions in the first through sixth passes and shows how the dots are formed.

Here, “interlaced mode” refers to a print mode in which k is at least 2 and a raster line that is not recorded is sandwiched between the raster lines that are recorded in a single pass. Also, “pass” refers to a single movement of the nozzle rows in the carriage movement direction. A “raster line” is a row of dots lined up in the carriage movement direction.

With the interlaced mode illustrated in FIG. 15A and FIG. 15B, each time the paper S is carried in the carrying direction by a constant carry amount F, the nozzles record a raster line immediately above the raster line that was recorded in the pass immediately before. In order to record the raster lines in this way using a constant carry amount, the number N (which is an integer) of nozzles that actually eject ink is set to be coprime to k, and the carry amount F is set to N-D.

In the figures, the nozzle row has four nozzles arranged in the carrying direction. However, since the nozzle pitch k of the nozzle row is 4, not all the nozzles can be used so that the condition for the interlaced mode, that is, “N and k are coprime”, is satisfied. Accordingly, only three of the four nozzles are used in this interlaced mode. Furthermore, because three nozzles are used, the paper S is carried by a carry amount 3·D. As a result, for example a nozzle row with a nozzle pitch of 180 dpi (4·D) is used to form dots on the paper S at a dot pitch of 720 dpi (=D).

The figures show the manner in which continuous raster lines are formed, with the first raster line being formed by the nozzle #1 of the third pass, the second raster line being formed by the nozzle #2 of the second pass, the third raster line being formed by the nozzle #3 of the first pass, and the fourth raster line being formed by the nozzle #1 of the fourth pass. It should be noted that ink is ejected only from nozzle #3 in the first pass, and ink is ejected only from nozzle #2 and nozzle #3 in the second pass. The reason for this is that if ink were ejected from all of the nozzles in the first and second passes, it would not be possible to form consecutive raster lines on the paper S. Also, from the third pass on, three nozzles (#l to #3) eject ink and the paper S is carried by a constant carry amount F (=3·D), forming continuous raster lines at the dot pitch D.

===Regarding Borderless Printing and Bordered Printing===

With the printer 1 of the present embodiment, it is possible to execute both “borderless printing,” in which printing is carried out without forming margins at the edges of the paper, and “bordered printing,” in which printing is carried out with margins at the edges of the paper.

<Overview of Borderless Printing and Bordered Printing>

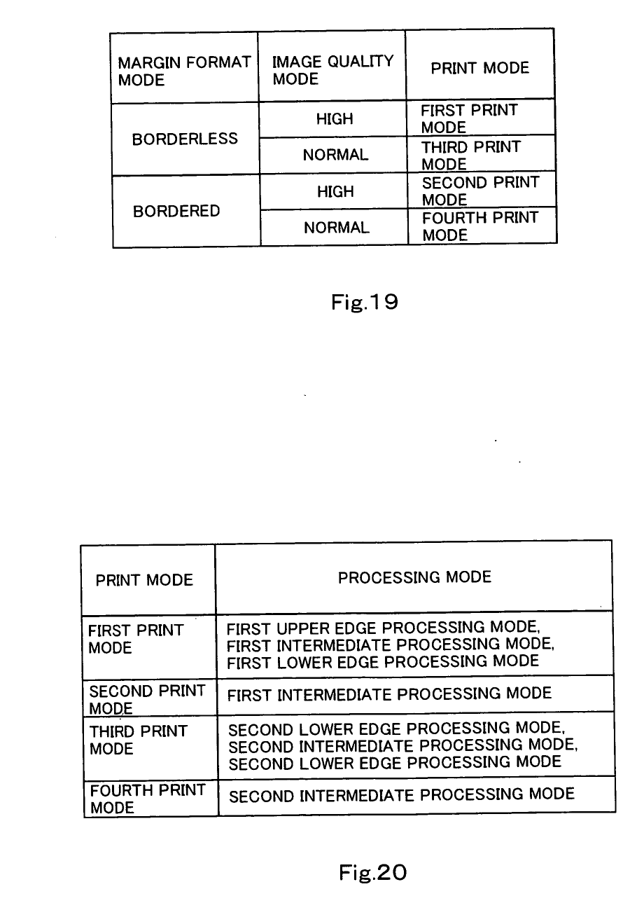

With bordered printing, printing is performed such that the print region A, which is the region to which ink is ejected according to the print data, is contained within the paper S. FIG. 16 shows the relationship between the sizes of the print region A and the paper S during “bordered printing.” The print region A is set to be contained within the paper S, and margins are formed at the upper and lower edge as well as the left and right side edge of the paper S.

When performing bordered printing, the printer driver 1110 converts the resolution of the image data in the above-noted resolution conversion process to a specified print resolution while processing the image data such that the print region A is located inward from the edges of the paper S by a predetermined width. For example, if the print region A of the image data does not fit within a predetermined width from the edges when printing at that print resolution, then the pixel data corresponding to the edges of the image are removed by trimming as appropriate, making the print region A smaller.

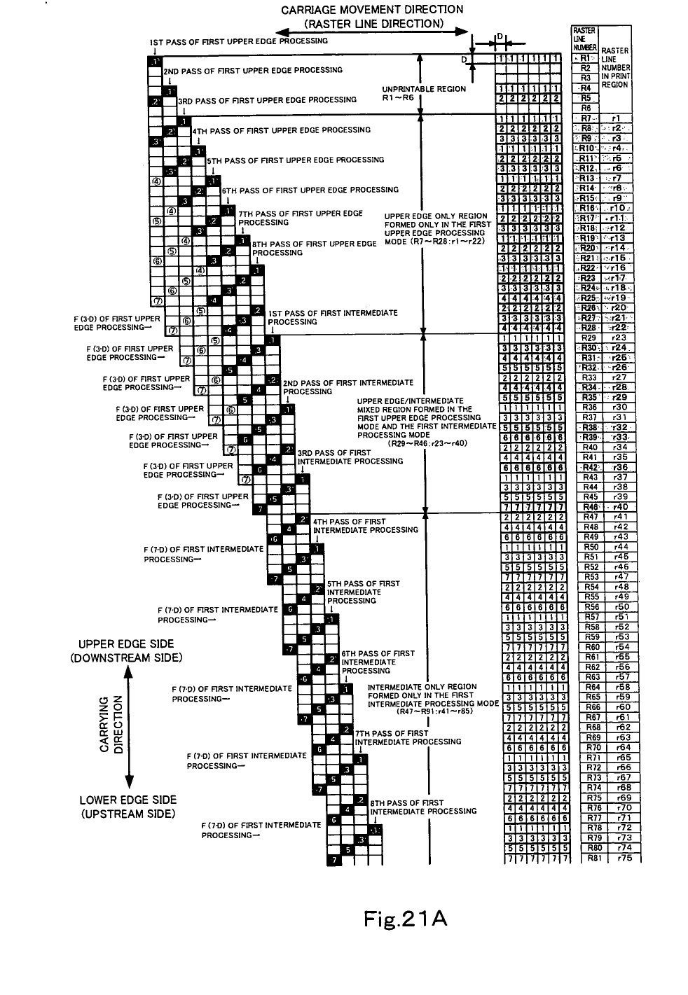

On the other hand, with borderless printing, printing is executed such that the print region A extends beyond the paper S. FIG. 17 shows the relationship between the sizes of the print region A and the paper S during “borderless printing.” The print region A is also set for a region that extends beyond the top and bottom edges and the left and right side edges of the paper S (hereinafter, referred to the abandonment region Aa), and ink is ejected onto this region as well. Thus, ink is reliably ejected toward the edges of the paper S, even if there is some shift in the position of the paper S with respect to the head 41 caused by the precision of the carrying operation, for example, thus achieving printing without forming margins at the edges. It should be noted that the region protruding from the upper and lower edges in the abandonment region Aa corresponds to the “region that is judged to be further upstream than said edge portion on the upstream side, in respect to the intersecting direction of the medium, and for a region that is judged to be further downstream than said edge portion on the downstream side” in the claims.

When performing borderless printing, the printer driver 1110 converts the resolution of the image data in the above-noted resolution conversion process to a specified print resolution while processing the image data such that the print region A extends beyond the edges of the paper S by a predetermined width. For example, if the print region A of the image data extends too far beyond the paper S when printing at that print resolution, then the image data is suitably trimmed, for example, so that the amount by which the print region A extends beyond the paper S becomes a predetermined width.

It should be noted that paper size information regarding the standard dimensions of the paper, such as the A4 size, is stored in advance in the memory of the computer 1100. This paper size information indicates for example how many dots (D) there are in the carriage movement direction and in the carrying direction, respectively, and this information is stored in association with the aforementioned paper size modes that are entered through the user interface of the printer driver 1110. Then, when processing the image data, the printer driver 1110 references the paper size information corresponding to that paper size mode to find the size of the paper, and then processing is performed.

<Regarding the Nozzles Used in Borderless Printing and Bordered Printing>

As mentioned above, with “borderless printing”, ink is ejected toward the abandoned region as well, which is the region outside of the upper edge and the lower edge of the paper. Thus, there is the risk that the ink that is abandoned will adhere to the platen 24 and cause the platen 24 to become dirty. Accordingly, the platen 24 is provided with grooves for collecting the ink outside the upper and lower edge of the paper S, and when printing the upper edge and the lower edge, use of the nozzles is restricted such that ink is ejected from only the nozzles that are in opposition to those grooves.

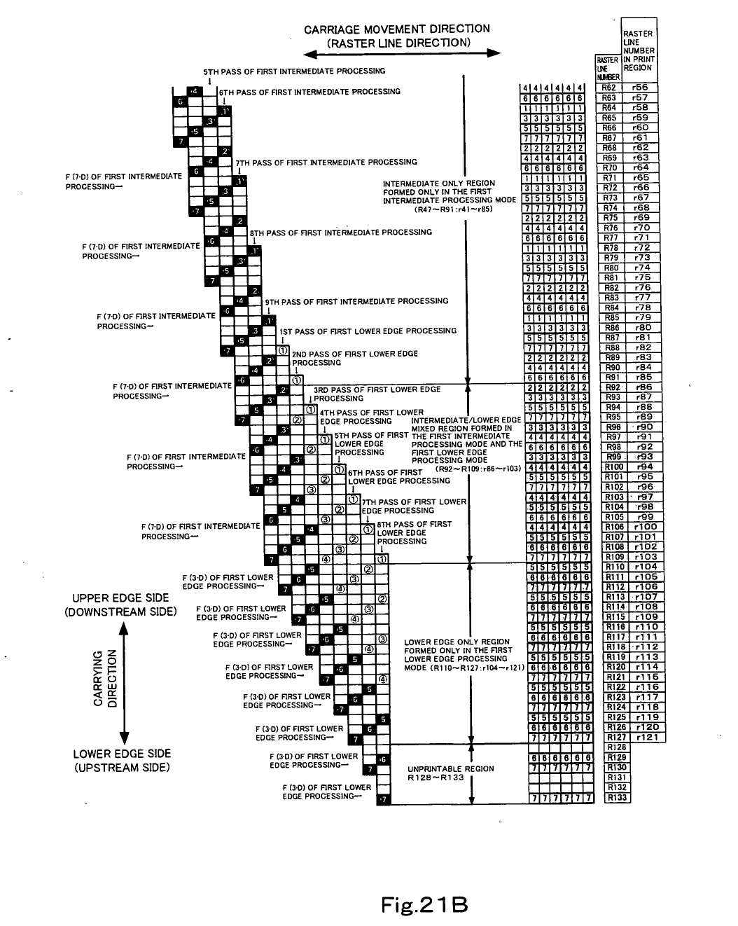

FIGS. 18A to 18C show the positional relationship between the nozzles and the grooves provided in the platen 24. It should be noted that for illustrative reasons, a nozzle row with n=7, that is, a nozzle row provided with nozzles #1 to #7, is used as an example. As shown in FIG. 18A, the upstream side and the downstream side in the carrying direction respectively correspond to the lower edge and the upper edge of the paper S.

As shown in FIG. 18A, the platen 24 is provided with two grooves 24a and 24b, one on the downstream side in the carrying direction and one on the upstream side in the carrying direction. The groove 24a on the downstream side faces the nozzles #1 to #3, whereas the groove 24b on the upstream side faces the nozzles #5 to #7. When printing the upper edge of the paper S as shown in FIG. 18A, printing is performed using the nozzles #1 to #3 (hereinafter, this is referred to as “upper edge processing”), and when printing the lower edge portion as shown in FIG. 18B, printing is performed using the nozzles #5 to #7 (hereinafter, this is referred to as “lower edge processing”). The intermediate portion between the upper edge and the lower edge is printed using all of the nozzles #1 to #7 as shown in FIG. 18C (hereinafter, this is referred to as “intermediate processing”). When printing the upper edge of the paper S as shown in FIG. 18A, the ejection of ink from the nozzles #1 to #3 is started before the upper edge arrives at the downstream groove 24a. However, at this time, the abandoned ink that does not land on the paper S is absorbed by an absorbing material 24c within the downstream groove 24a, so that the platen 24 will not become dirty. Also, as shown in FIG. 18B, when printing the lower edge of the paper S, the ejection of ink from the nozzles #5 to #7 is continued even after that lower edge has passed over the upstream groove 24b. However, at this time, the abandoned ink that does not land on the paper S is absorbed by an absorbing material 24d within the upstream side groove 24b, so that the platen 24 will not become dirty.

On the other hand, in “bordered printing”, a margin is formed at the edges of the paper S, and thus ink is not ejected toward the abandoned region, which is the region outside of the upper edge and the lower edge of the paper S. Consequently, it is always possible to start and end the ejection of ink in a state where the paper S is in opposition to a nozzle, and thus unlike with “borderless printing”, there is no limitation to which nozzles are used, so that printing is performed using all nozzles #1 to #7 over the entire length of the paper S.

===Regarding the Processing Modes===

The user can select “borderless printing” or “bordered printing” through the user interface of the printer driver 1110. That is, as shown in FIG. 7, the two buttons “bordered” and “borderless” are displayed on a screen of the user interface as the input buttons of the margin format mode for specifying the margin format.

It is also possible to select the image quality mode for specifying the image quality of the image from the screen of that user interface, which displays the two buttons “normal” and “high” as the input buttons of the image quality mode. If the user has input “normal,” then the printer driver 1110 sets the print resolution to 360×360 dpi, for example, whereas if the user has input “high,” then the printer driver 1110 sets the print resolution to 720×720 dpi, for example.

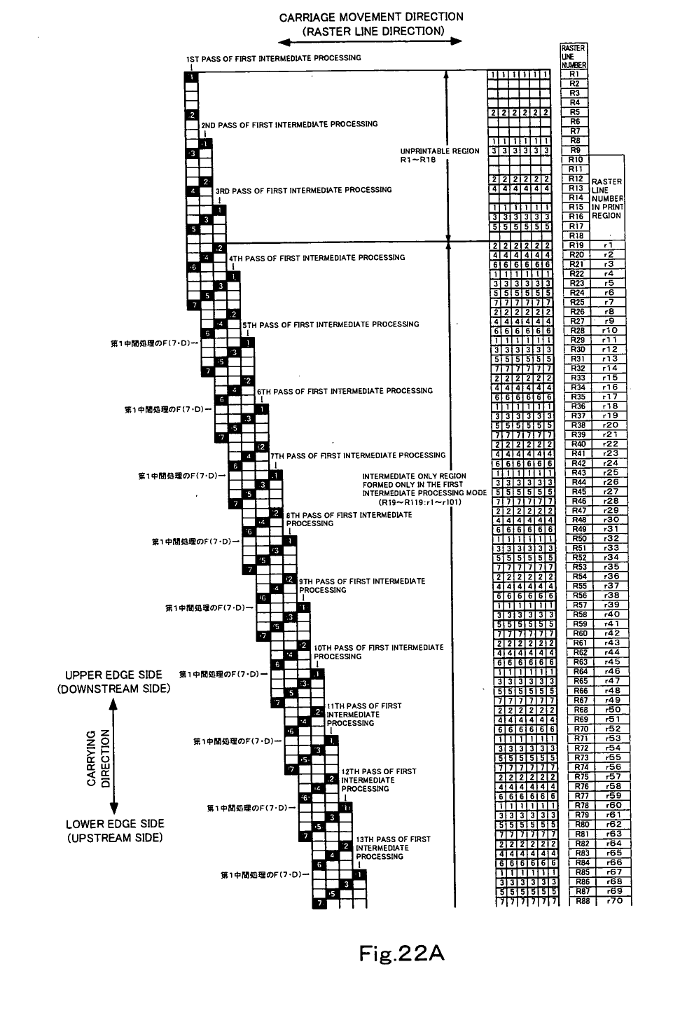

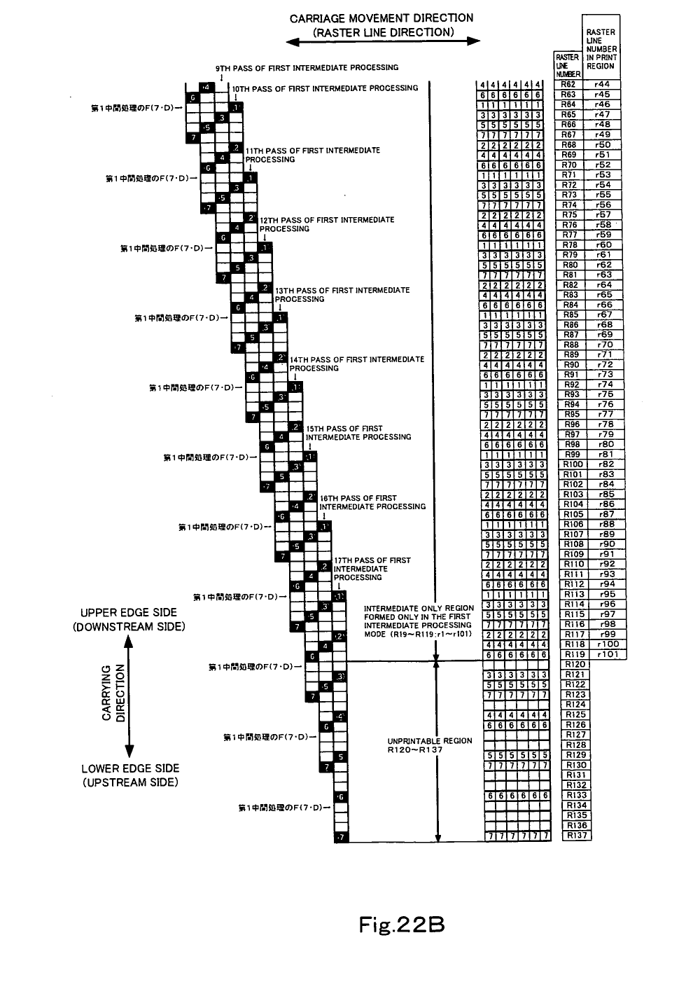

It should be noted that, as shown in the first reference table of FIG. 19, print modes are prepared for each combination of margin mode and image quality mode. Also, processing modes are associated with these print modes as shown in the second reference table in FIG. 20. It should be noted that the first and the second reference table are stored in the memory of the computer 1100.

These processing modes determine the dot formation operation and the carrying operation, and through the processes from the resolution conversation process to the rasterizing process, the printer driver 1110 converts the image data into print data that matches the format of that processing mode.

It should be noted that if the processing modes are different, then print processing in which at least one of the dot formation operation and the carrying operation is different is performed. Here, print processing in which the dot formation operations are different refers to print processing in which the change patterns of the nozzles that are used in the dot formation operations are different. Also, print processing in which the carrying operations are different refers to print processing in which the change patterns of the carry amounts used in the carrying operations are different. This is described later using specific examples.

Six processing modes, namely a first upper edge processing mode, a first intermediate processing mode, a first lower edge processing mode, a second upper edge processing mode, a second intermediate processing mode, and a second lower edge processing mode, are provided.

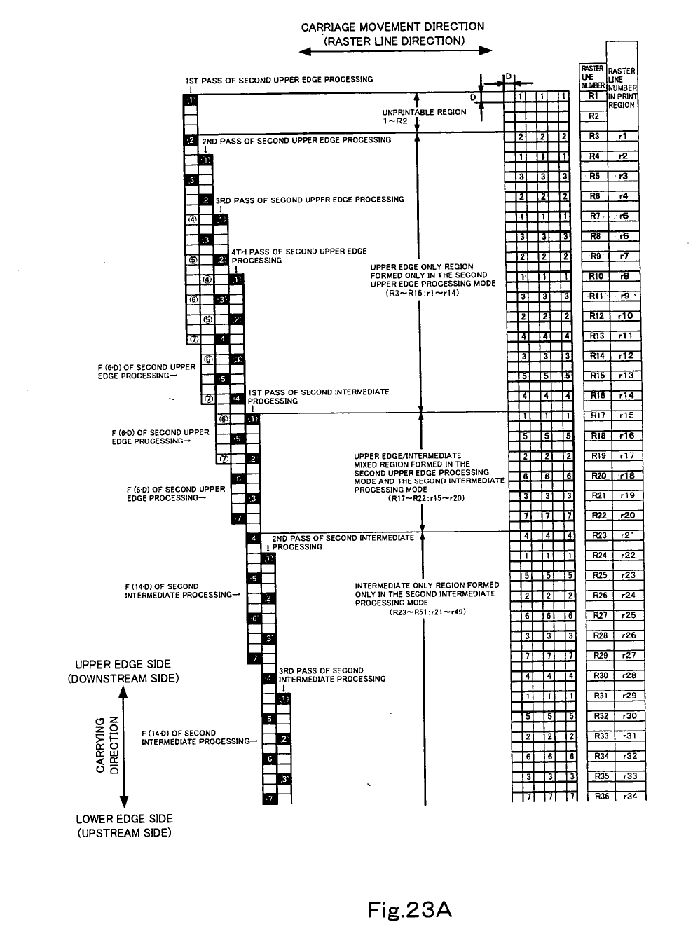

The first upper edge processing mode is a processing mode for executing the upper edge processing mentioned above at a print resolution of 720×720 dpi. In other words, it is a processing mode in which in the first half of the passes, printing is performed in principle in the interlaced mode using only nozzles #1 to #3. In this case, the carry amount F of the paper is 3·D because three nozzles are used (see FIG. 21A).

The first intermediate processing mode is a processing mode for executing the intermediate processing mentioned above at a print resolution of 720×720 dpi. In other words, it is a processing mode in which printing in the interlaced mode using all of the nozzles #1 to #7 of the nozzle row is performed in all passes. It should be noted that the carry amount F of the paper is 7·D because seven nozzles are used (see FIG. 21A and FIG. 21B).

The first lower edge processing mode is a processing mode for executing the lower edge processing mentioned above at a print resolution of 720×720 dpi. In other words, it is a processing mode in which in the latter half of the passes, printing is performed in principle in the interlaced mode using only the nozzles #5 to #7. In this case, the carry amount of the paper is 3·D because three nozzles are used (see FIG. 21B).

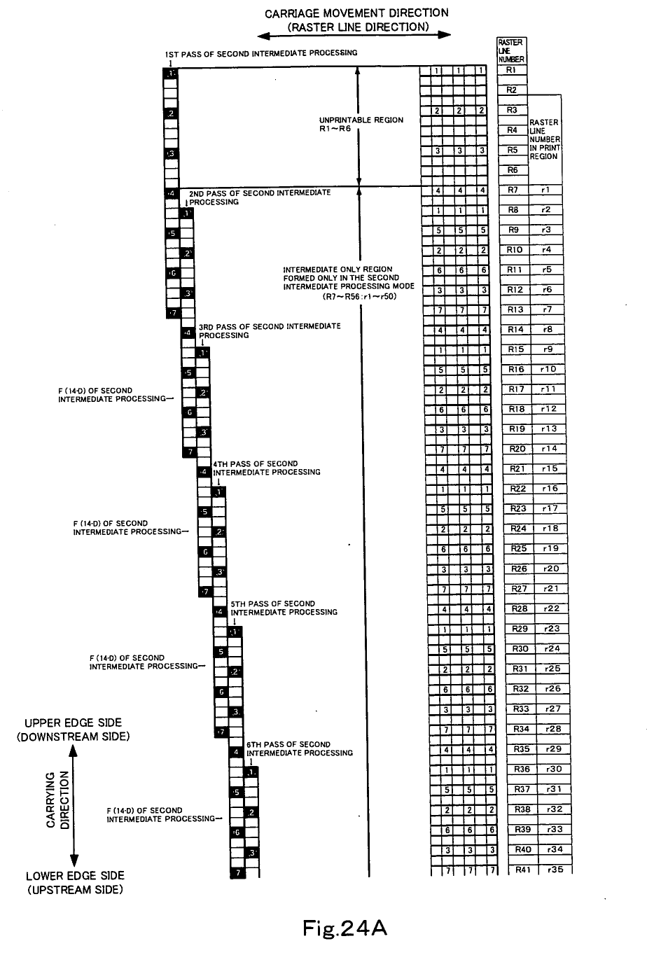

The second upper edge processing mode is a processing mode for executing the upper edge processing mentioned above at a print resolution of 360×360 dpi. In other words, it is a processing mode in which in the first half of the passes, printing is performed in principle in the interlaced mode using only nozzles #1 to #3. However, due to the print resolution being only half as fine as that of the first upper edge processing mode, the carry amount F of the paper is 6·D, which is twice that of the first upper edge processing mode (see FIG. 23A).

The second intermediate processing mode is a processing mode for executing the intermediate processing mentioned above at a print resolution of 360×360 dpi. In other words, it is a processing mode in which printing in the interlaced mode using all of the nozzles #1 to #7 of the nozzle row is performed in all passes. However, due to the print resolution being only half as fine as that of the first intermediate processing mode, the carry amount F of the paper is 14·D dots, which is twice that of the first intermediate processing mode (see FIG. 23A and FIG. 23B).

The second lower edge processing mode is a processing mode for executing the upper edge processing mentioned above at a print resolution of 360×360 dpi. In other words, it is a processing mode in which in the latter half of the passes, printing is performed in principle in the interlaced mode using only the nozzles #5 to #7. However, due to the print resolution being only half as fine as that of the first lower edge processing mode, the carry amount F of the paper is 6·D, twice that of the first lower edge processing mode (see FIG. 23B).

Here, the manner in which the image is formed on the print paper S through these processing modes is described with reference to FIG. 21A to FIG. 24B. It should be noted that in all of these figures, the two diagrams A and B represent the manner in which a single image is formed. That is to say, Fig. A shows by what nozzle in what pass of what processing mode the raster lines in the upper portion of the image are formed, and Fig. B shows by what nozzle in what pass of what processing mode the raster lines in the lower portion of the image are formed.

The left side of FIG. 21A through FIG. 24B (hereinafter referred to as the “left diagrams”) shows the relative position of the nozzle row with respect to the paper in each pass of the processing modes. It should be noted that in the left diagrams, for illustrative reasons, the nozzle row is shown moving downward in increments of the carry amount F for each pass, but in actuality the paper S is moved in the carrying direction. Also, the nozzle row has nozzles #1 to #7, whose nozzle number is shown surrounded by a circle, and their nozzle pitch k·D is 4·D. Further, the dot pitch D is 720 dpi ( 1/720 inch). It should be noted that in this nozzle row the nozzles shown shaded in black are the nozzles that eject ink.

The diagrams to the right of the left diagrams (hereinafter referred to as the “right diagrams”) show how the dots are formed by ejecting ink toward the pixels making up the raster lines. It should be noted that, as mentioned earlier, pixels are virtual square boxes on the paper that define the positions where ink is made to land to form dots, and the squares in the right diagrams respectively represent pixels of 720×720 dpi, that is, pixels of D×D size. The numbers written in each square indicate the numbers of the nozzles that eject ink toward those pixels, and the squares in which no numbers are written indicate pixels in which ink is not ejected. Also, as shown in the right diagrams, the raster line at the uppermost end that can be formed in this print mode is called the first raster line R1. Thereafter, in the direction toward the lower end of the figure, the raster lines are successively referred to as the second raster line R2, the third raster line R3, etc.

(1) Regarding the case of printing an image using the first upper edge processing mode, the first intermediate processing mode, and the first lower edge processing mode

This corresponds to the case that the first print mode shown in FIG. 19 and FIG. 20 has been set, that is, the case that “borderless” has been set as the margin format mode and “high” has been set as the image quality mode. As shown in FIG. 21A and FIG. 21B, the printer 1 performs eight passes in the first upper edge processing mode, then performs nine passes in the first intermediate processing mode, and then performs eight passes in the first lower edge processing mode. As a result, ink is ejected at a print resolution of 720×720 dpi to the region R7 to R127 from the seventh raster line R7 to the 127th raster line R127 serving as a print region, borderlessly printing on a paper of a later-described “first size”, which is 110·D in the carrying direction.

It should be noted that the pass numbers of the first upper edge processing mode and the first lower edge processing mode are fixed values, and do not change from the, for example, eight passes mentioned above, but the number of passes of the first intermediate processing mode is set to change in correspondence with the paper size mode that has been input through the user interface of the printer driver 1110. This is because in order to perform borderless printing it is necessary for the size of the print region to be larger in the carrying direction than the paper corresponding to the paper size mode, and the size of the print region is adjusted by changing the number of passes in the intermediate processing mode. In the example of the diagrams, “first size,” which indicates that the size in the carrying direction is 110·D, has been input as the paper size mode. Then, the number of passes of the first intermediate mode is set to nine passes as mentioned above so that the size in the carrying direction of the print region becomes 121·D. This is explained in detail later.

In the first upper edge processing mode, the dot formation operation of a single pass is in principle executed in the interlaced mode between the carrying operations, each of which carries the paper S by 3·D, as shown in the left diagram of FIG. 21A. In the four passes of the first half of this processing mode, printing is performed using nozzles #1 to #3. In the four passes of the latter half, printing is performed while increasing the number of the nozzle to be used by one every time the pass number advances, in the order of nozzle #4, #5, #6, and #7. It should be noted that the reason why the number of nozzles used is successively increased in the four passes of the latter half is so that the usage state of the nozzles matches that of the first intermediate processing mode that is executed immediately afterward.

Printing in the first upper edge processing mode results in raster lines formed over the region R1 to R46, from the first raster line R1 to the 46th raster line R46, shown in the right diagram (in the right diagram, the raster lines that are formed by the first upper edge processing mode are shown shaded). However, it should be noted that in the region R1 to R46, the complete region in which all raster lines have been formed is only the region R7 to R28 ranging from raster line R7 to raster line R28, whereas the region R1 to R6 from raster line R1 to raster line R6 and the region R29 to R46 from raster line R29 to raster line R46 are incomplete regions containing portions in which no raster lines are formed.

The former of these incomplete regions, namely the region R1 to R6, is a so-called unprintable region, which means that no nozzles pass over the portion corresponding to the second, third and sixth raster lines R2, R3 and R6 in any of the passes, and thus no dots can be formed in those pixels. Thus, this region R1 to R6 is not used for recording an image, and is excluded from the print region. On the other hand, the yet unformed sections of the raster lines in the latter region R29 to R46 are formed in a complementary manner through the first intermediate processing mode that is executed immediately afterwards, so that this region R29 to R46 is completed at that time. In other words, the region R29 to R46 is a region that is completed through both the first upper edge processing mode and the first intermediate processing mode, and hereinafter this region R29 to R46 is referred to as the “upper edge/intermediate mixed region.” Also, the region R7 to R28 that is formed through only the first upper edge processing mode is referred to as the “upper edge only region.”

In the first intermediate processing mode, the dot formation operation of a single pass is executed in principle in the interlaced mode between carrying operations, each of which carries the paper S by 7·D, as shown in the left diagrams of FIG. 21A and FIG. 21B. All the nozzles #1 to #7 are used for printing in all of the passes, from the first pass to the ninth pass, and as a result, raster lines are formed over the region R29 to R109 from the 29th raster line R29 to the 109th raster line R109 shown in the right diagram.

More specifically, with regard to the upper edge/intermediate mixed region R29 to R46, the raster lines R29, R33, R36, R37, R40, R41, R43, R44, and R45, which were not formed in the first upper edge processing mode, are each formed in a complementary manner, completing the upper edge/intermediate mixed region R29 to R46. All of the raster lines of the region R47 to R91 are completely formed through only the dot formation operations of the first intermediate processing mode. Hereinafter, the region R47 to R91, which is completed through only the first intermediate processing mode, is referred to as the “intermediate only region.” The region R92 to R109 includes some raster lines with unformed portions, and these are formed in a complementary manner through the first lower edge processing mode that is executed next, completing the region R92 to R109. In other words, the region R92 to R109 is a region that is completed through both the first intermediate processing mode and the first lower edge processing mode, and hereinafter this region R92 to R109 is referred to as the “intermediate/lower edge mixed region.” It should be noted that in the right diagram, the raster lines that are formed through the first lower edge processing mode are shown shaded.

In the first lower edge processing mode, as shown in FIG. 21B, the dot formation operation of a single pass is in principle executed in the interlaced mode between carrying operations, each of which carries the paper S by 3·D. In the five passes of the latter half of the first lower edge processing mode, printing is executed using nozzles #5 to #7. Also, in the three passes of the first half of the first lower edge processing mode, printing is carried out while decreasing the nozzle number of the nozzles that are used by one in the order of nozzle #1, nozzle #2, and nozzle #3, each time the pass number increases. That is, printing is executed in the first pass using nozzles #2 to #7, in the second pass using nozzles #3 to #7, and in the third pass using nozzles #4 to #7. It should be noted that the reason why the number of nozzles used is successively decreased in the three passes of the first half is so that the usage state of the nozzles is matched to that of the five passes of the latter half that are executed immediately afterward.

The result of printing in the first lower edge processing mode is that raster lines are formed over the region R92 to R133, from the 92ns raster line R92 to the 133rd raster line R133 shown in the right diagram.

More specifically, with regard to the intermediate/lower edge mixed region R92 to R109, the raster lines R92, R96, R99, R100, R103, R104, R106, R107, and R108, which were not formed in the first intermediate processing mode, are each formed in a complementary manner, completing the intermediate/lower edge mixed region R92 to R109. All the raster lines of the region R110 to R127 are formed through only the dot formation operations of the first lower edge processing mode, completing this region. Hereinafter, the region R110 to R127 that is formed through only the lower edge processing mode is referred to as the “lower edge only region.” Further, the region R128 to R133 is a so-called unprintable region, that is, no nozzles pass over the portion corresponding to the 128th, 131st, and 132nd raster lines R128, R131, and R132 in any pass number, and thus it is not possible to form dots in those pixels. Thus, the region R128 to R133 is not used for recording an image, and is excluded from the print region.

Incidentally, in the case of printing using the first upper edge processing mode, the first intermediate processing mode, and the first lower edge processing mode, the print start position (the target position at the upper edge of the paper S when printing is started) should be set to the fourth raster line from the uppermost edge of the print region toward the lower edge (in FIG. 21A, this is the tenth raster line R10). By doing this, even if due to carry error the paper is carried more than the stipulated carry amount, as long as that error is within 3·D, the upper edge of the paper S will be positioned closer to the lower edge than the uppermost edge of the print region. Consequently, borderless printing can be reliably achieved without a margin being formed at the upper edge of the paper S. Conversely, if due to carry error the paper S is carried less than the stipulated carry amount, then as long as that amount is less than 14·D, the upper edge of the paper S is positioned closer to the upper edge than the 24th raster line R24, and thus the upper edge of the paper S will be printed by only the nozzles #1 to #3 above the groove portion, reliably preventing the platen 24 from becoming dirty.

On the other hand, the print end position (the target position at the lower edge of the paper S when printing is finished) should be set to the ninth raster line from the lowermost edge of the print region toward the upper edge (in FIG. 21B, this is the 119th raster line R119), for example. By doing this, even if due to carry error the paper is carried less than the stipulated carry amount, as long as that error is within 8·D, the lower edge of the paper S will still be positioned closer to the upper edge than the raster line R127 at the lowermost edge of the print region. Consequently, borderless printing can be reliably achieved without a margin being formed at the lower edge of the paper S. Conversely, if due to carry error the paper S is carried more than the stipulated carry amount, then as long as that amount is less than 12·D, the lower edge of the paper S is positioned closer to the lower edge than the 106th raster line R106, and thus the lower edge of the paper will be printed by only the nozzles #5 to #7 above the groove portion, preventing the platen 24 from becoming dirty.

It should be noted that the print start position and the print end position are related to the number of passes that is set in the first intermediate processing mode mentioned above. In other words, to satisfy the conditions of the print start position and the print end position mentioned above with respect to a paper that corresponds to the paper size mode, first the size of the print region in the carrying direction must be set to a size that extends beyond the upper edge and the lower edge of the paper by 3·D and 8·D, respectively. That is, it needs to be set 11·D larger in the carrying direction than the paper. Consequently, the number of passes in the first intermediate processing mode is set such that the size is 11·D larger than the size in the carrying direction, which is indicated by the paper size mode that has been input. Incidentally, the size in the carrying direction of the “first size” mentioned above is 110·D. To set the print region larger than this by 11·D to 121·D, the number of passes of the first intermediate processing mode is set to nine passes.

(2) Regarding the case that an image is printed using only the first intermediate processing mode

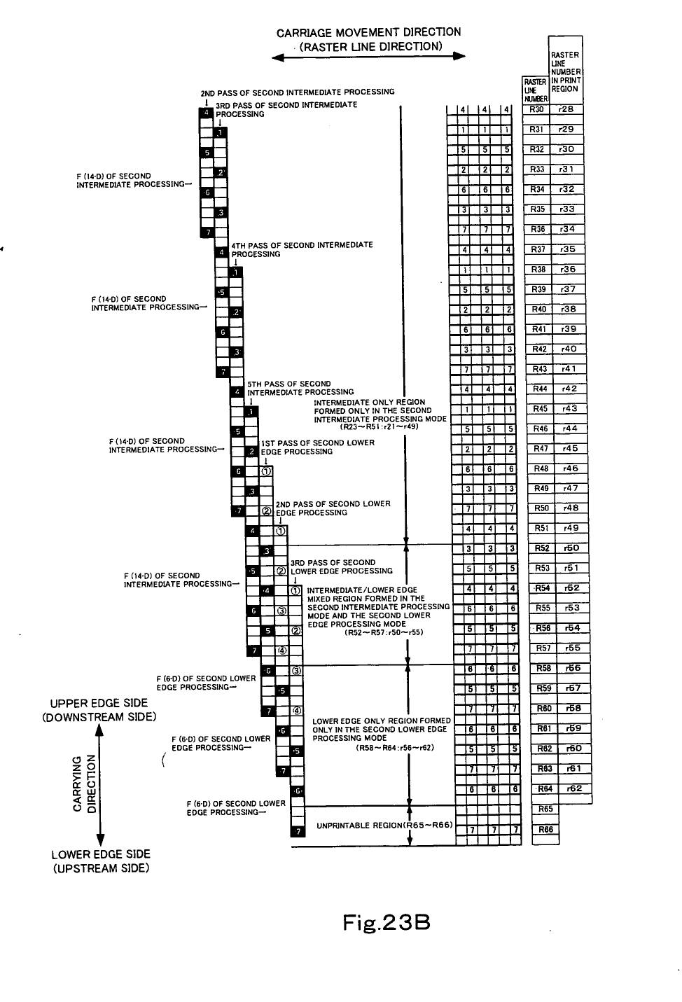

This corresponds to the case that the second print mode shown in FIG. 19 and FIG. 20 has been set, that is, a case in which “bordered” has been set as the margin format mode and “high” has been set as the image quality mode. As shown in FIG. 22A and FIG. 22B, the printer 1 performs nine passes in the first intermediate processing mode. As a result, ink is ejected at a print resolution of 720×720 dpi onto the region R19 to R119, which serves as the print region, printing a paper of the “first size,” which is 110·D in the carrying direction, while leaving a border.

It should be noted that as in case (1) mentioned above, the number of passes of the first intermediate processing mode changes depending on the paper size mode that has been input. In other words, the number of passes is set such that the size of the print region is a size with which a margin of a predetermined width is formed at the upper and lower edges of a paper of the paper size mode that has been input. In the example shown in the diagrams, “first size” has been input as the paper size mode, so that the size of the paper in the carrying direction is 110·D. Thus, in order to print the paper leaving a border, the number of passes of the first intermediate processing mode is set to 17 passes, as mentioned above, so that the size in the carrying direction of the print region is 101·D.

As mentioned above, bordered printing is printing forming a margin at the upper edge portion and the lower edge portion of the paper. Thus, it is not necessary to print the upper edge portion and the lower edge portion using only the nozzles opposing the grooves 24a and 24b, so that printing is executed according to only the first intermediate processing mode, in which all of the nozzles #1 to #7 are used over the entire length in the carrying direction of the paper.

In the first intermediate processing mode, the dot formation operation of a single pass is performed in the interlaced mode between carrying operations, with each of which the paper is carried by 7·D. In the example shown in the diagrams, all of the nozzles #1 to #7 are used in all of the passes, from the first pass to the seventeenth pass, resulting in raster lines being formed over the region from the first raster line R1 to the 137th raster line R137.

However, the region R1 to R18 at the upper edge includes portions in which raster lines are not formed in any of the passes, such as the portion R18, and thus the region R1 to R18 is an unprintable region and is excluded from the print region. Similarly, also the region R120 to R137 at the lower edge includes portions in which raster lines are not formed in any of the passes, such as R120, and thus this region R120 to R137 also is an unprintable region and is excluded from the print region. It should be noted that in the remaining region R19 to R119 all of the raster lines are formed through only the first intermediate processing mode, and thus this corresponds to an intermediate only region as described above.

(3) Regarding the case that an image is printed using the second upper edge processing mode, the second intermediate processing mode, and the second lower edge processing mode

This corresponds to the case that the third print mode shown in FIG. 19 and FIG. 20 has been set, that is, the case that “borderless” has been set as the margin format mode and “normal” has been set as the image quality mode. As shown in FIG. 23A and FIG. 23B, the printer 1 performs four passes in the second upper edge processing mode, five passes in the second intermediate processing mode, and three passes in the second lower edge processing mode. As a result, ink is ejected at a print resolution of 360×360 dpi to the region R3 to R64, which serves as the print region, borderlessly printing a paper of the “first size.”

It should be noted that because the print resolution is 360×360 dpi, only every other grid square shown in the right diagrams is covered by a dot. That is to say, the raster lines in the print region are formed only every other grid square.

As in case (1) above, the number of passes in the second upper edge processing mode and the second lower edge processing mode is fixed and does not change, but the number of passes in the second intermediate processing mode changes depending on the paper size mode. In other words, in order to reliably print borderlessly on a paper of any paper size mode, the number of passes of the second intermediate processing mode is set such that the size of the print region is 14·D larger than the size of the paper. It should be noted that the value 14·D is determined so that the print start position becomes the fourth raster line from the uppermost edge of the print region toward the lower edge (the sixth raster line R6 in FIG. 23A), and that the print end position becomes the fourth raster line from the lowermost edge of the print region toward the upper edge (the 61st raster line R61 in FIG. 23B). In the example shown in the drawings, “first size” has been input and thus the size of the paper in the carrying direction is 110·D. Therefore the number of passes of the first intermediate processing mode is set to five passes such that the size in the carrying direction of the print region becomes 124·D (=110·D+14·D).

In the second upper edge processing mode, the dot formation operation of one pass is in principle executed in the interlaced mode between the carrying operations, each of which carries the paper by 6·D, as shown in the left diagram in FIG. 23A.

In the two passes of the first half of the second upper edge processing mode, printing is performed using nozzles #1 to #3. In the latter two passes, printing is performed while increasing the nozzle number of the nozzles that are used by two each time the pass number advances, in the order of nozzle #4, nozzle #5, nozzle #6, and nozzle #7. It should be noted that the reason for successively increasing the number of nozzles that are used is the same as in the case (1) discussed above.

The result of printing through the second upper edge processing mode is that raster lines are formed over the region R1 to R22 shown in the right diagram (in the right diagram, the raster lines that are formed are shown shaded). However, the complete region in which all of the raster lines have been formed, which corresponds to the upper edge only region mentioned above, is only the region R3 to R16, and the region R1 to R2 and the region R17 to R22 are incomplete because they include some unformed raster lines. Of these, the former region R1 to R2 is an unprintable region because raster lines are not formed in the portion corresponding to the second raster line R2 in any pass number, and is excluded from the print region. On the other hand, the latter region R17 to R22 corresponds to the upper edge/intermediate mixed region, and the unformed raster lines in the region R17 to R22 are completed by being formed in a complementary manner in the second intermediate processing mode that is executed immediately thereafter.

In the second intermediate processing mode, the dot formation operation of a single pass is in principle executed in the interlaced mode between carrying operations, each of which carries the paper by 14·D, as shown in the left diagrams of FIG. 23A and FIG. 23B. All the nozzles #1 to #7 are used for printing in all of the passes, from the first pass to the fifth pass, and as a result, raster lines are formed over the region R17 to R57 shown in the right diagrams. More specifically, with regard to the upper edge/intermediate mixed region R17 to R22, the raster lines R17, R19, and R21, which were not yet formed in the second upper edge processing mode, are each formed in a complementary manner, thus completing them. The region R23 to R51 corresponds to the intermediate only region mentioned above, and the region R23 to R51 is completed by forming all of the raster lines through only the dot formation operations of the second intermediate processing mode. The region R52 to R57 corresponds to the intermediate/lower edge mixed region and includes some raster lines that have not been formed, which are formed in a complementary manner through the second lower edge processing mode that is performed immediately thereafter, completing these regions R52 to R57. It should be noted that in the right diagram, the raster lines that are formed through the second lower edge processing mode only are shown shaded.

In the second lower edge processing mode, the dot formation operations of a single pass are in principle executed in the interlaced mode between the carrying operations, each of which carries the paper by 6·D, as shown in FIG. 23B.

In the one pass of the latter half of the second lower edge processing mode, printing is executed using nozzles #5 to #7. Also, in the two first passes of the second lower edge processing mode, printing is performed while the nozzle number of the nozzles that are used is reduced by two each time the pass number advances, in the order of nozzle #1, nozzle #2, nozzle #3, and nozzle #4. It should be noted that the reason for successively decreasing the number of nozzles that are used is the same as in the case (1) discussed above.

The result of executing the second lower edge processing mode is that raster lines are formed over the region R48 to R66 shown in the right diagram. More specifically, the intermediate/lower edge mixed region R52 to R57 is completed by forming each of the raster lines R52, R54, and R56 that were not yet formed in the second intermediate processing mode in a complementary manner. Also, the region R58 to R64 corresponds to the lower edge only region, and is completed by all the raster lines that are formed through only the dot formation operations of the second lower edge processing mode. The remaining region R65 to R66 is an unprintable region because raster lines are not formed in the portion corresponding to the 65th raster line R65 in any pass number, and thus it is excluded from the print region.

(4) Regarding the case that an image is printed using only the second intermediate processing mode

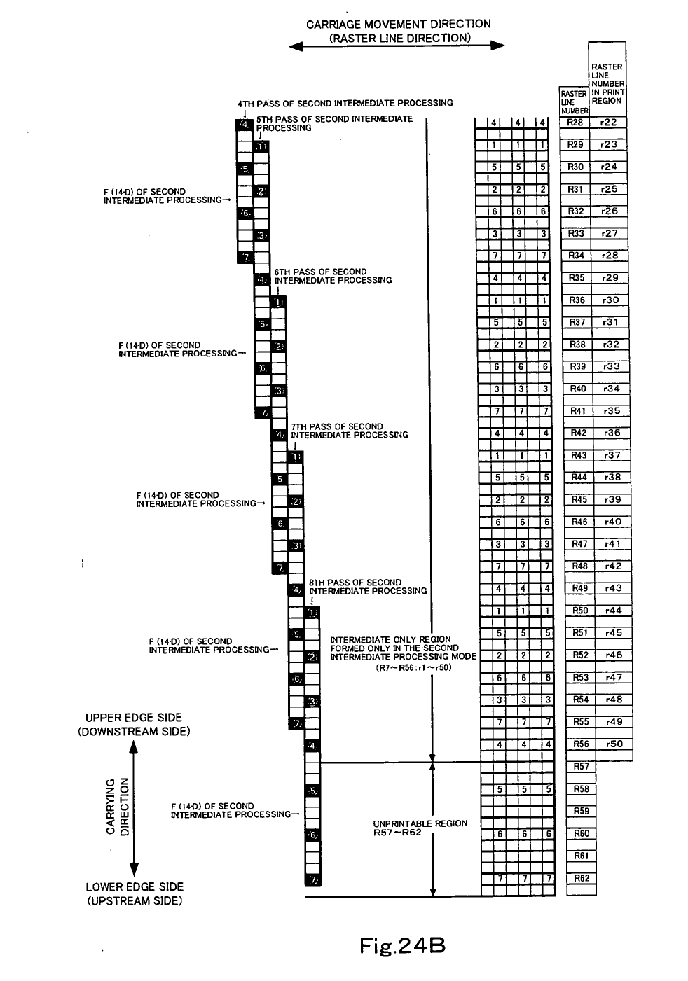

This corresponds to the case that the fourth print mode shown in FIG. 19 and FIG. 20 has been set, that is, the case that “bordered” has been set as the margin format mode and “normal” has been set as the image quality mode. As shown in FIG. 24A and FIG. 24B, the printer 1 performs eight passes in the first intermediate processing mode. As a result, ink is ejected at a print resolution of 360×360 dpi to the region R7 to R56, which serves as the print region, printing with a border on a paper of the “first size.”

As in case (2) mentioned above, the number of passes of the second intermediate processing mode changes depending on the paper size mode. In the example shown in the diagrams, “first size” has been input, so that in order to print on a paper whose size is 110·D while leaving a border, the number of passes of the second intermediate processing mode is set to the aforementioned eight passes, so that the size of the print region in the carrying direction becomes 100·D. It should be noted that in this bordered printing, the reason for printing in the second intermediate processing mode is the same as in the case (2) discussed above.

In the second intermediate processing mode, the dot formation operation of a single pass is performed in the interlaced mode between carrying operations, with each of which the paper is carried by 14·D. Then, in the example shown in the diagrams, all of the nozzles #1 to #7 are used in all of the passes, from the first pass to the eighth pass, resulting in raster lines being formed over the region spanning the region R1 to R62.

However, the region from R1 to R6 on the upper edge side includes portions in which raster lines are not formed in any of the passes, such as R6, and thus the region R1 to R6 is an unprintable region and is excluded from the print region. Similarly, the region R57 to R62 on the lower edge side includes portions in which raster lines are not formed in any of the passes, such as the portion R57, and thus this region R57 to R62 also is an unprintable region and is excluded from the print region. In the remaining region R7 to R56, all of the raster lines are formed through only the first intermediate processing mode, and thus this corresponds to the intermediate only region noted above.

Incidentally, the first upper edge processing mode, first intermediate processing mode, first lower edge processing mode, second upper edge processing mode, second intermediate processing mode, and second lower edge processing mode described above are all different processing modes, because the six processing modes correspond to printing processes in which at least one of the dot formation operation and the carrying operation differs.

That is to say, printing processes with different carrying operations are printing processes in which, as noted above, the change pattern of the carry amount F (carry amount F of each pass) for each carrying operation differs. In the first intermediate processing mode, the change pattern is 7·D for all passes, in the second intermediate processing mode, the change pattern is 14·D for all passes, in the first upper edge processing mode and the first lower edge processing mode, the change pattern is 3·D for all passes, and in the first upper edge processing mode and the first lower edge processing mode, the change pattern is 6·D for all passes. Consequently, the first intermediate processing mode and the second intermediate processing mode are different from any of the other processing modes in terms of their change pattern for the carry amount F, and thus these processing modes are different from the other processing modes.

On the other hand, in both the first upper edge processing mode and the first lower edge processing mode, the change pattern for the carry amount F is 3·D for all of the passes, and thus they are not different from one another with respect to the print processing in the carrying operations. However, with regard the print processing of their dot formation operations, they are different from one another and thus they are different processing modes. That is to say, the change pattern of the nozzles that are used in the dot formation operations (passes) in the first upper edge processing mode is a pattern in which the nozzles #1 to #3 are used in the first through fourth passes, and the nozzles that are used in the fifth through eighth passes are increased one at a time in the order of #4, #5, #6, and #7 each time the pass number increases. By contrast, the change pattern in the first lower edge processing mode is a pattern in which the nozzles are decreased one at a time in the order of #1, #2, #3, and #4 in the first to fourth pass, and the nozzles #5 to #7 are used in the fifth to eighth pass. Consequently, the first upper edge processing mode and the first lower edge processing mode are different from one another in terms of the nozzle change pattern, that is, they are different from one another in terms of their print processing of the dot formation operations. Due to this, these processing modes are different from one another.

Likewise, the second upper edge processing mode and the second lower edge processing mode both have a carry amount change pattern of 6·D for all of the passes, and thus they are not different from one another in terms of the print processing of the carrying operations. However, as regards the print processing of their dot formation operations, they are different from one another and thus they are different processing modes. In other words, the change pattern in the nozzles that are used in the dot formation operations (passes) in the second upper edge processing mode is a pattern in which the nozzles #1 to #3 are used in the first and second passes, and the nozzles that are used are increased by two at a time in the order of #4, #5, #6, and #7 each time the pass number increases in the third and fourth passes. By contrast, the change pattern in the second lower edge processing mode is a pattern in which #3 to #7 are used in the first pass and the nozzles #5 to #7 are used in the third and fourth passes. Consequently, the second upper edge processing mode and the second lower edge processing mode are different from one another in terms of the nozzle change pattern, that is, they are different from one another in terms of their print processing of the dot formation operations. Due to this, these processing modes are different from one another.

The processing modes were described above using specific examples, and because the print region is the only region that contributes to image formation, the raster line numbers are reassigned for only the print region in the following description. That is to say, as shown in the right diagrams of FIG. 21A to FIG. 24C, the uppermost raster line in the print region is called the first raster line r1, and thereafter heading toward the lower end in the drawings the raster lines are the second raster line r2, the third raster line r3, and so on.

===Regarding the Peculiarities of the Printing States of Different Printers===

Incidentally, the printer 1 of such a printing system 1000 may show peculiar individual differences in the printing state between different printers that are caused by the precision with which parts are assembled or the machining precision. Consequently, in the inspection line before the printer 1 is shipped, a test pattern is usually printed on each printer, and the peculiarities of the printing states of each printer are determined from these test patterns. Then, a correction value of various control amounts used for printing is determined and set, in order to suppress these peculiarities.

One example of the peculiarities of the printing state is darkness non-uniformities occurring in parallel along the movement direction, caused by irregularities in the amount of ink ejected from the nozzles. In typical printing methods that suppress such darkness non-uniformities a correction pattern is formed, the darkness of this correction pattern is measured, a correction value is determined for each nozzle in accordance with the measurement result (darkness data), and each nozzle is corrected by the correction value when actually printing an image.

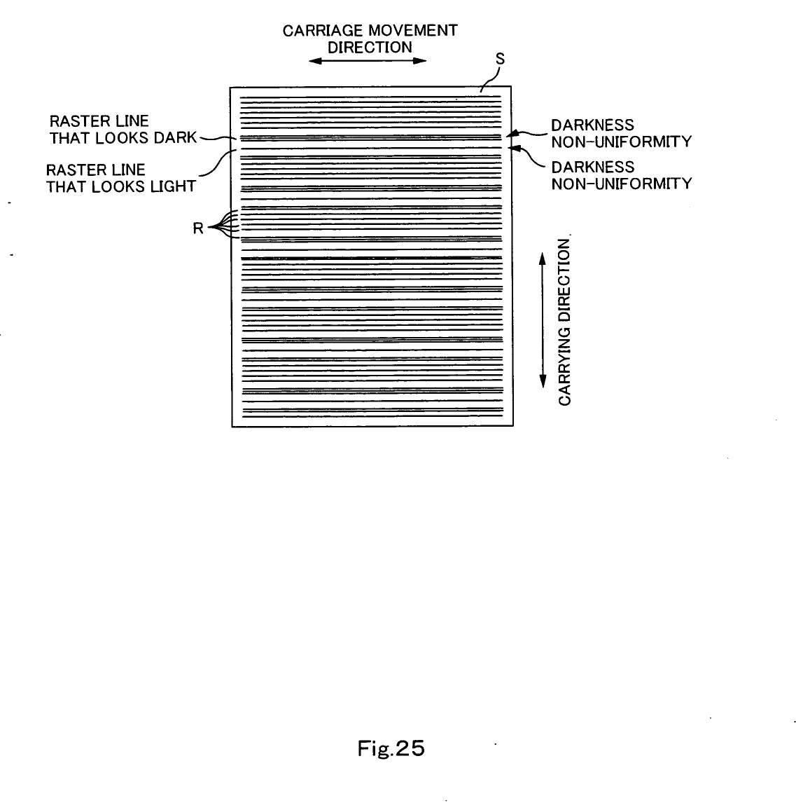

Another example of peculiarities of the printing state are the darkness non-uniformities of the image shown in FIG. 25, for example. These darkness non-uniformities can be seen as stripes that are parallel to the carriage movement direction. A main reason for the occurrence of darkness uniformities is, for example, that the dot formation position shifts in the carrying direction with respect to the target formation position due to poor manufacturing precision of the nozzles and tilts in the ink ejection direction. In such a case, also the formation positions of the raster lines R made of these dots are inevitably shifted in the carrying direction from the target formation positions, and thus the spacing between adjacent raster lines R in the carrying direction is periodically wide or narrow. Observed macroscopically, this will be apparent as striped darkness non-uniformities. In other words, adjacent raster lines R with a wide spacing between them macroscopically appear light, whereas raster lines R with a narrow spacing between them macroscopically appear undesirably dark.

With the above-mentioned printing method of associating each nozzle with a correction value, it is not possible to suppress the darkness non-uniformities caused by the spacing between neighboring raster lines. The reason for this is that the state of the spacing of the raster lines depends on the combination of nozzles forming the adjacent raster lines.

Accordingly, an example of a printing method inhibiting these darkness non-uniformities is the method of forming a correction pattern with a gradation value of predetermined darkness, determining a correction value for each raster line by measuring the darkness of the raster lines formed by each nozzle from this correction pattern, and undertaking a correction for each raster line in accordance with these correction values when actually printing an image.

This method is described in detail in the following. First, in the inspection line, for example the first intermediate processing mode is selected from the above-described six processing modes, and a test pattern is printed by ejecting ink from the nozzles using this processing mode. This test pattern is made of a multitude of raster lines that are formed at a predetermined pitch in the carrying direction, and each of these raster lines is made of a plurality of dots that are lined up in the carriage movement direction at the spots where the ink has landed on the paper. It should be noted that when printing, ink is ejected by giving command values of the same gradation values for all pixels of the test pattern.

Next, the darkness of this test pattern is measured for each raster line, and based on these measurement values, a darkness correction value is determined for each raster line. Then, the correction value for each raster line is stored in the memory of the printer 1 in association with the corresponding raster line.

Then, after the printer 1 has been shipped, the user performs actual printing of an image using this printer 1. At this time, the printer 1 ejects ink while correcting the gradation value of the pixel data corresponding to a given raster line by the correction value corresponding to that raster line, and the darkness non-uniformities are suppressed by correcting the darkness raster line by raster line. More precisely, for nozzles that form raster lines at which the measurement value has become small because the spacing between adjacent raster lines is wide, the ink amount is increased so that those raster lines appear darker, and conversely, for nozzles that form raster lines at which the measurement value has become large because the spacing between adjacent raster lines is narrow, the ink amount is decreased so that those raster lines appear lighter.

However, with this printing method, if at the time of the actual printing a processing mode is selected that differs from the first intermediate processing mode, then the darkness non-uniformities of the printed image cannot be suppressed. This is because the combination of the nozzles forming the neighboring raster lines depends on the processing mode. This is because the correction values stored in the printer 1 are, after all, based on the spacing of the raster lines printed in the first intermediate processing mode, and not based on the spacing between raster lines printed in other processing modes, for example in the first upper edge processing mode.

Consequently, the correction values based on a correction pattern that was printed with the first intermediate processing mode are valid when actually printing in this first intermediate processing mode, but when performing actual printing with a different processing mode, the combination of nozzles forming the adjacent raster lines is different, so that those correction values are not appropriate. For example, in the case of borderless printing in the first print mode, the actual printing of an image is not only performed using the first intermediate processing mode, but also the first upper edge processing mode and the first lower edge processing mode, but the correction values of the first intermediate processing mode are not appropriate for the first upper edge processing mode and the first lower edge processing mode.

This is explained in more detail with reference to the diagram on the right side in FIG. 21A. In the case of printing with the above-explained first intermediate processing mode, the order of the nozzles forming raster lines is, for example, repeated in cycles of #2, #4, #6, #1, #3, #5, #7 in the carrying direction (see for example region r41 to r54). On the other hand, in the case of the first upper edge processing mode, the order of the nozzles forming raster lines is, for example, repeated in cycles of #1, #2, #3 in the carrying direction (see for example region r1 to r6).

Comparing for example the raster lines r44 and r4 that are formed by the nozzle #1 in the first intermediate processing mode and in the first upper edge processing mode, it can be seen that in the first intermediate processing mode, the raster line r45 that is immediately upstream from this raster line r44 is formed by the nozzle #3 and the raster line r43 that is immediately downstream is formed by the nozzle #6. Therefore, the macroscopic darkness of the raster line r44 formed by the nozzle #1 is given by the combination of the nozzles #3, #1 and #6. By contrast, in the first upper edge processing mode, the raster line r5 that is immediately upstream from the raster line r4 formed by the nozzle #1 is formed by the nozzle #2, and the raster line r3 that is immediately downstream is formed by the nozzle #3, so that the macroscopic darkness of the raster line r4 formed by the nozzle #1 is given by the combination of the nozzles #2, #1 and #3. Hence, the combination of the nozzles #2, #1 and #3 in the first upper edge processing mode is different from the combination of the nozzles #3, #1 and #6 in the first intermediate processing mode mentioned above, so that the macroscopic darkness of the raster line r4 formed by the nozzle #1 in the first upper edge processing mode is different from the macroscopic darkness of the raster line r44 that is formed by the nozzle #1 in the first intermediate processing mode. Consequently, the correction value of the first intermediate processing mode cannot be applied to the first upper edge processing mode, so that, as noted above, it is not possible to suppress the darkness non-uniformities of the image of the first upper edge processing mode with the correction value of the first intermediate processing mode.

To address this problem, the embodiment of the present invention described in the following prints a correction pattern for each processing mode and determines correction values of the darkness of the raster lines for each processing mode. Moreover, the test pattern of this embodiment explained below includes at least two correction patterns of different processing modes, and the correction value of the darkness of each raster line is determined for each processing mode, based on these correction patterns. Then, when actually printing an image in a given processing mode, the darkness correction of the raster lines is performed using the correction values that have been determined based on the correction pattern printed in that processing mode, so that darkness non-uniformities are reliably inhibited regardless of which processing mode is selected for the actual printing.

Incidentally, darkness non-uniformities that occur in a multicolor image that is printed using CMYK inks are generally due to darkness non-uniformities that occur in each of those ink colors. For this reason, the method that is adopted in this embodiment is a method that inhibits darkness non-uniformities in images printed in multiple colors by individually inhibiting darkness non-uniformities in each of the ink colors. The following is an explanation of the causes of darkness non-uniformities occurring in images printed in a single color. But needless to say, also in the case of multicolor printing, a correction pattern can be printed for each of the CMYK ink colors used for the multicolor printing, and the correction values can be determined for each ink color.

===Method for Inhibiting Darkness Non-Uniformities Using the Test Pattern of the First Embodiment===

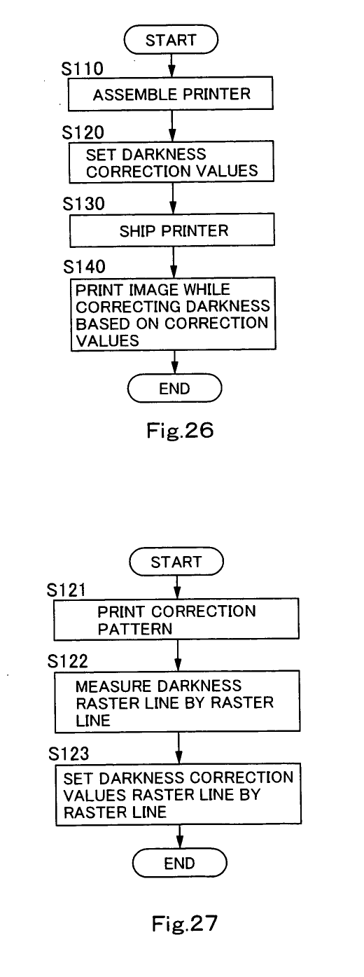

FIG. 26 is a flowchart showing the overall procedure of the method for inhibiting darkness non-uniformities. First, the printer 1 is assembled on a manufacturing line (S110), and then darkness correction values for inhibiting darkness non-uniformities are set in the printer 1 by an operator of an inspection line (S120), before shipping the printer 1 (S130). Then, a user who has purchased the printer 1 performs actual printing of an image, and at the time of this actual printing, the printer 1 prints an image on paper while performing darkness correction for each raster line based on the correction values (S140).

The following is an explanation of Step S120 and Step S140.

<Step S120: Setting the Darkness Correction Values for Inhibiting Darkness Non-Uniformities>

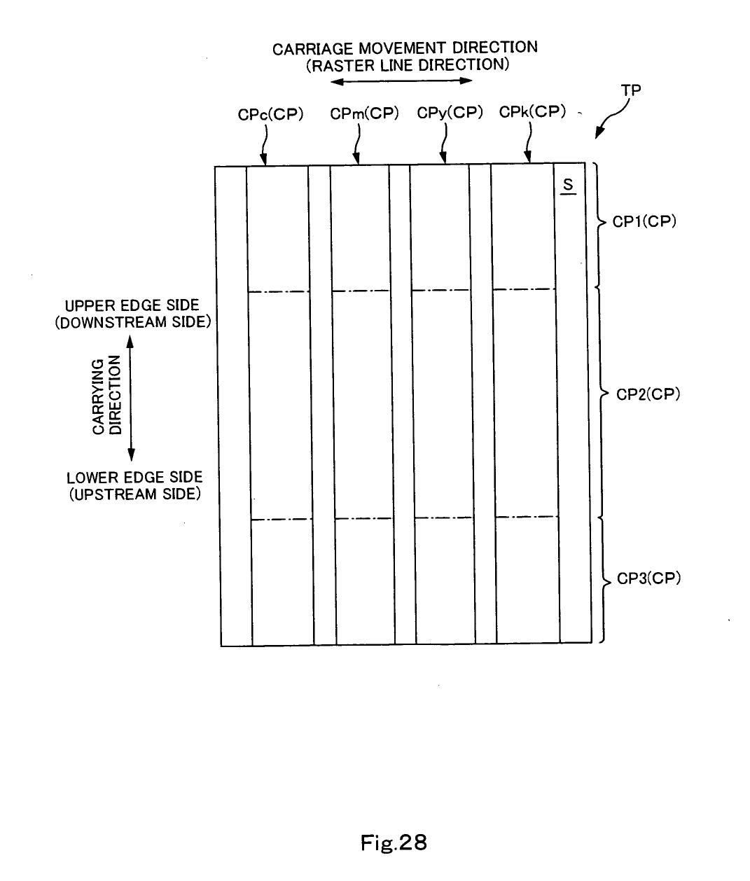

FIG. 27 is a flowchart showing the procedure of Step S120 in FIG. 26. First, the procedure for setting the darkness correction values is outlined below with reference this flowchart.

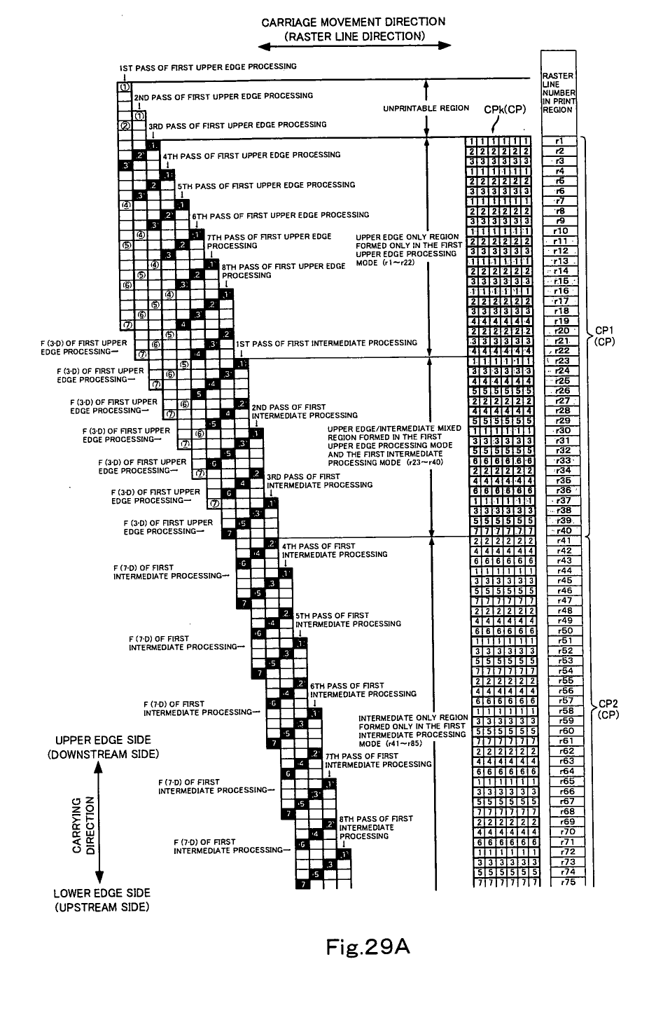

Step S121: First, an operator of the inspection line connects the printer 1 to a computer 1100 on the inspection line and prints a test pattern TP for determining correction values using the printer 1. It should be noted that the printer 1 printing this test pattern TP is the printer 1 in which darkness non-uniformities are to be inhibited, that is, the setting of the correction values is performed for each printer individually. The test pattern TP includes a plurality of correction patterns that are printed in individual partitions for each ink color and for each processing mode (see FIG. 28).

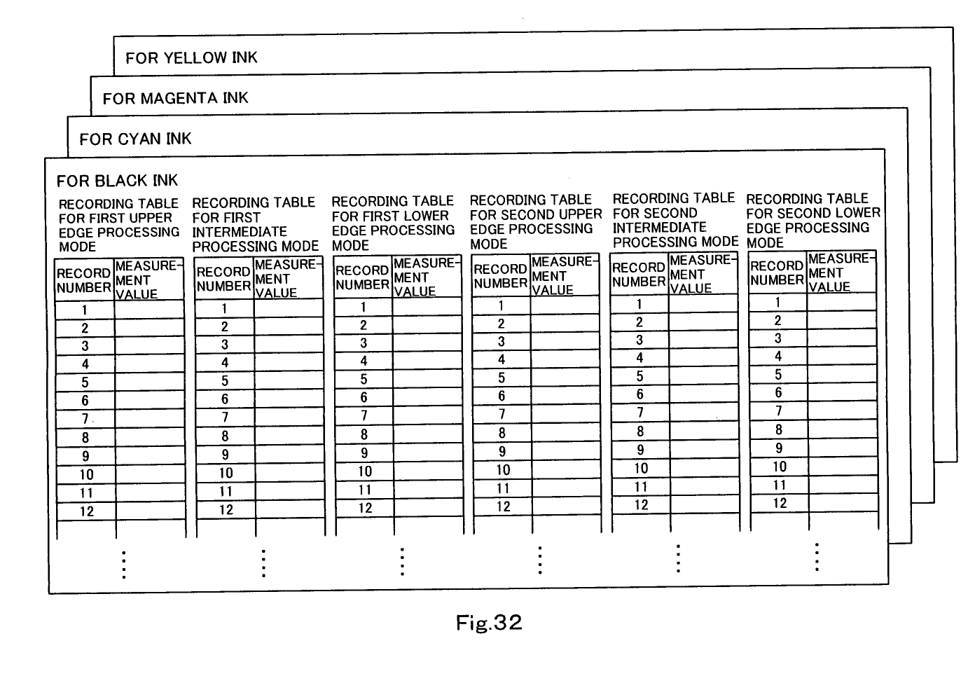

Step S122: Next, the darkness of all printed correction patterns is measured for each raster line, and these measured values are recorded in recording tables in association with the raster line numbers. It should be noted that these recording tables are arranged in individual partitions for each ink color and for each processing mode in the memory of the computer 1100 of the inspection line (see FIG. 32).

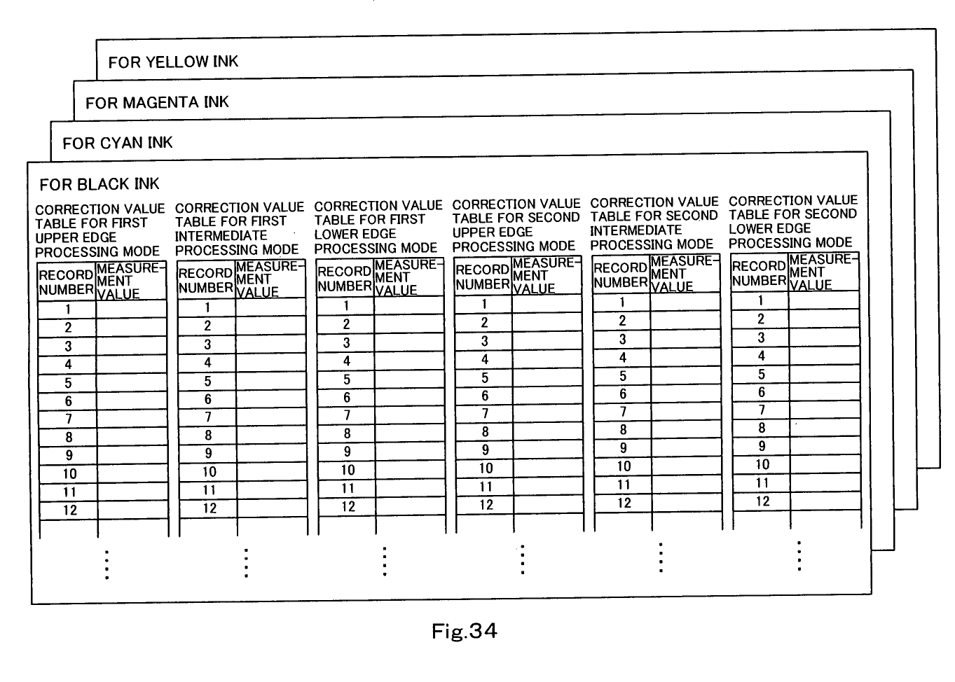

Step S123: Next, the computer 1100 calculates a darkness correction value for each raster line, based on the measured darkness values recorded in the recording tables, and records these correction values in correction value tables in association with the raster line numbers. It should be noted that these correction value tables are arranged in individual partitions for each ink color and for each processing mode in the memory 63 of the printer 1 (see FIG. 34).

In the following, the Steps S121 to S123 are described in more detail.

(1) Step S121: Printing the Test Pattern

First, the operator of the inspection line communicably connects the printer 1 whose correction values are to be set to the computer 1100 of the inspection line, establishing a printing system as illustrated in FIG. 1. Then, the printer 1 is instructed to print a test pattern TP on paper based on the print data of the test patterns TP stored in the memory of the computer 1100, and the printer 1 prints this test pattern TP on the paper S based on the print data sent to it. The print data of this test pattern TP is generated by performing halftone processing and rasterization on the CMYK pixel data obtained by directly specifying the gradation values of the various ink colors CMYK. The gradation values of the pixel data of the CMYK image data are set to the same value for all of the pixels of each correction pattern formed for each ink color, so that the correction patterns are each printed at a substantially uniform darkness across the entire region. The gradation values can be set to an appropriate value, but from the standpoint of actively inhibiting darkness non-uniformities in regions in which darkness non-uniformities occur easily, it is preferable to select a gradation value that results in so-called intermediate gradation regions for CMYK colors. More specifically, in the case of the above-noted 256 gradation values, the gradation value should be selected from the range of 77 to 128.

The print instruction given by the operator is performed through the user interface of the printer driver 1110. For this, the print mode and the paper size mode are set through the user interface, and the printer driver 1110 prints the correction pattern based on print data corresponding to these settings. That is to say, the print data of the correction pattern is prepared for each print mode and for each paper size. Note, however, that the print data of the “first print mode” and the “third print mode” is required, whereas the print data of the “second print mode” and the “fourth print mode” is not necessarily required. This is because the correction patterns of the “second print mode” and the “fourth print mode” are included within the correction patterns of the “first print mode” and the “third print mode”, and can be used appropriately as described below.

FIG. 28 shows a test pattern TP printed on paper. This test pattern TP includes correction patterns CP that are printed for each of the ink colors CMYK. In the example shown in the figure, correction patterns CPc, CPm, CPy and CPk of the various ink colors are lined up in the carriage movement direction on one sheet of paper S in the order cyan (C), magenta (M), yellow (Y), and black (K).

It should be noted that basically the only difference between these correction patterns is the ink color, so that in the following, the correction pattern CPk for black (K) is described as a representative one of these correction patterns CP.

Also, as mentioned above, darkness non-uniformities in multicolor prints are inhibited for each individual ink color that is used in that multicolor print, and further the method that is used for inhibiting the darkness non-uniformities is the same. For this reason, black (K) shall serve as a representative example in the following explanation. In other words, some of the following description is given only for the color black (K), but the same explanations also apply for the other ink colors C, M, and Y as well.

The black (K) correction pattern CPk is printed in a band shape that is oblong in the carrying direction. The print region in the carrying direction extends over the entire region of the paper S.

The correction pattern CPk is printed for each processing mode, and in the example shown in the drawing, one of the correction patterns CP1, CP2, and CP3 for the different processing modes, is printed in each of the three or so regions into which the carrying direction is partitioned.

Here, it is preferable that the relationship dictating in which processing mode the correction patterns CP1, CP2, and CP3 are printed in which of these partitioned regions matches that relationship during actual printing. In this case, the same carrying operation and the same dot formation operation as during the actual printing can be accurately realized also during the printing of the correction patterns CP1, CP2 and CP3, so that the correction precision of the correction values obtained from these correction patterns CP1, CP2 and CP3 is improved, and darkness non-uniformities can be inhibited reliably.

For example, taking the first upper edge processing mode, the first intermediate processing mode and the first lower edge processing mode as an example, a correction pattern (in the following referred to as first upper edge correction pattern CP1) is printed in the first upper edge processing mode onto the region at the top of the paper S, a correction pattern (in the following referred to as first intermediate correction pattern CP2) is printed in the first intermediate processing mode onto the region in the middle of the paper S, and a correction pattern (in the following referred to as first lower edge correction pattern CP3) is printed in the first lower edge processing mode onto the region at the bottom of the paper S. This is because during actual printing, if the first print mode is selected, the upper edge of the paper S is printed in the first upper edge processing mode, the middle of the paper is printed in the first intermediate processing mode, and the bottom of the paper is printed in the first lower edge processing mode.

Here, the formation process of the correction patterns CP1, CP2 and CP3 is explained in detail for the example of the first upper edge, the first intermediate and the first lower edge correction patterns CP1, CP2 and CP3. Note that the following explanations also apply to the second upper edge processing mode, the second intermediate processing mode and the second lower edge processing mode, and since it is clear that the darkness corrections can be carried out in the same manner by executing basically the same basic flow, further explanations have been omitted.

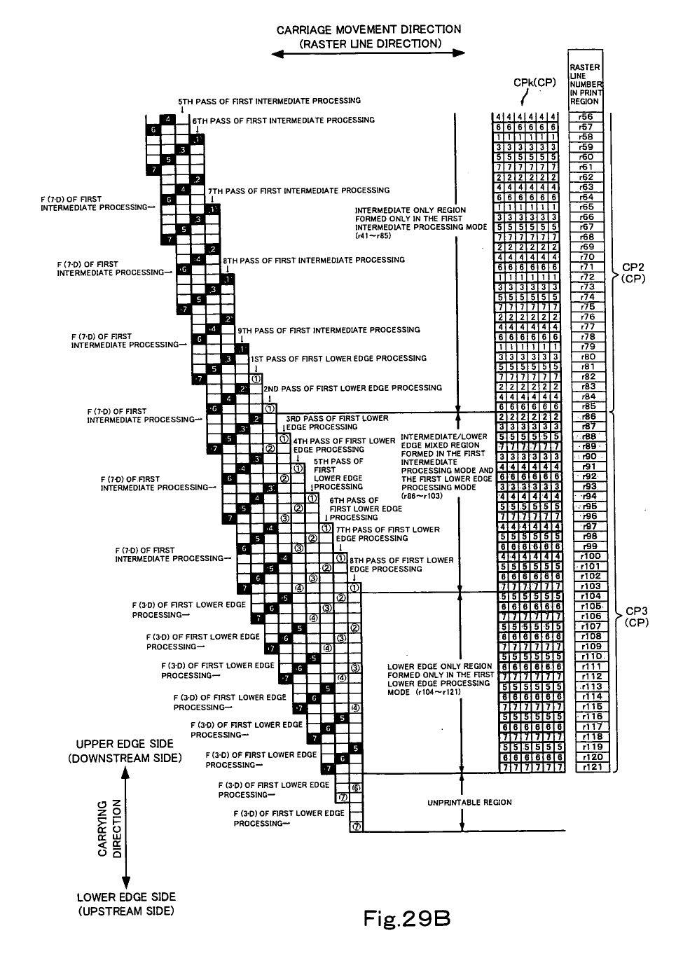

FIG. 29A and FIG. 29B show by which nozzles the raster lines constituting the correction patterns CP1, CP2 and CP3 are formed. FIG. 29A shows this for the first upper edge correction pattern CP1 and the first intermediate correction pattern CP2, whereas FIG. 29B shows this for the first intermediate correction pattern CP2 and the first lower edge processing correction pattern CP3. It should be noted that FIG. 29A and FIG. 29B have the same format as FIG. 21A and FIG. 21B shown above.

In the example shown in the drawings, “first print mode” is set as the print mode, and “first size” is set as the paper size mode. The print data of the correction pattern corresponding to these settings is selected from the memory, and as shown in the right diagrams in FIG. 29A and FIG. 29B, the correction patterns CP1, CP2 and CP3 are printed in the processing modes used for actual printing on the regions at the upper edge, the middle and the lower edge of the paper S.

That is to say, as during the actual printing in FIG. 21A, raster lines are formed in the region r1 to r40 at the upper edge of the paper shown in FIG. 29A by eight passes in the first upper edge processing mode, and the raster lines formed in this region r1 to r40 constitute the first upper edge correction pattern CP1. As noted above, the upper edge/intermediate mixed region r23 to r40 within the region r1 to r40 is formed by both the first upper edge processing mode and the first intermediate processing mode, and of those, the raster lines r24, r25, r26, r28, r29, r32, r33, r36 and r40 are formed by the first intermediate processing mode, but also these raster lines are treated as constituting the first upper edge correction pattern CP1. That is to say, as shown by the shading in the right diagram, the first upper edge correction pattern CP1 is constituted by raster lines of the upper edge only region r1 to r22 and of the upper edge/intermediate mixed region r23 to r40.

Moreover, as in the actual printing of FIG. 21A and FIG. 21B, the raster lines in the region r23 to r103 are formed by nine passes in the first intermediate processing mode in the middle of the paper shown in FIG. 29A and FIG. 29B. Note, however, that as mentioned above, the raster lines in the upper edge/intermediate mixed region r23 to r40 are treated as constituting the first upper edge correction pattern CP1, and the raster lines of the intermediate/lower edge mixed region r86 to r103 described below are treated as constituting the first lower edge correction pattern CP3. Therefore, the raster lines of the remaining intermediate only region r41 to r85 constitute the first intermediate correction pattern CP2. The right diagram shows the raster lines constituting the first intermediate correction pattern CP2 without shading.

Moreover, as during the actual printing in FIG. 21B, raster lines are formed in the region r86 to r121 at the lower edge of the paper shown in FIG. 29B by eight passes in the first lower edge processing mode, and the raster lines formed in these regions r86 to r121 constitute the first lower edge correction pattern CP3. As mentioned above, the intermediate/lower edge mixed region r86 to r103 in the region r86 to r121 is formed by both the first lower edge processing mode and the first intermediate processing mode, and of those, the raster lines r87, r88, r89, r91, r92, r95, r96, r99 and r103 are formed by the first intermediate processing mode, but also these raster lines are treated as constituting the first lower edge correction pattern CP1. That is to say, as shown by the shading in the right diagram, the first lower edge correction pattern CP3 is constituted by raster lines of the intermediate/lower edge mixed region r86 to r103 and of the lower edge only region r104 to r121.

Here, comparing the combinations of nozzles forming adjacent raster lines in these correction patterns CP1, CP2 and CP3, these combinations are obviously the same as the combinations during actual printing, as can be seen from comparing them with the right diagrams in FIG. 21A and FIG. 21B, which show the combination of nozzles during actual printing.

That is to say, the combination of nozzles forming adjacent raster lines in the region r1 to r40 of the first upper edge correction pattern CP1 as shown in the right diagrams in FIG. 29A and FIG. 29B is the same as the combination of nozzles in the region r1 to r40 printed in the first upper edge processing mode during actual printing, as shown in the right diagram in FIG. 21A. Similarly, the combination of nozzles in the intermediate only region r41 to r85 of the first intermediate correction pattern CP2 as shown on the right side in FIG. 29A and FIG. 29B is the same as the combination of nozzles in the intermediate only region r41 to r85 printed in only the first intermediate processing mode during actual printing, as shown in the right diagram in FIG. 21A and FIG. 21B. Likewise, the combination of nozzles in the region r86 to r121 of the first lower edge correction pattern CP3 as shown in the right diagram in FIG. 29B is the same as the combination of nozzles in the region r86 to r121 printed in the first lower edge processing mode during actual printing, as shown in the right diagram in FIG. 21B.

Consequently, it can be seen that it is possible to reliably inhibit darkness non-uniformities of the image during actual printing, by correcting the darkness of each of the raster lines individually based on the correction patterns CP1, CP2 and CP3 formed for each of the processing modes.

It should be noted that the paper size used for printing the correction patterns CP in this example has been taken to be the first size, that is, a size of 110·D in the carrying direction, in order to emulate the same carrying operation and dot formation operation as during actual printing. Consequently, a portion at the uppermost edge and the lowermost edge of the print region r1 to r121 (mainly the portion that corresponds to the abandonment region) cannot be printed at this paper size, so that there are cases in which the correction patterns CP for this portion cannot be obtained.

In this case, a paper that is longer than, for example, 120·D should be used, such that all of the print region r1 to r121 can be covered with respect to the carrying direction. Then, the correction pattern printed on the paper of at least 120·D length is used as the correction patterns CP for the abandonment region, whereas the correction patterns CP printed on the paper of the first size should be used as the correction patterns CP for the portion apart from the abandonment region.

(2) Step S122: Measuring the Darkness of the Correction Pattern for Each Raster Line

The darkness of the correction patterns CP1, CP2 and CP3 shown in FIG. 29A and FIG. 29B is measured for each raster line by a darkness measurement device that optically measures this darkness. This darkness measurement device is capable of measuring the average darkness of a predetermined number of pixels in the raster line direction for each raster line individually. An example of such a device is a scanner as known in the art. It should be noted that the reason why the darkness of the raster lines is evaluated by the average darkness of a predetermined number of pixels is because even if the gradation values of all the pixels are equalized, the size of the dots that are formed in the pixels will differ from pixel to pixel due to the halftone processing. That is, one pixel will not necessarily be representative of the darkness of the entire raster line.

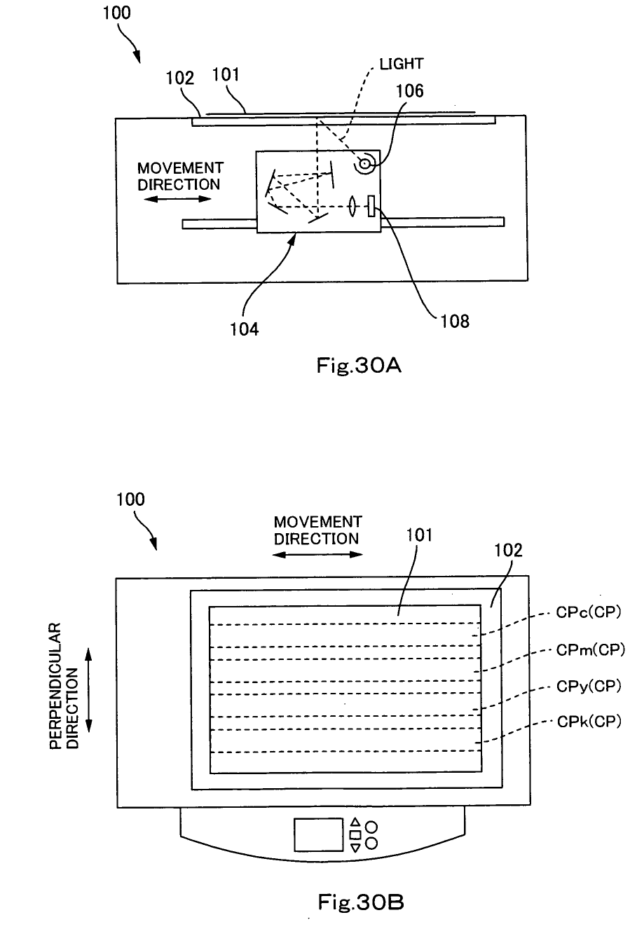

FIG. 30A and FIG. 30B show, respectively, a cross-sectional view and a top view of the scanner. The scanner 100 includes a document glass 102 on which a document 101 is placed, and a reading carriage 104 that faces the document 101 via this document glass 102 and that moves in a predetermined movement direction. The reading carriage 104 is provided with an exposure lamp 106 that irradiates light onto the document 101 and a linear sensor 108 for receiving the light that is reflected by the original document 101 over a predetermined range in a direction that is perpendicular to the movement direction. An image is read from the document 101 at a predetermined read resolution, while moving the reading carriage 104 in the movement direction. It should be noted that the dashed line in FIG. 30A indicates the path of the light.

As shown in FIG. 30B, the paper serving as the document 101, on which the correction patterns CP have been printed, is placed on the document glass 102, aligning its raster lines with the intersecting direction. Thus, the average darkness of a predetermined number of pixels in the raster line direction can be read for each raster line individually. It is preferable that that the reading resolution in the movement direction of the reading carriage 104 is several integer multiples narrower than the pitch of the raster lines. Thus, it is easy to correlate the measured darkness values that have been read in with the raster lines.

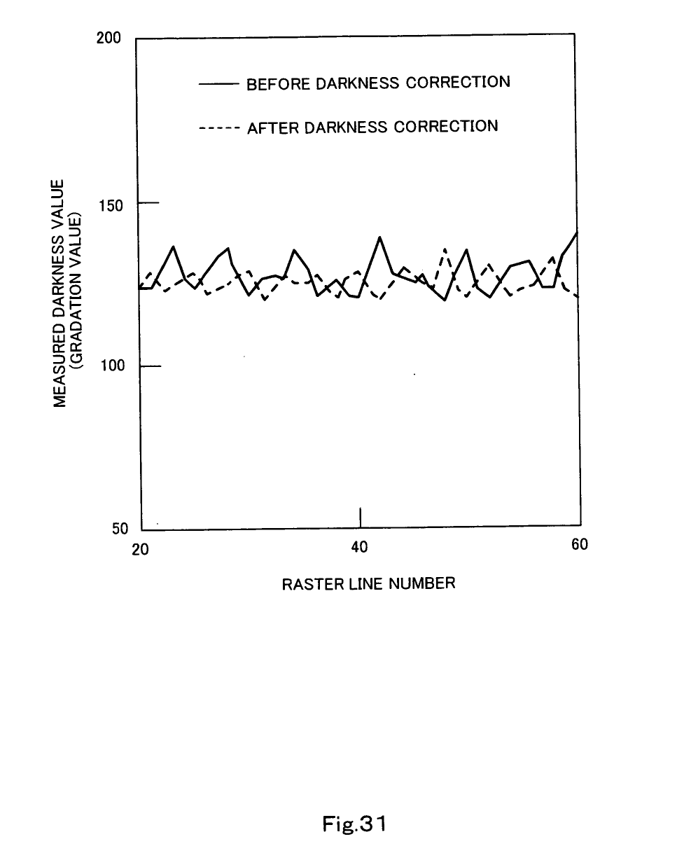

FIG. 31 shows an example of the measured darkness values of the correction pattern CPk. The horizontal axis of FIG. 31 denotes the raster line number and the vertical axis denotes the measured darkness value. The solid line in the figure denotes the measured values, and, for reference, the measured values after the darkness correction according to this first embodiment are also indicated by the broken line.

Even though printing was performed at a gradation value of the same darkness for all raster lines constituting the correction pattern CPk, the measured values indicated by the solid line vary greatly for each raster line. These are the darkness non-uniformities caused by the above-noted variations in the ink ejection direction. That is to say, the darkness of raster lines where the spacing of the adjacent raster lines is narrow is measured to be large, whereas the darkness of raster lines where this spacing is wide is measured to be low.

With the method for inhibiting darkness non-uniformities using the test pattern TP of this first embodiment, by performing the later-described darkness correction during the actual printing, the raster lines corresponding to those raster lines where the measured value is large are corrected so that their macroscopic darkness becomes smaller by making for example the dot creation ratio (corresponds to the above-noted level data) of the dots constituting the corresponding raster line smaller, whereas conversely the raster lines corresponding to those raster lines where the measured value is small are corrected so that their macroscopic darkness becomes larger by making the dot creation ratio of the dots constituting those raster line larger. As a result, darkness non-uniformities in the image are inhibited. Incidentally, when the correction pattern CPk for black (K) is printed while performing the later-described darkness correction, then the measurement result of that darkness is that the variations among the raster lines have been inhibited to smaller measurement values, as shown by the dashed line in FIG. 31.

Now, the scanner 100 is communicably connected to the computer 1100. Moreover, the measurement values of the darkness of the correction pattern read with the scanner 100 are recorded in a recording table arranged in the memory of the computer 1100, in association with the raster line numbers. It should be noted that the darkness measurement values output from the scanner 100 are grey-scale values (that is, data not representing color information but only brightness) represented by 256 gradation values. Here, the reason for using this grey-scale is that if the measurement values include color information, then a further process for expressing the measurement values by gradation values of that ink color must be performed, so that the processing becomes more complicated.

FIG. 32 is a diagrammatic view of the recording tables, which are divided by ink color and processing mode. The measurement values of the correction patterns CP printed in each section are recorded in the corresponding recording table.

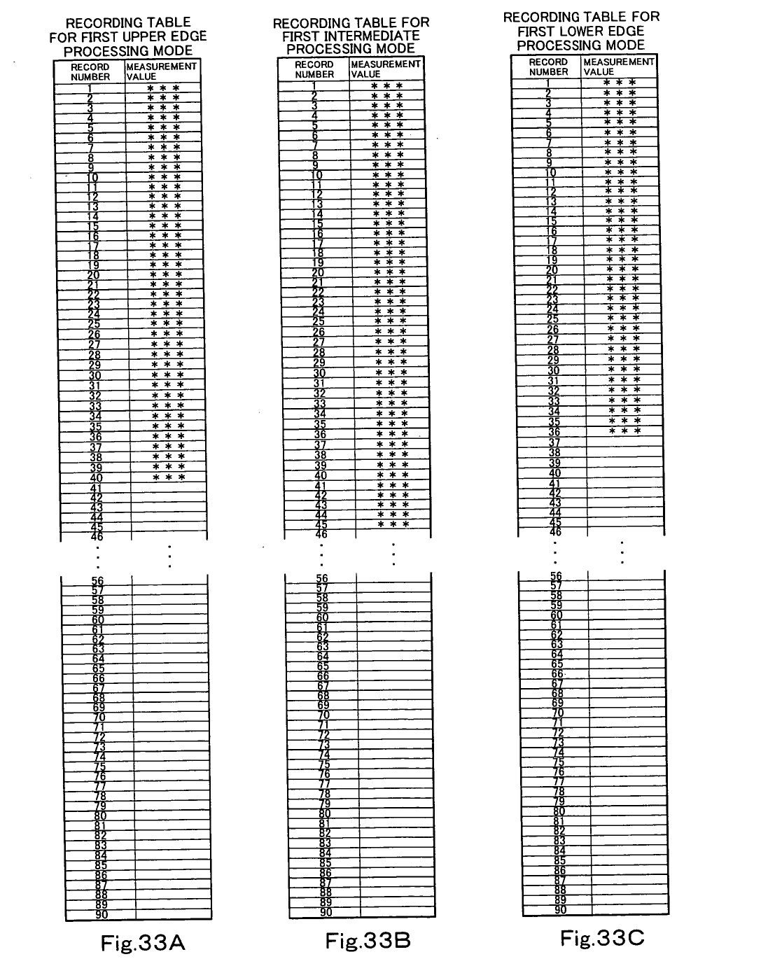

FIGS. 33A to 33C show the recording tables for the first upper edge processing mode, the first intermediate processing mode and the first lower edge processing mode, respectively, taking black (K) as a representative example. These recording tables each have records for recording the measurement values. A record number is given to each record, and the measurement values of the raster lines for low numbers in the corresponding correction patterns CP1, CP2, and CP3 are successively recorded from the records of low numbers. It should be noted that three asterisks “***” in FIGS. 33A to 33C denote a state in which a measurement value is recorded in the record, and a blank field denotes a state in which no record is made.

In the recording table for the first upper edge processing mode shown in FIG. 33A, the measurement values for the raster lines of the first upper edge correction pattern CP1 are recorded. It should be noted that, as mentioned before, this first upper edge correction pattern CP1 is constituted by the raster lines of the upper edge only region r1 to r22 and the upper edge/intermediate mixed region r23 to r40 shown in FIG. 29A, so that the measurement values of the raster lines of the upper edge only region and the intermediate mixed region are recorded in this recording table. Now, since there are 40 raster lines in these regions, the measurement values are recorded in the region from the first record to the 40th record in this recording table.

In the recording table for the first intermediate processing mode shown in FIG. 33B, the measurement values for the raster lines of the first intermediate correction pattern CP2 are recorded. As mentioned before, this first intermediate correction pattern CP2 is constituted by the raster lines of the intermediate only region r41 to r85 shown in FIG. 29A and FIG. 29B, so that the measurement values of the raster lines of the intermediate only region are recorded in this recording table. Now, since there are 45 raster lines in this region, the measurement values are recorded in the region from the first record to the 45th record in this recording table.

In the recording table for the first lower edge processing mode shown in FIG. 33C, the measurement values for the raster lines of the first lower edge correction pattern CP3 are recorded. As mentioned before, this first lower edge correction pattern CP3 is constituted by the raster lines of the intermediate/lower edge mixed region r86 to r103 and the lower edge only region r104 to r121 shown in FIG. 29B, so that the measurement values of the raster lines of the intermediate/lower edge mixed region and the lower edge only region are recorded in this recording table. Now, since there are 36 raster lines in these regions, the measurement values are recorded in the region from the first record to the 36th record in this recording table.

(3) Step S123: Setting the Darkness Correction Value for Each Raster Line

Next, the computer 1100 calculates the darkness correction values based on the measurement values that have been recorded in the records of the recording tables, and sets the correction values in the correction value tables in the memory 63 of the printer 1. FIG. 34 is a diagrammatic view of these correction value tables, which are prepared as divided by ink color and processing mode, just like the aforementioned recording tables.

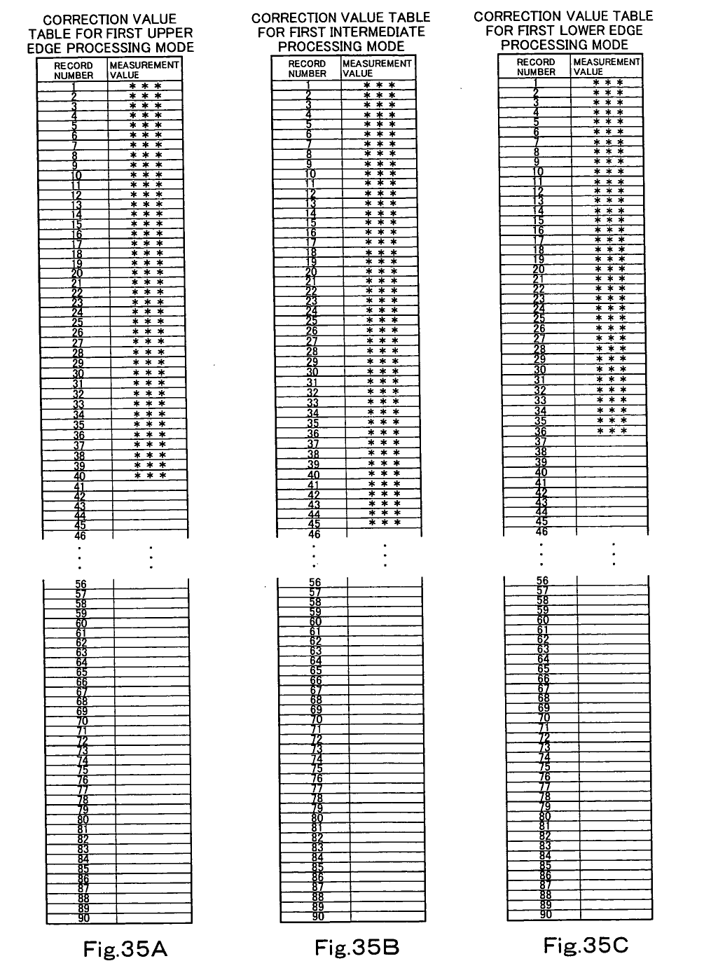

FIGS. 35A to 35C show the correction value tables for the first upper edge processing mode, the first intermediate processing mode and the first lower edge processing mode for black (K), respectively, as representative examples of the correction value tables. These correction value tables each have records for recording the correction values. Each record is assigned a record number, and a correction value calculated based on the measurement values is recorded in the record having the same record number as the record for those measurement values.

For example, in the records from the first record to the 40th record of the correction value table for the first upper edge processing mode shown in FIG. 35A, the correction values calculated based on the measurement values recorded from the first record to the 40th record of the recording table for the first upper edge processing mode are recorded. That is to say, the correction values corresponding to the upper edge only region and the upper edge/intermediate mixed region are recorded in this correction value table.

Similarly, in the records from the first record to the 45th record of the correction value table for the first intermediate processing mode shown in FIG. 35B, the correction values calculated based on the measurement values recorded from the first record to the 45th record of the recording table for the first intermediate processing mode are recorded. That is to say, the correction values corresponding to the intermediate only region are recorded in this correction value table.

Furthermore, in the records from the first record to the 36th record of the correction value table for the first lower edge processing mode shown in FIG. 35C, the correction values calculated based on the measurement values recorded from the first record to the 36th record of the recording table for the first lower edge processing mode are recorded. That is to say, the correction values corresponding to the intermediate/lower edge mixed region and the lower edge only region are recorded in this correction value table.

These correction values are obtained in the format of a correction ratio indicating the proportion of correction with respect to the darkness gradation value. More specifically, they are calculated as follows. First, an average value M of the measurement values recorded in the recording tables is calculated for each of the recording tables, and the calculated average values are taken as a target value M of the darkness for each recording table. Then, for each measurement value C in the recording tables, the deviation ΔC(=M−C) between this target value M and the measurement value C is calculated, and the value obtained by dividing the deviation ΔC by the target value M is taken as the correction value H. That is to say, this correction value H can be expressed by the following Equation 1:

$$\begin{matrix}correction value H = Δ C / M \\ = ( M - C ) / M\end{matrix} \qquad ( Eq . 1 )$$

Then, using this correction value H, it is possible to perform such a correction on the raster lines for which the measurement value C is higher than the target value M that the darkness of those raster lines is reduced to the target value M. For example, if the measurement value C of a raster line is 105 and the target value M is 100, then the correction value H(=(100−105)/100) is −0.05, and the darkness of the printed raster line can be set closer to the target value M=100 by reducing the gradation value of the darkness of this raster line by a factor of 0.05 when printing. It is also possible to perform such a correction on the raster lines for which the measurement value C is lower than the target value M that the darkness of those raster lines is increased to the target value M. For example, if the measurement value C of a raster line is 95 and the target value M is 100, then the correction value H(=(100−95)/100) is +0.05, and the darkness of the printed raster line can be set closer to the target value M=100 by increasing the gradation value of the darkness of this raster line by a factor of 0.05 when printing.

Thus, by using this correction value H to perform a darkness correction, which is discussed later, variations in the darkness of each raster line can be made small for each ink color and processing mode, thus making it possible to inhibit darkness non-uniformities.

<Step S140: Actual Printing of the Image While Performing Darkness Correction for Each Raster Line>

When the darkness correction values are set in this manner, the printer 1 can inhibit darkness non-uniformities when printing, by performing a darkness correction for each raster line, using the correction value tables prepared for each ink color and for each processing mode. It should be noted that this darkness correction for each raster line is achieved by correcting the pixel data based on the correction values when the printer driver 1110 converts the RGB image data into print data. That is to say, as noted above, the pixel data is ultimately turned into 2-bit pixel data indicating the size of the dots formed on the paper, and the macroscopic darkness of the raster lines printed based on this data is changed by changing this 2-bit pixel data.

(1) Darkness Correction Procedure

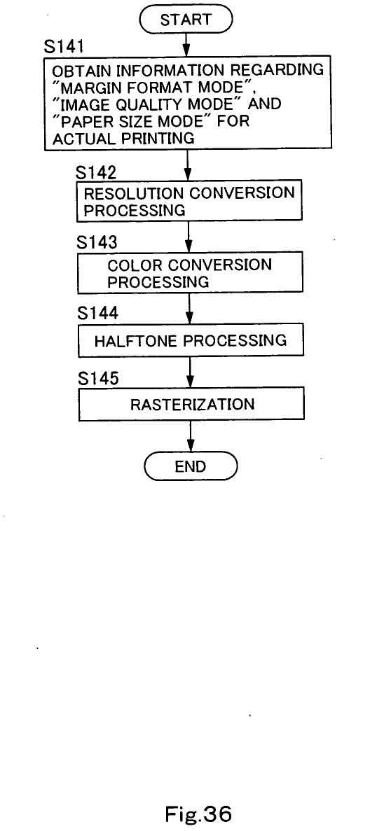

FIG. 36 is a flowchart showing the procedure for correcting the darkness of each raster line in Step S140 of FIG. 26. Hereinafter, the darkness correction procedure is described with reference to this flowchart.

Step S141: First, the user communicably connects the printer 1 that he has purchased to his computer 1100, establishing a printing system as illustrated in FIG. 1. The user then inputs the margin format mode, the image quality mode, and the paper size mode through the user interface screen of the printer driver 1110 in the computer 1100. With this input, the printer driver 1110 obtains information on these modes, for example. In the following explanations, it is assumed that “high” is input as the image quality mode, “borderless” is input as the margin format mode, and further the above-noted “first size” is input as the paper size mode.

Step S142: Next, the printer driver 1110 subjects the RGB image data that has been output from the application program 1104 to a resolution conversion process. That is to say, the resolution of the RGB image data is converted to the print resolution corresponding to the image quality mode, and moreover, the number of pixels in the RGB image data is matched to the dot number of the print region corresponding to the paper size and the margin format mode by trimming the RGB image data as appropriate.

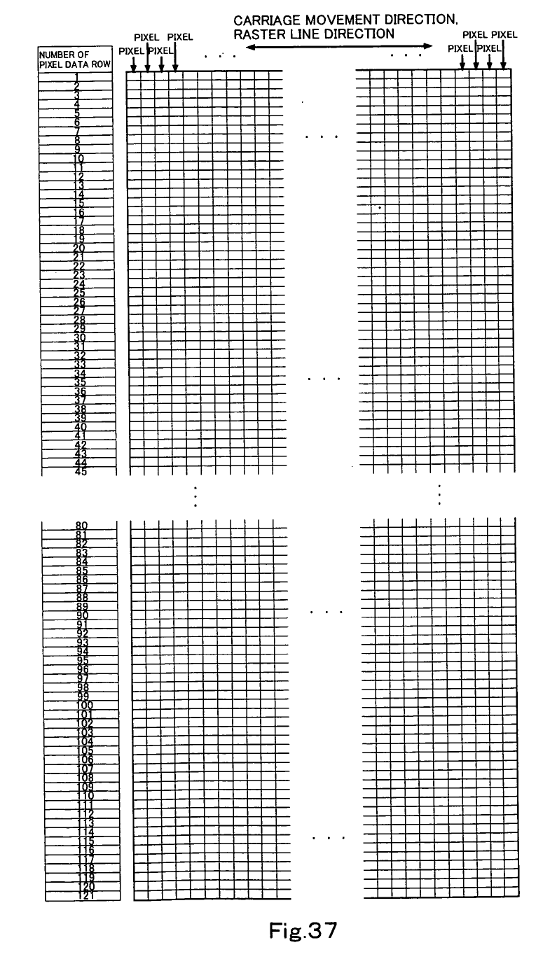

FIG. 37 is a diagrammatic view showing an array of pixel data according to the RGB image data after the resolution conversion process. Each of the squares in the figure represents a pixel of 720×720 dpi size, and each pixel has pixel data. Here, “high” has been input as the image quality mode, so that the resolution of the RGB image data is converted to 720×720 dpi. Also, “first size” has been input as the paper size mode and “borderless” has been input as the margin format mode, so that the size of the print region is 121·D in the carrying direction, and the RGB image data corresponding to this is processed to a number of 121 pixels in the carrying direction. That is to say, the RGB image data is processed to a state in which there are 121 pixel data rows constituted by data for a plurality of pixels running in the direction of the raster lines.

It should be noted that the pixel data rows are data for forming the raster lines in the print region r1 to r121 of the image. That is to say, the first pixel data row is the data of the uppermost first raster line r1 of the print region r1 to r121, and the second pixel data row is the data of the second raster line r2. From there on, the pixel data rows correspond numerically to the raster lines, and the last, 121st pixel data row is the data of the lowermost, 121st raster line r121 of the print region r1 to r121.

Step S143: Next, the printer driver 1110 performs the above-described color conversion to convert the RGB image data into CMYK image data. As mentioned above, the CMYK image data includes C image data, M image data, Y image data, and K image data, and these C, M, Y, and K image data are each made of 121 rows of pixel data as mentioned above.

Step S144: Next, the printer driver 1110 performs halftone processing. Halftone processing is processing for converting the 256 gradation values given by the pixel data in the C, M, Y, and K image data into gradation values of four gradations. It should be noted that the pixel data of these four gradation values is 2-bit data indicating “no dot formation,” “small dot formation,” “medium dot formation,” and “large dot formation.”

Then, in the method for inhibiting darkness non-uniformities of this first embodiment, the darkness correction is performed for each raster line during this halftone processing. In other words, the conversion of the pixel data constituting the image data from 256 gradations to one of four gradations is performed while correcting the pixel data by an amount corresponding to the correction value. Darkness correction is performed for each of the C, M, Y, and K image data values based on the correction value table for each ink color, but here the K image data for black (K) is described as representative image data. Moreover, in the above-noted color conversion process, the array of the pixel data does not change, so that in the following explanations, FIG. 37 is used also as the figure representing the array of the pixel data of the K image data.

First, the printer driver 1110 references the first reference table (FIG. 19) using the margin format mode and the image quality mode as the key to obtain the corresponding print mode. The printer driver 1110 then references the second reference table (FIG. 20) using the print mode as the key to specify the processing mode to be used during actual printing of the image.

If a single processing mode is specified, then the correction value table for that processing mode is used to correct the pixel data rows in the K image data.

On the other hand, if a plurality of processing modes have been specified, then the regions that are to be printed by each processing mode are specified in accordance with the paper size mode. Then, the correction value table for each processing mode is used to correct the image data rows corresponding to the regions to be printed by that processing mode.

It should be noted that the information on the regions that are printed by the processing modes is recorded in a region determination table. The region determination table is stored in the memory in the computer 1100, and the printer driver 1110 references this region determination table to specify the region that is printed by each processing mode.

For example, as shown in FIG. 21A, the upper edge only region and the upper edge/intermediate mixed region that are printed by the first upper edge processing mode are formed in a fixed number of eight passes as discussed above, and thus it is known in advance that this region will have 40 raster lines from the uppermost edge of the print region downstream. Consequently, “region from uppermost edge of print region to the 40th raster line” is recorded in the region determination table in association with the first upper edge processing mode.

Similarly, as shown in FIG. 21B, the intermediate/lower edge mixed region and the lower edge only region printed in the first lower edge processing mode are formed in a fixed number of eight passes as discussed above, and thus it is known in advance that this region will have 36 raster lines from the lowermost edge of the print region upward. Consequently, “region from lowermost edge of the print region to the 36th raster line on upper edge side thereof” is recorded in the region determination table in association with the first lower edge processing mode.

Next, as shown in FIG. 21A and FIG. 21B, the intermediate only region that is printed in the first intermediate processing mode only is the region that continues toward the lower edge from the region that is printed by the first upper edge processing mode mentioned above, and is also the region that continues toward the upper edge from the region that is printed by the first lower edge processing mode mentioned above. Thus, the intermediate only region is known in advance to be the region that is sandwiched by the 41st raster line toward the lower edge from the uppermost edge of the print region and the 37th raster line toward the upper edge from the lowermost edge of the print region. Consequently, “region sandwiched by the 41st raster line toward the lower edge from the uppermost edge of the print region and the 37th raster line toward the upper edge from the lowermost edge of the print region” is recorded in the region determination table in association with the first intermediate processing mode.

In this example, the modes are “borderless” and “high,” and thus the printer driver references the first and second reference tables shown in FIG. 19 and FIG. 20 and specifies “first print mode” as the print mode, and specifies the three corresponding processing modes of first upper edge processing mode, first intermediate processing mode, and first lower edge processing mode as the corresponding processing modes for the actual printing.

Also, because the paper size mode is “first size,” the print region during the actual printing is 121·D in the carrying direction, and as discussed above, because three processing modes are specified, the regions that are printed by the respective processing modes are specified by referencing the region determination table, and the pixel data rows corresponding to the respective regions are corrected.

For example, the upper edge only region and the upper edge/intermediate mixed region that are printed through the first upper edge processing mode are specified from the region determination table as the region r1 to r40 within the print region r1 to r121. The data of the raster lines of the region r1 to r40 are the pixel data rows from the first row to the 40th row of the K image data. On the other hand, the correction values corresponding to the upper edge only region and the upper edge/intermediate mixed region are recorded in the first through 40th records in the correction value table for the first upper edge processing mode. Consequently, the pixel data making up each pixel data row is corrected while correlating the correction values of the first through 40th records of the correction value table for the first upper edge processing mode successively with the first through 40th pixel data rows.

Similarly, the intermediate/lower edge mixed region and the lower edge only region that are printed in the first lower edge processing mode are specified as the region r86 to r121 within the print region r1 to r121, based on the region determination table. The data of the raster lines of the region r86 to r121 are the pixel data rows from the 86th row to the 121st row of the K image data. On the other hand, the correction values corresponding to the intermediate/lower edge mixed region and the lower edge only region are recorded in the first through 36th records of the correction value table for the first lower edge processing mode. Consequently, the pixel data making up each pixel data row is corrected while correlating the correction values of the first through 36th records of the correction value table for the first lower edge processing mode successively with the first through 36th pixel data rows.

The intermediate only region, which is printed in the first intermediate processing mode only, is specified as the region r41 to r85 of the print region r1 to r121 based on the region determination table. The data of the raster lines of the region r41 to r85 are the pixel data rows of the 41st to 85th rows in the K image data. On the other hand, the correction values corresponding to the intermediate only region are recorded in the first through 45th records of the correction value table for the first intermediate processing mode. Consequently, the pixel data making up each pixel data row are corrected while correlating the correction values of the first through 45th records of the correction value table for the first intermediate processing mode successively with the 41st through 85th pixel data rows.

As mentioned above, the number of passes of the first intermediate processing mode is not fixed like that of the first upper edge processing mode, for example, but changes depending on the paper size mode that has been input. Therefore, the number of pixel data rows in the intermediate only region varies. The correction value table for the first intermediate processing mode includes correction values for only the fixed number of 45 records from the first record through the 45th record, creating a risk that the number of correction values may become insufficient in the latter half of correlating them to a pixel data row.

This is dealt with by utilizing the periodicity of the combination of nozzles forming adjacent raster lines. In other words, as shown in the right diagrams of FIG. 21A and FIG. 21B, the order of the nozzles forming the raster lines in the intermediate only region r41 to r85, which is printed by only the first intermediate processing mode, in a single cycle is #2, #4, #6, #1, #3, #5, and #7, and this cycle is repeated. This cycle is increased by one cycle each time the pass number of the first intermediate processing mode increases by one. Consequently, it is possible to use the correction values of this one cycle for row numbers that do not have a corresponding correction value. That is, the correction values from the first record to the seventh records, for example, corresponding to the correction values of this one cycle can be used repeatedly for however many correction values are insufficient.

Incidentally, in the above explanation of Step S144, the method for correcting the pixel data based on the correction values has not been explained in detail, and this will be discussed later.

Step S145: Next, the printer driver 1110 performs a rasterization process. The rasterized print data is output to the printer 1, and the printer 1 performs actual printing of the image on paper in accordance with the pixel data of the print data. It should be noted that as discussed above, the darkness of the pixel data has been corrected for each raster line individually, so that darkness non-uniformities in the image can be inhibited.

(2) Regarding the Method for Correcting the Pixel Data Based on the Correction Values

Next, a method for correcting the pixel data based on the correction values is described in detail.

As mentioned above, pixel data having 256 gradation values is converted through halftone processing into pixel data having four gradation values representing “no dot formation,” “small dot formation,” “medium dot formation,” and “large dot formation”. During this conversion, the 256 gradations are first substituted with level data and then converted into four gradations.

Accordingly, in this method for inhibiting darkness non-uniformities according to the first embodiment, at the time of this conversion, the level data is changed by an amount corresponding to the correction value so as to correct the pixel data of gradation values having four gradations, thus realizing a “correction of pixel data based on the correction values.”

It should be noted that the halftone processing in this first embodiment differs from the halftone processing that has been described using FIG. 3 in that it includes steps S301, S303, and S305 for setting the level data, but otherwise it is the same. Consequently, the following description focuses on this difference, and aspects that are the same are described only summarily. Also, the following description refers to the flowchart of FIG. 3 and the dot creation ratio table of FIG. 4.

First, as in ordinary halftone processing, the printer driver 1110 obtains the K image data in Step S300. It should-be noted that at this time the C, M, and Y image data also are obtained, but because the following description can be applied to any of the C, M, and Y image data as well, the description is made with the K image data as representative image data.

Next, in Step S301, for each pixel data value, the level data LVL corresponding to the gradation value of that pixel data is read in from the large dot profile LD of the creation ratio table. However, in this first embodiment, when reading the level data LVL, the gradation values are shifted by the correction value H corresponding to the pixel data row to which the pixel data belongs.

For example, if the gradation value of the pixel data is gr and the pixel data row to which that pixel data belongs is the first row, then that pixel data row is correlated with the correction value H of the first record in the correction value table for first upper edge processing. Consequently, the level data LVL is read while shifting the gradation value gr by a value Δgr(=gr×H) that is obtained by multiplying the correction value H by the gradation value gr, obtaining a level data LVL of 11d.

In Step S302, it is determined whether or not the level data LVL of this large dot is greater than the threshold value THL of the pixel block corresponding to that pixel data on the dither matrix. Here, the level data LVL is changed by an amount corresponding to Δgr(=gr×H), in accordance with the correction value H. Consequently, the result of this size determination is changed by that amount of change, and thus the ease with which a large dot is formed also changes, thus achieving the “correction of pixel data in accordance with the correction value” mentioned above.

It should be noted that if in Step 302 the level data LVL is larger than the threshold value THL, then the procedure advances to Step S310 and a large dot is recorded in association with that pixel data. Otherwise the procedure advances to Step S303.

In Step S303, the level data LVM corresponding to the gradation value is read from the medium dot profile MD of the creation ratio table, and also at this time, as in Step S301, the level data LVM is read while shifting the gradation value by an amount corresponding to the correction value H.

For example, the level data LVM is read while shifting the gradation value gr by a value Δgr(=gr×H) that is obtained by multiplying the correction value H by the gradation value gr, obtaining a level data LVM of 12d. Then, in Step S304, it is determined whether or not the level data LVM of this medium dot is greater than the threshold value THM of the pixel block corresponding to that pixel data on the dither matrix. Here, the level data LVM is changed by an amount corresponding to Δgr, in accordance with the correction value H. Consequently, the result of this size determination is changed by that amount of change, and thus the ease with which a medium dot is formed also changes, thus achieving the “correction of pixel data in accordance with the correction value” mentioned above.

It should be noted that if in Step 304 the level data LVM is larger than the threshold value THM, then the procedure advances to Step S309 and a medium dot is recorded in association with that pixel data. Otherwise the procedure advances to Step S305.

In Step S305, the level data LVS corresponding to the gradation value is read from the small dot profile SD of the creation ratio table, and also at this time, as in Step S301 the level data LVS is read while shifting the gradation value by an amount corresponding to the correction value H.

For example, the level data LVS is read while shifting the gradation value gr by a value Δgr(=gr×H) that is obtained by multiplying the correction value H by the gradation value gr, obtaining a level data LVS of 13d. Then, in Step S306, it is determined whether or not the level data LVS of this small dot is greater than the threshold value THS of the pixel block corresponding to that pixel data on the dither matrix. Here, the level data LVS is changed by an amount corresponding to Δgr, in accordance with the correction value H. Therefore, the result of this size determination is changed by that amount of change, and thus the ease with which a small dot is formed also changes, thus achieving the “correction of pixel data in accordance with the correction value” mentioned above.

It should be noted that if in Step 306 the level data LVS is larger than the threshold value THS, then the procedure advances to Step S308, and a small dot is recorded in association with that pixel data. Otherwise the procedure advances to Step S307 and no dot is recorded corresponding to that pixel data.

(3) Regarding the “Darkness Correction Procedure” in the Case that the Second Print Mode has been Set

In the explanation of “(1) Darkness Correction Procedure”, an example was given of a case in which the first print mode was set, but here, the case that the second print mode is set is explained.

This corresponds to the case that the user has entered “bordered” as the margin format mode and “high” as the image quality mode in the interface of the printer driver 1110. Then, the printer 1 performs printing only in the first intermediate processing mode shown in FIG. 19, and prints a bordered image with a print resolution of 720×720 dpi on paper.

Step S141: First, the printer driver 1110 obtains “high” as the image quality mode, “bordered” as the margin format mode and “first size” as the paper size mode, through input from the user interface of the printer driver 1110.

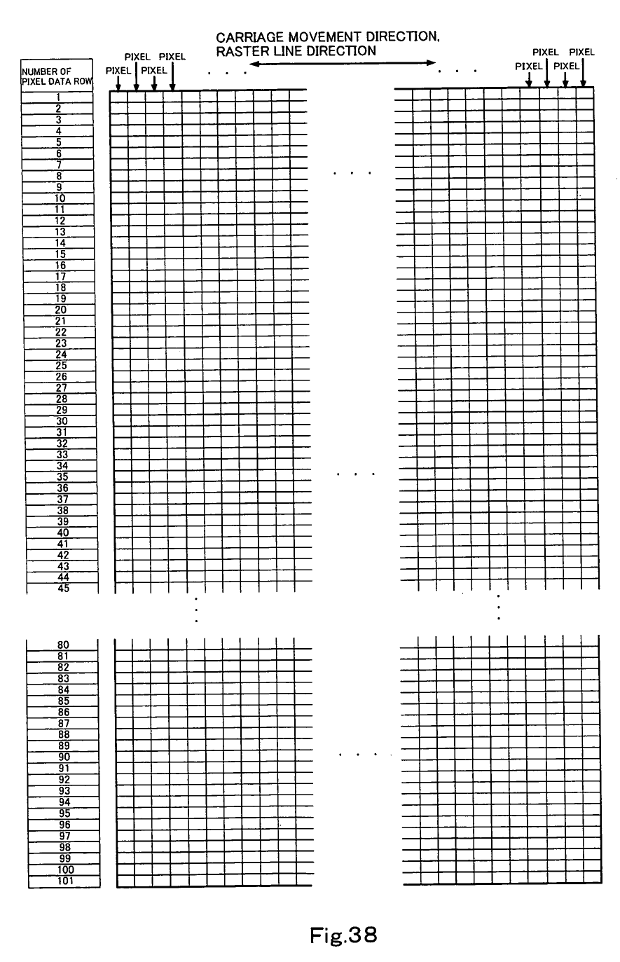

Step S142: Next, the printer driver 1110 performs a resolution conversion process. FIG. 38 is a diagrammatic view showing an array of pixel data according to the RGB image data after the resolution conversion process. In accordance with the “high” mode, the resolution of the RGB image data is converted to 720×720 dpi. Also, the “first size” and “bordered” print region r1 to r101 has the size 101·D in the carrying direction, and the RGB image data corresponding to this is processed to 101 pixel data rows.

Step S143: Next, the printer driver 1110 performs color conversion to convert the RGB image data into CMYK image data. As in the foregoing, the following is an explanation for the K image data as representative of CMYK image data. It should be noted that the K image data has 101 pixel data rows, just like the RGB image data.

Step S144: Next, the printer driver 1110 performs halftone processing. As in the previous examples, darkness correction is performed for each raster line individually during this halftone processing. The following explanation uses FIG. 38 as the figure representing the pixel array of the K image data.

First, the printer driver 1110 references the first reference table (FIG. 19) using “bordered” and “high” as the key to specify that the corresponding print mode is the second print mode. The printer driver 1110 then references the second reference table (FIG. 20) using this second print mode as the key to specify that only the first intermediate processing mode is to be used during actual printing of the image. That is to say, in this case, it is specified that the entire print region is the intermediate only region. Therefore, there is no need to specify the printed regions by processing mode through referring to the region determination table, and thus all pixel data rows of the K image data, which are the data of the entire print region, are corrected using the correction value table for the first intermediate processing mode that stores the correction values corresponding to the intermediate only region.

Here, as can be seen from the right diagrams in FIG. 22A and in FIG. 22B, the order of the nozzles forming the raster lines in the print region r1 to r101 is the above-noted cycle, that is, #2, #4, #6, #1, #3, #5, #7 repeated in that order. Consequently, when correcting the pixel data rows in the K image data, the correction is performed using, in repetition, the correction values from the first record to the seventh record in the correction value table mentioned above from the first pixel data row to the 101st pixel data row.

Step S145: Next, the printer driver 1110 performs a rasterization process. The rasterized print data is output to the printer 1, and the printer 1 performs actual printing of the image on paper in accordance with the pixel data of the print data. It should be noted that as discussed above, the darkness of the pixel data has been corrected for each raster line individually, so that darkness non-uniformities in the image can be inhibited.

===Method for Inhibiting Darkness Non-Uniformities Using the Test Pattern of the Second Embodiment===

### Problems in the Method for Inhibiting Darkness Non-Uniformities Using the Test Pattern of the First Embodiment

In the method for inhibiting darkness non-uniformities according to the first embodiment, a correction pattern with one darkness gradation value was printed for each ink color as the test pattern TP. However, this is problematic with regard to the above-noted “setting of the darkness correction values for inhibiting darkness non-uniformities”, or more specifically, with regard to the method for calculating the darkness correction values.

Here, the “method for calculating the darkness correction values” according to the first embodiment is explained once more. As noted above, in this method for calculating the darkness correction values, the darkness correction value for each raster line is determined from the following Equation 1.

$$\begin{matrix}correction value H = Δ C / M \\ = ( M - C ) / M\end{matrix} \qquad ( Eq . 1 )$$

In Equation 1, C is the measured darkness value of each raster line in the correction pattern. Furthermore, M is the average value of the measured values across all raster lines. Then, the pixel data of the image data is corrected using this correction value H, thereby correcting the darkness of the raster line. It should be noted that the gradation value of the pixel data corresponds to the command value of the darkness.

More specifically, explaining this with an example for the case that the gradation value of the pixel data is M, the idea is that in the raster lines where the correction value H is ΔC/M, the measurement value C of this darkness is changed through the correction by ΔC(=H×M) and becomes the target value M. In order for it to change in this way, when reading the level data corresponding to the gradation value M of the pixel data from the dot creation ratio table in FIG. 4, the correction amount ΔC is calculated by multiplying the gradation value M by the correction value H(=ΔC/M), and the level data is read out after shifting for this correction amount ΔC from the gradation value M. Then, the size of the dots to be formed is determined with the level data and the dither matrix (see FIG. 5). At this time, the measurement value C of the darkness of the raster line is corrected by changing the size of the formed dots by an amount corresponding to the change of the level data by ΔC.

However, even if the gradation value M for reading out the level data is changed by ΔC, there is no guarantee that the darkness measurement value C of the raster line is reliably changed by ΔC and ultimately becomes the target value M. That is to say, with this correction value H, it is possible to let the measurement value C approach the target value M, but it is not possible to let it approach so much that the two substantially match.

Therefore, it used to be customary to repeat a series of operations of printing correction patterns while changing the correction value H and measuring the darkness thereof, in a manner of trial and error, until the measurement value C becomes the target value, thereby finding the optimum correction value H. This operation required a lot of manpower.

Accordingly, in a method for inhibiting darkness non-uniformities using a test pattern TP of a second embodiment, correction patterns of at least two darknesses are printed with different gradation values (darkness command values) as the test pattern TP, and the darkness of these correction patterns is measured. The correction value H at which the measurement value C assumes the target value is calculated by linear interpolation of these two pairs of information (where measurement value and command value are regarded as one pair). Thus, when calculating the correction value H, the correction value H can be found with one operation and without the above-described repeated trial-and-error operation.

### Method for Setting the Correction Value Using the Test Pattern of the Second Embodiment

The following is an explanation of a method for setting the correction value using the test pattern TP of the second embodiment, but most of this explanation is the same as for the method for setting the correction value using the test pattern TP of the first embodiment. Thus, the following explanations focus on the differences, and like portions are only explained where this is necessary to appreciate this second embodiment. The following explanations refer to the flowchart in FIG. 27.

First, an broad overview is given.

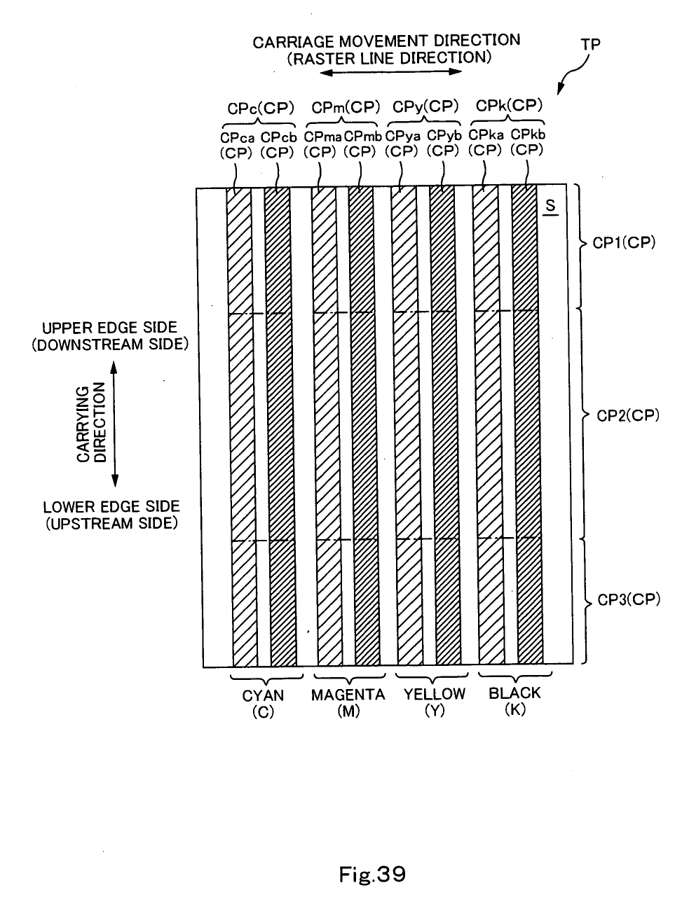

Step S121: First, an operator of the inspection line connects the printer 1 to a computer 1100 or the like on the inspection line and, using the printer 1, prints the above-noted stripe-shaped correction pattern CP for each of the ink colors CMYK, as the test pattern TP. However, in this test pattern TP of the second embodiment, at least two correction patterns CP for each ink color are printed with different darkness command values (see FIG. 39).

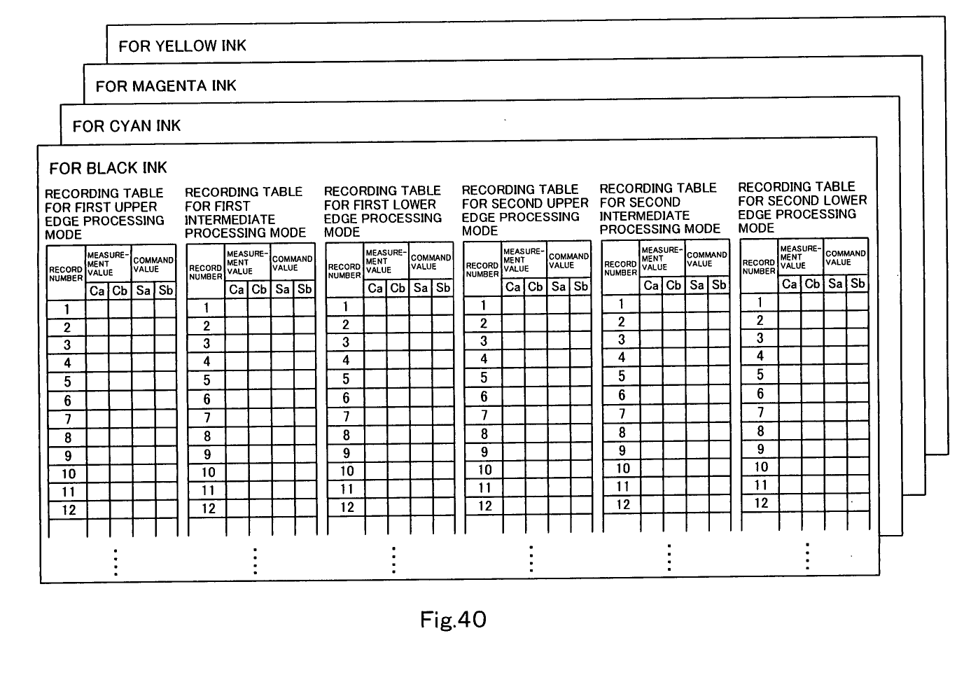

Step S122: Next, the darkness of the printed correction patterns CP is measured for each raster line, and the measured values are recorded in recording tables in association with the raster line numbers. It should be noted that this measurement is carried out independently for each of the at least two correction patterns CP of different darknesses. Moreover, this recording is performed while associating the measurement values Ca and Cb of the two correction patterns CP, CP with one another, and associating the command values Sa and Sb with the measurement values Ca and Cb (see FIG. 40).

Step S123: Next, the computer 1100 calculates a darkness correction value H for each raster line, based on the measurement values Ca and Cb recorded in the recording tables, and records these correction values H in correction value tables in association with the raster line numbers. These correction value tables are the same as the correction value tables of the first embodiment shown in FIG. 34. However, for this calculation, the command value So at which the measurement value C matches the later-described target value Ss1 is determined by performing a linear interpolation using the associated measurement values Ca and Cb and the command values Sa and Sb of these measurement values Ca and Cb. Then, the value obtained by dividing deviation between the determined command value So and the later-described reference value Ss by this reference value Ss is recorded as the correction value H. In the present embodiment, the correction value H is calculated through such a linear interpolation, so that it is possible to determine the optimum correction value H through a single calculation operation, and thus without repeating a trial-and-error operation as in the first embodiment.

Referring to two specific examples, the following is a more detailed explanation of the method for setting the correction value using the test pattern TP of the second embodiment.

(A) First Specific Example of the Method for Setting the Darkness Correction Values

FIG. 39 shows a test pattern TP according to a first specific example. In this first specific example, two correction patterns CP of different darkness are printed for each of the CMYK ink colors as the test pattern TP.

(1) Step S121: Printing the Test Pattern

First, the printer 1 whose correction values are to be set is connected in a communicable manner to the computer 1100 on the inspection line. Based on the print data of the test pattern TP stored in the memory of the computer 1100, the printer 1 prints the test pattern TP on a paper S. It should be noted that similar to the first embodiment, it is assumed that “borderless” has been set as the margin format mode, “high” has been set as the image quality mode and “first size” has been set as the paper size mode.

As shown in FIG. 39, two stripe-shaped correction patterns CP are formed on the paper S for each of the CMYK ink colors, as the test pattern TP. The following explanations refer to black (K) as a representative example of those ink colors, but the other ink colors are similar.

The two correction patterns CPka and CPkb of the correction pattern CPk for black (K) are printed with different darknesses.

It should be noted that the print data for printing these correction patterns CPka and CPkb are configured by directly specifying the gradation values of the CMYK ink colors, as explained for the above-described first embodiment, and in this particular case are configured by specifying the gradation value of black (K). That is to say, the print data is set to -different values, namely a gradation value Sa of pixel data corresponding to the correction pattern CPka and a gradation value Sb of pixel data corresponding to the correction pattern CPkb in the CMYK image data, and is generated for this CMYK image data through the above-described halftone process and rasterization process. It should be noted that the gradation values Sa and Sb correspond to the command values of the darkness for the correction patterns CPka and CPkb.

These gradation values Sa and Sb are set such that their median value becomes the reference value Ss, and are for example set to values of the reference value Ss±10%. It should be noted that the reference value Ss is a gradation value that is optimal for determining the correction value H, and is selected for example as a gradation value at which darkness non-uniformities tend to be conspicuous. As noted above, this gradation value at which darkness non-uniformities tend to be conspicuous is a gradation value that is in a so-called intermediate gradation region with respect to CMYK colors, and in the case of black (K), it corresponds to a gradation value in the range of 77 to 128, among the 256 gradation values.

Needless to say, these two correction patterns CPka and CPkb each include a first upper edge correction pattern CP1, a first intermediate correction pattern CP2 and a first lower edge correction pattern CP3, extending in the carrying direction.

(2) Step S122: Measuring the Darkness of the Correction Pattern for Each Raster Line

The darkness of the two correction patterns CPka and CPkb shown in FIG. 39 is measured raster line by raster line with the scanner 100.

It should be noted that as in the above-described first embodiment, the scanner 100 outputs the measured values Ca and Cb in 256 grey-scale gradation values to the computer 1100. Then, the computer 1100 records the measurement values Ca and Cb represented by these grey-scale gradation values in a recording table provided in its memory.

As shown in FIG. 40, the recording tables of the first specific example according to the second embodiment are each provided with four fields, such that they can store the measurement values Ca and Cb of the two correction patterns CPka and CPkb, and the command values Sa and Sb that are respectively associated with these measurement values Ca and Cb. In the records of the first field and the third field from the left of the table, the measurement value Ca and its command value Sa for the correction pattern CPka with the lower darkness are recorded. In the records of the second field and the fourth field, the measurement value Cb and its command value Sb for the correction pattern CPkb, which has the higher darkness, are recorded. It should be noted that during this recording, the measurement values Ca and Cb and the command values Sa and Sb for the same raster line number of the two correction patterns CPka and CPkb are, of course, recorded in records of the same record number.

(3) Step S123: Setting the Darkness Correction Values for Each Raster Line

Next, as in the case of the above-described first embodiment, the darkness correction value H is calculated from the measurement values Ca and Cb recorded in the records of the recording tables, and this correction value H is set in the correction value table.

However, in the first specific example according to the second embodiment, a linear interpolation is performed using two pairs of information (Sa, Ca) and (Sb, Cb), the pairs being given by the command values Sa and Sb and the measurement values Ca and Cb recorded in the records of the same record numbers. Thus, it is possible to calculate the correction value in one operation without repeating the calculation operation by trial and error, as explained above. It should be noted that the procedure of calculating the correction value H explained below is, of course, performed individually for each record number.

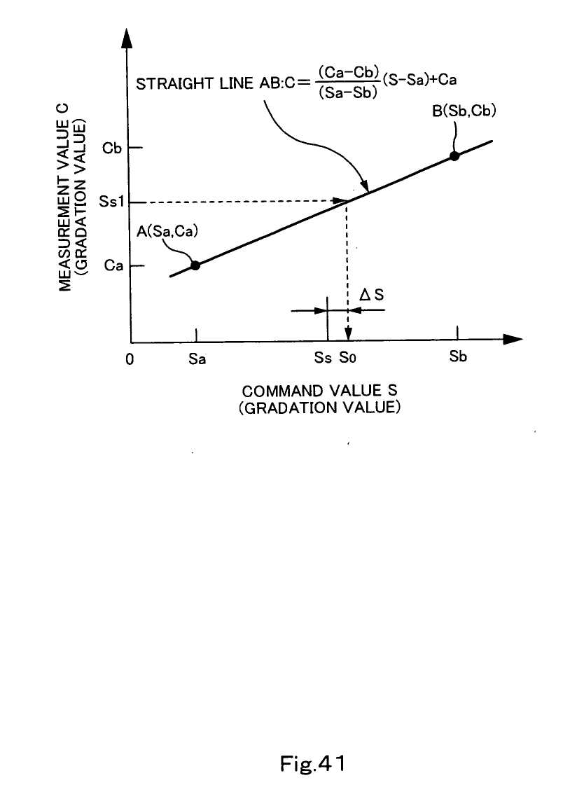

FIG. 41 is a graph illustrating the linear interpolation performed using these two pairs of information (Sa, Ca) and (Sb, Cb). The horizontal axis of this graph corresponds to the gradation value of black (K) serving as the command value S, and the vertical axis corresponds to the gradation value of the grey-scale serving as the measurement value C. The coordinates of the points on the graph are indicated by (S,C).

As is well known, in a linear interpolation, a function value between two known values or outside thereof, is determined as the point for which all three plotted points are located on the same straight line. In this first specific example, the known values are the two pairs of information (Sa, Ca) and (Sb, Cb), and the function value to be determined is the command value S at which the measurement value C becomes the target value Ss1. Here, this target value Ss1 is the grey-scale gradation value that is output when reading a color sample (darkness sample) representing the darkness of the above-noted reference value Ss with the scanner 100. This color sample represents an absolute reference of the darkness, that is, if the measurement value C measured by the scanner 100 is represented by the target value Ss1, then the measured object appears at the darkness of this reference value Ss.

As shown in FIG. 41, the two information pairs (Sa, Ca) and (Sb, Cb) are respectively expressed on the graph by a point A having the coordinates (Sa, Ca) and a point B having the coordinates (Sb, Cb). The straight line AB connecting these points A and B indicates the relation between the change of the command value S and the change of the measurement value C. Consequently, if the value So of the command value S at which the measurement value C becomes the target value Ss1 is read from this straight line AB, then this value So represents the command value S at which the measurement value C of the darkness becomes the target value Ss1. Now, if the command value S would be set to the reference value Ss, then the target value Ss1 should be obtained as the measurement value C, but actually the measurement value C does not reach the target value Ss1 unless the command value S is set to So. This deviation So-Ss between So and Ss is the correction amount ΔS. It should be noted however, that the correction value H needs to be given in the format of a correction ratio, as noted above, so that the value obtained by dividing the correction amount ΔS by the reference value Ss becomes the correction value H(=ΔS/Ss).

Incidentally, the following is the correction value H when expressed by an equation.

First, the straight line AB can be expressed by the following Equation 2.
C=[(Ca−Cb)/(Sa−Sb)]·(S−Sa)+Ca (Eq. 2)

If Equation 2 is solved for the command value S and the target value Ss1 is substituted for the measurement value C, then the command value So at which the measurement value C becomes the target value Ss1 can be expressed by Equation 3 below.
So=(Ss1−Ca)/[(Ca−Cb)/(Sa−Sb)]+Sa (Eq. 3)

On the other hand, the correction amount ΔS of the command value S is expressed by Equation 4, and the correction value is expressed by Equation 5.
ΔS=So−Ss (Eq. 4)
H=ΔS/Ss=(So−Ss)/Ss (Eq. 5)

Consequently, Equations 3, and 5 are the equations for finding the correction value H, and by substituting concrete values for Ca, Cb, Sa, Sb, and Ss1 in these Equations 3 and 5, it is possible to find the correction value H.

It should be noted that a program for calculating Equation 3 and Equation 5 is stored in the memory of the computer 1100 of the inspection line according to the first specific example. The computer 1100 reads the two pairs of information (Sa, Ca) and (Sb, Cb) from the same record of the recording table and substitutes these into Equations 3 to 5, and records the calculated correction value H in the record of the same record number in the correction value table.

(B) Second Specific Example of the Method for Setting the Darkness Correction Values

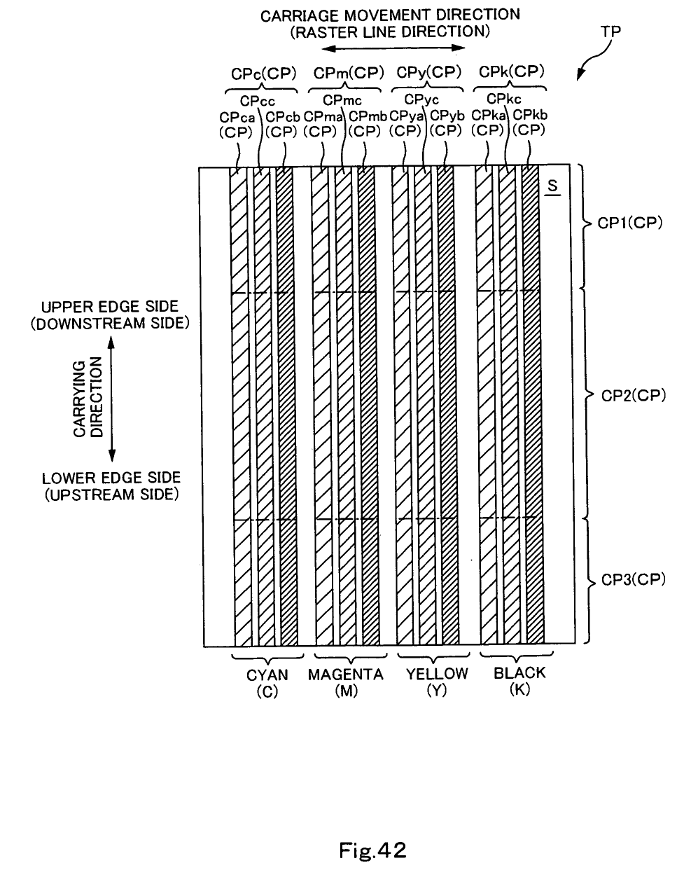

FIG. 42 shows a test pattern TP according to a second specific example printed on a paper S. In the above-described first specific example, two correction patterns CP with different darknesses were printed for each ink color as the test pattern TP, but the second specific example shown in FIG. 42 differs in that three correction patterns CP are printed for each of the CMYK ink colors, and a linear interpolation is carried out using the darkness measurement values Ca, Cb and Cc of these three correction patterns CP. Using these three measurement values Ca, Cb and Cc, it is possible to calculate the correction value H with even higher precision. It should be noted that other than this difference, the second specific example is similar to the above-described first specific example. Consequently, the following explanations focus on the differences, and content that is the same is explained only briefly. Furthermore, as for the first specific example, these explanations refer to the flowchart in FIG. 27.

(1) Step S121: Printing the Test Pattern

As shown in FIG. 42, three stripe-shaped correction patterns CP are formed on the paper S for each of the CMYK ink colors, as the test pattern TP. The respective correction patterns CP are printed such that their three darknesses differ. In the following explanations, black (K) is taken as a representative ink color.

As shown in FIG. 42, the two correction patterns CPka and CPkb of the three correction patterns are printed with the command values Sa and Sb of the same darkness as in the first specific example, whereas the remaining correction pattern CPkc is printed with a command value Sc that lies between these command values Sa and Sb. The reason why the correction patterns CPka, CPkb and CPkc are printed with command values for these three darknesses is that there is the possibility that the slope of the straight line AB differs between regions of high darkness and regions of low darkness, and in this case, this would lead to an interpolation error. This is explained further below.

(2) Step 122: Measuring the Darkness of the Correction Pattern for Each Raster Line

The darkness values of the three correction patterns CPka, CPkb and CPkc shown in FIG. 42 are measured raster line by raster line with the scanner 100, as in the first specific example. Then, these measurement values Ca, Cb and Cc are recorded in the recording table explained below.

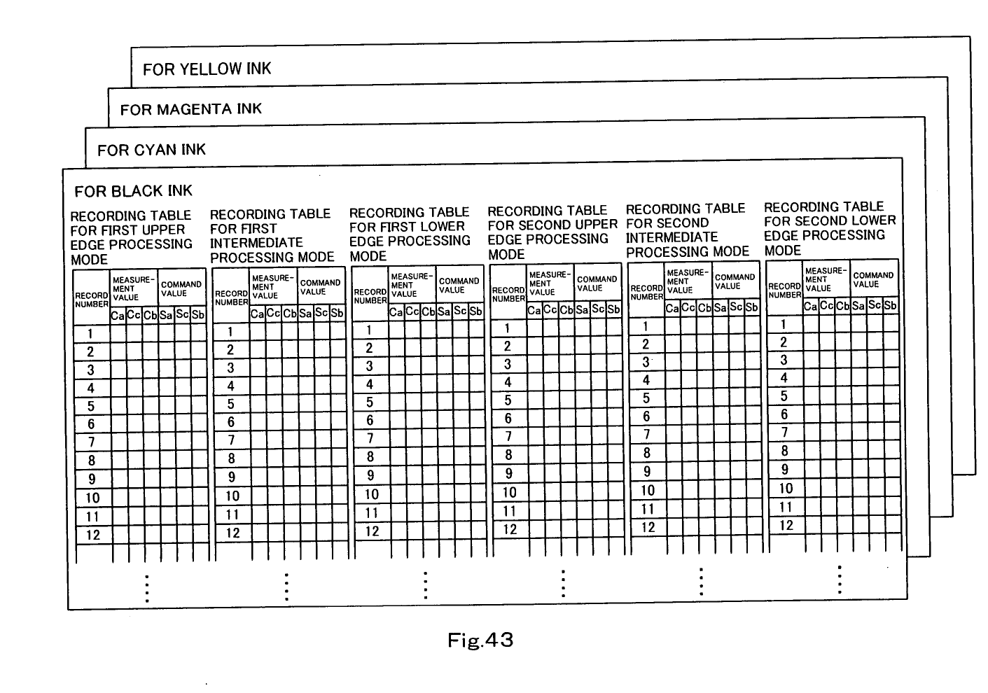

FIG. 43 shows the recording tables of the second specific example. In these recording tables, six fields are provided, so that the measurement values Ca, Cb and Cc of the three correction patterns CPka, CPkb and CPkc and the command values Sa, Sb and Sc corresponding to these measurement values can be recorded. In the records of the first field and the fourth field from the left of the table, the measurement value Ca and its command value Sa for the correction pattern CPka with the lower darkness are recorded. In the records of the third field and the sixth field, the measurement value Cb and its command value Sb for the correction pattern CPkb, which has a higher darkness, are recorded. In the records of the second field and the fifth field, the measurement value Cc and its command value Sc for the correction pattern CPkc, which has an intermediate darkness, are recorded. It should be noted that during this recording, the measurement values Ca, Cb and Cc and the command values Sa, Sb and Sc for the same raster line number of these two correction patterns CPka, CPkb and CPkc are, of course, recorded in records of the same record number.

(3) Step 123: Setting the Darkness Correction Values for Each Raster Line p Next, the correction value H is calculated by performing a linear interpolation using the three pairs of information (Sa, Ca), (Sb, Cb), and (Sc, Cc) of the command values Sa, Sb and Sc and the measurement values Ca, Cb and Cc recorded in the records of the recording tables, just like in the first specific example, and that correction value H is set in the correction value table.

It should be noted however, that in the linear interpolation of this second specific example, three pairs of information (Sa, Ca), (Sb, Cb) and (Sc, Cc) are used, so that the correction value H can be calculated with even higher precision than with the first specific example. That is to say, ordinarily, the slope of the straight line AB used for the above-described linear interpolation may differ between regions of high darkness and regions of low darkness. In this case, as in the above-described first specific example, it is not possible to calculate a suitable correction value H with the method using one straight line regardless of the extent of the darkness.

With the second specific example on the other hand, the linear interpolation is carried out using the two pairs of information (Sb, Cb) and (Sc, Cc) for the region of high darkness, whereas the linear interpolation is carried out using the two pairs of information (Sa, Ca) and (Sc, Cc) for the region of low darkness.

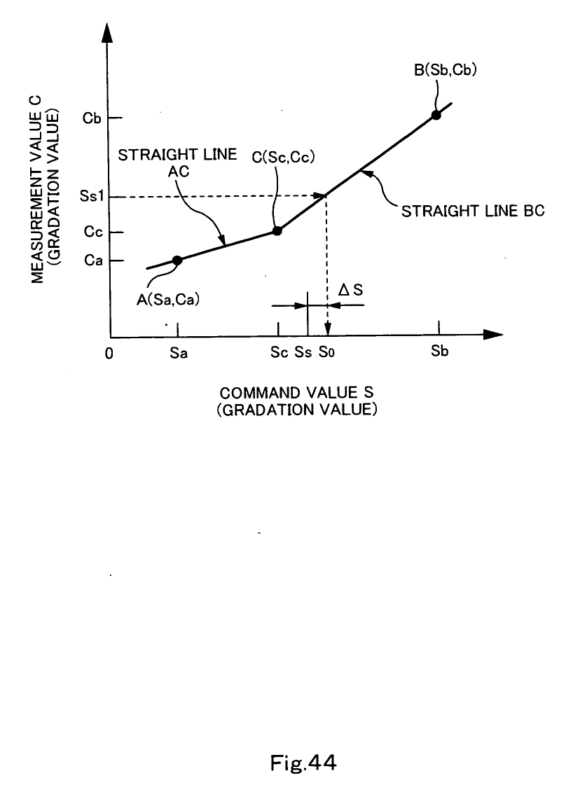

FIG. 44 is a graph illustrating the linear interpolation performed using these three pairs of information (Sa, Ca), (Sb, Cb), and (Sc, Cc). It should be noted that FIG. 44 is given in the same format as FIG. 41.

As shown in FIG. 44, the three pairs of information (Sa, Ca), (Sb, Cb), and (Sc, Cc) are each expressed on the graph by a point A having the coordinates (Sa, Ca), a point B having the coordinates (Sb, Cb), and a point C having the coordinates (Sc, Cc). The straight line BC connecting the two points B and C indicates the relationship between the change of the command value S and the change of the measurement value C in the range of high darkness, whereas the straight line AC connecting the two points A and C indicates the relationship between the change of the command value S and the change of the measurement value C in the range of low darkness.

Then, the value So of the command value S at which the measurement value C becomes the target value Ss1 is read from the graph constituted by these two lines AC and BC to determine the correction value H. For example, if the target value Ss1 is larger than the measurement value Cc of the point C as shown in the drawing, then a linear interpolation is carried out with the straight line BC, and the value So of the command value S at which the measurement value C becomes the target value Ss1 is determined. Conversely, if the target value Ss1 is smaller than the measurement value Cc of the point C, then a linear interpolation is carried out with the straight line AC, and the value So of the command value S at which the measurement value C becomes the target value Ss1 is determined. The deviation between the determined command value So and the reference value Ss is the correction amount ΔS, and the correction value H in the form of a correction ratio is calculated by dividing the correction amount ΔS by the reference value Ss. It should be noted that also the linear interpolation of this second specific example can be formalized in the same manner as the first specific example, and the formalized equations can be calculated by the program of the computer 1100 to calculate the correction value. Thus, further explanations thereof are omitted.

### Other Embodiments

The above embodiment was written primarily with regard to a printer, but the above embodiment of course also includes the disclosure of a printing apparatus, a printing method, and a printing system, for example.

Also, a printer, for example, serving as an embodiment was described above. However, the foregoing embodiment is for the purpose of elucidating the present invention and is not to be interpreted as limiting the present invention. The invention can of course be altered and improved without departing from the gist thereof and includes functional equivalents. In particular, the embodiments mentioned below are also included in the invention.

<Regarding the Printer>

In the above embodiments a printer was described, however, there is no limitation to this. For example, technology similar to that of the present embodiments can also be adopted for various types of recording apparatuses that use inkjet technology, including color filter manufacturing devices, dyeing devices, fine processing devices, semiconductor manufacturing devices, surface processing devices, three-dimensional shape forming machines, liquid vaporizing devices, organic EL manufacturing devices (particularly macromolecular EL manufacturing devices), display manufacturing devices, film formation devices, and DNA chip manufacturing devices. Also, these methods and manufacturing methods are within the scope of application.

<Regarding the Ink>

In the foregoing embodiment, dye ink or pigment ink was ejected from the nozzles. However, the ink that is ejected from the nozzles is not limited to such inks.

<Regarding the Nozzles>

In the foregoing embodiment, ink was ejected using piezoelectric elements. However, the mode for ejecting ink is not limited to this. Other methods, such as a method for generating bubbles in the nozzles through heat, may also be employed.

<Regarding the Print Modes>

The interlaced mode was described as an example of the print mode in the above embodiments, but the print mode is not limited to this, and it is also possible to use the so-called overlapping mode. With interlacing, a single raster line is formed by a single nozzle, whereas with overlapping, a single raster line is formed by two or more nozzles. That is, with the overlapping mode, each time the paper S is carried by a fixed carry amount F in the carrying direction, the nozzles, which move in the carriage movement direction, intermittently eject ink droplets every several pixels, intermittently forming dots in the carriage direction. Then, in another pass, dots are formed such that the intermittent dots already formed by the other nozzle are completed in a complementary manner. Thus, a single raster line is completed by a plurality of nozzles.

<Regarding the Carriage Movement Direction in which Ink is Ejected>

The foregoing embodiment describes an example of single-direction printing in which ink is ejected only when the carriage is moving forward, but this is not a limitation, and it is also possible to perform so-called bidirectional printing in which ink is ejected both when the carriage is moving forward and backward in both directions.

<Regarding the Color Inks Used for Printing>

In the foregoing embodiments, examples of multicolor printing are described in which the four color inks cyan (C), magenta (M), yellow (Y), and black (K) are ejected onto the paper S to form dots, but the ink colors are not limited to these. For example, it is also possible to use other inks in addition to these, such as light cyan (LC) and light magenta (LM).

Alternatively, it is also possible to perform single-color printing using only one of these four colors.

<Other Considerations>

In the foregoing embodiments, the case of borderless printing, that is, the case of printing without a margin at the upper edge and the lower edge in the carrying direction of the paper has been explained as an example of upper edge and lower edge processing, but in the widest sense, upper edge and lower edge processing simply means processing that is applicable for printing an image at the upper edge and the lower edge. Consequently, it is also possible to carry out bordered printing with a margin at the upper edge and the lower edge, using this upper edge processing and lower edge processing. It should be noted that in this case, compared to the case that the upper edge processing and the lower edge processing shown in FIGS. 22A and 22B are not performed, the operational effect is attained that the non-printable region is reduced, as shown in FIGS. 21A and 21B.

In the foregoing embodiments, the upper edge processing was explained as including a process of printing using only the nozzles #1 to #3 arranged in opposition to the groove 24a and a process of transitioning from this process to the intermediate process, but in the most narrow sense, each of these two processes can be defined as upper edge processing.

For example, in the example of borderless printing shown in FIG. 21A, it is possible to define only the process of the first four passes (first pass to fourth pass) of printing using only the nozzles #1 to #3 arranged in opposition to the groove 24a as upper edge processing in a narrow sense and to define the process of the last four passes (fifth to eighth pass) of transitioning from the upper edge processing to the intermediate processing while printing by gradually increasing the number of nozzles used to #1 to #7 as upper edge transition processing.

Furthermore, in the case of bordered printing, it is possible to start printing without performing the processing of the first four passes and performing only the upper edge transition processing of the last four passes, and in this case, the upper edge transition processing can also be defined as upper edge processing in the narrow sense. With this upper edge processing, the operational effect of reducing the non-printable region can be attained. It should be noted that if the upper edge transition processing is defined as upper edge processing in the narrow sense, then the upper edge processing of the foregoing embodiments as shown in FIG. 21A can also be taken to include both upper edge processing for printing an image without margin (the processing of the first four passes) and upper edge processing for printing an image with a margin (the processing of the latter four passes).

Needless to say, these definitions can also be applied mutatis mutandis to the lower edge processing. That is to say, the lower edge processing of the foregoing embodiments was explained as including a process of printing using only the nozzles #5 to #7 arranged in opposition to the groove 24b and a process of transitioning to this process from the intermediate process, but in the most narrow sense, each of these two processes can be defined as lower edge processing.

For example, in the example of borderless printing shown in FIG. 21B, it is possible to define only the process of the last five passes (fourth pass to eighth pass) of printing using only the nozzles #5 to #7 arranged in opposition to the groove 24b as lower edge processing in the narrow sense and to define the process of the first three passes (first to third pass) of transitioning to the lower edge processing from the intermediate processing while printing by gradually decreasing the number of nozzles used from #1 to #7 as lower edge transition processing.

Furthermore, in the case of bordered printing, it is possible to stop printing without performing the last five passes mentioned above and performing only the lower edge transition processing of the first three passes, and in this case, the lower edge transition processing can also be defined as lower edge processing in the narrow sense. With this lower edge processing, the operational effect of reducing the non-printable region can be attained. It should be noted that if the lower edge transition processing is defined as lower edge processing in the narrow sense, then the lower edge processing of the foregoing embodiments as shown in FIG. 21B can also be taken to include both lower edge processing for printing an image with margin (the processing of the first three passes) and lower edge processing for printing an image without margin (the processing of the latter five passes).

In the foregoing embodiments, the correction patterns CP were formed for all processing modes, namely the first upper edge processing mode, the first intermediate processing mode, the first lower edge processing mode, the second upper edge processing mode, the second intermediate processing mode, and the second lower edge processing mode, recording the correction values in the correction value tables, but there is no limitation to this.

For example, it is also possible not to form a correction pattern CP for the second upper edge processing mode, the second intermediate processing mode, and the second lower edge processing mode, in which images are printed at a lower print resolution, that is, not to record correction values in the corresponding correction value tables. Further, in this case, since there are no corresponding correction values, the actual printing is carried out without performing the above-described darkness correction, so that the actual printing can be carried out faster as this correction is not carried out.

In the foregoing embodiments, only a correction pattern CP for measuring the darkness for each raster line was printed on the paper S, but there is no limitation to this. For example, it is also possible to print ruled lines extending along the raster line direction onto the white space to the side of the correction pattern CP, in correspondence with certain raster line numbers. If this is done, then it is possible to specify the raster lines during the darkness measurement in the correction pattern CP by the ruled lines, and thus, the correspondence between the raster lines and the measurement values obtained through this measurement can be made easy and reliable.

In the foregoing embodiments, the method for correcting the pixel data in the halftone processing has been explained to be the method of using an existing dot creation ratio table and to read out the level data while offsetting them by the correction values when reading the level data corresponding to the gradation values of the pixel data from this creation ratio table, but there is no limitation to this.

For example, it is also possible to prearrange a plurality of dot creation ratio tables, for each of a plurality of predetermined correction values, in which the level data are changed by an amount corresponding to the correction value, and to correct the pixel data by directly reading out the level data corresponding to the gradation value of the pixel data from those creation ratio tables. With this configuration, it is sufficient to simply read out the level data corresponding to the gradation values of the pixel data from the dot creation ratio tables, so that the time required for the correction of the pixel data can be shortened.

The test pattern TP of the foregoing first embodiment includes correction patterns CP for all processing modes, namely the first upper edge processing mode, the first intermediate processing mode, the first lower edge processing mode, the second upper edge processing mode, the second intermediate processing mode, and the second lower edge processing mode, and the correction values in the correction value table are recorded based on these correction patterns CP, but there is no limitation to this.

For example, it is also possible not to form a correction pattern CP for the second upper edge processing mode, the second intermediate processing mode, and the second lower edge processing mode, in which images are printed at a lower print resolution, that is, not to record correction values in the corresponding correction value tables. Further, in this case, since there are no corresponding correction values, the actual printing is carried out without performing the above-described darkness correction, so that the actual printing can be carried out faster as this correction is not carried out.

In the first specific example according to the above-described second embodiment, the reference value Ss is positioned between the two information pairs (Sa, Ca) and (Sb, Cb), and the command value So at which the measurement value C becomes the target value Ss1 is determined by interpolation, but there is no limitation to this. For example, it is also possible to position the reference value Ss outside the two information pairs (Sa, Ca) and (Sb, Cb) and to determine the command value So at which the measurement value C becomes the target value Ss1 by extrapolation. However, in this case, the precision is poorer than with interpolation.

In the first specific example of the above-described second embodiment, the command values Sa and Sb of the darkness of the correction patterns CPka and CPkb are set such that the reference value Ss becomes a middle value, but it is also possible to set one of the command values Sa and Sb such that one of them becomes the reference value Ss. If this is done, then one of the measurement values Ca and Cb of the darkness of the correction patterns CPka and CPkb can be obtained as the value near the target value Ss1. Moreover, the command value So corresponding to the target value Ss1 is determined by performing a linear interpolation using the measurement value near this target value Ss1, so that the interpolation precision improves by the amount that the measurement value is closer to the target value Ss1. Thus, the precision of the determined command value So is improved. As a result, the precision of the correction value H that is determined by this linear interpolation increases.

In the second specific example according to this second embodiment, the command value Sc set to a value between the command value Sa and the command value Sb is set to a value different from the reference value Ss, but it may also be set to the same value as the reference value Ss. If this is done, then the measurement value Cc of the darkness of the correction patterns CPkc can be obtained as a value near the target value Ss1. Moreover, the command value So corresponding to the target value Ss1 is determined by performing a linear interpolation using the measurement value Cc near this target value Ss1, so that the interpolation precision improves by the amount that the measurement value Cc is closer to the target value Ss1. Thus, the precision of the determined command value So is improved. As a result, the precision of the correction value H that is determined by this linear interpolation increases.

In the second specific example according to the above-described second embodiment, the measurement value of the darkness of a color sample of the reference value Ss was used as the value of the target value Ss1 for reading the command value So in the linear interpolation, but there is no limitation to this. For example, it is also possible to use the average value, across all raster lines, of the measurement values Cc, which is in the middle of the measurement values Ca, Cb, Cc of the three points, as the target value Ss1. If this is done, then it is possible to determine the correction value with even higher correction precision through linear interpolation.

In the foregoing embodiment, a scanner 100 that is separate from the printer 1 was used as the darkness measurement device, and after the printing of the correction pattern CP with the printer 1 is finished, the darkness measurement was performed with this scanner 100, but there is not limitation to this.

For example, it is also possible that sensors for measuring darkness optically are attached on the downstream side of the head 41 in the carrying direction of the paper S, and that the darkness of the printed correction pattern CP is measured with these sensors in parallel to performing the operation of printing the correction pattern CP.

1. A printing method for printing an image onto a medium, the method comprising:
printing a correction pattern by ejecting ink from a plurality of nozzles moving in a predetermined movement direction and forming, in an intersecting direction intersecting the movement direction, a plurality of lines extending along the movement direction and constituted by a plurality of dots;
measuring a darkness of the correction pattern line by line; and
printing the image with a plurality of the lines formed in the intersecting direction, while correcting the darkness of each line in accordance with correction values each corresponding to the darkness of each of the measured lines.

2. A printing method according to claim 1,
wherein a plurality of the lines are formed in the intersecting direction by repeating in alternation a dot formation operation of forming dots on the medium by ejecting ink from a plurality of the nozzles moving in the movement direction and a carrying operation of carrying the medium in the intersecting direction.

3. A printing method according to claim 2,
wherein a printing apparatus printing the image onto the medium,
includes a plurality of types of processing modes for respectively executing print processes in which at least one of the carrying operation and the dot formation operation differs;
prints, with at least two of the processing modes, a correction pattern corresponding to each of the processing modes on a medium, and has the correction values, which are obtained by measuring the darkness of the correction pattern line by line, in correspondence with each line; and
corrects the darkness of the image line by line, in accordance with the correction values corresponding to each line of the image, when printing the image in any of the processing modes with which the correction pattern was printed.

4. A printing method according to claim 3,
wherein the correction pattern corresponding to each of the processing modes is printed to fit on a single medium.

5. A printing method according to claim 1,
wherein a plurality of the nozzles is lined up along the intersecting direction to constitute a nozzle row.

6. A printing method according to claim 5,
wherein a printing apparatus printing the image onto the medium comprises the nozzle row for each color of ink;
the correction value is prepared for each of the colors by printing the correction pattern for each of the colors; and
the darkness of the image is corrected color by color, based on the correction values for each of the colors.

7. A printing method according to claim 3,
wherein the at least two processing modes include at least either a downstream edge processing mode for printing an image at an edge portion on a downstream side, with respect to the intersecting direction, of the medium, and an upstream edge processing mode for printing an image at an edge portion on an upstream side, with respect to the intersecting direction, of the medium.

8. A printing method according to claim 7,
wherein the downstream edge processing mode and the upstream edge processing mode respectively are modes for printing an image provided without a margin at the edge portion.

9. A printing method according to claim 7,
wherein the downstream edge processing mode and the upstream edge processing mode respectively include modes for printing an image provided with a margin at the edge portion.

10. A printing method according to claim 7,
wherein the correction pattern printed by the upstream edge processing mode is printed at the edge portion on the upstream side of the medium.

11. A printing method according to claim 7,
wherein the correction pattern printed by the downstream edge processing mode is printed at the edge portion on the downstream side of the medium.

12. A printing method according to claim 7,
wherein the at least two processing modes include an intermediate processing mode for printing an image on a portion between the edge portion on the upstream side of the medium and the edge portion on the downstream side of the medium with respect to the intersecting direction.

13. A printing method according to claim 12,
wherein the intermediate processing mode and at least one of the downstream edge processing mode and the upstream edge processing mode have a different carry amount in the carrying operation.

14. A printing method according to claim 1,
wherein there is also a correction value for a region that is judged to be further upstream than the edge portion on the upstream side, or for a region that is judged to be further downstream than the edge portion on the downstream side in the intersecting direction of the medium on which the image is printed; and
this correction value is obtained by arranging the medium at a position corresponding to the region, printing the correction pattern on this medium, and measuring the darkness of this correction pattern line by line.

15. A printing method according to claim 1,
wherein ruled lines extending along the movement direction for specifying a line during the measurement when measuring the darkness of the correction pattern line by line are formed in the correction pattern at a predetermined spacing in the intersecting direction.

16. A printing method according to claim 1,
wherein image data for printing the image is prepared, and the image data has a gradation value of the darkness for each dot formation unit formed on the medium;
if a correction value is not associated with the formation units,
then a creation ratio corresponding to the gradation value of the formation units is read from a creation ratio table in which gradation values are associated with dot creation ratios, and dots are formed in the formation units on the medium in accordance with the read creation ratio; and
if a correction value is associated with the formation units,
then when reading the creation ratio corresponding to the gradation value from the creation ratio table, the creation ratio corresponding to a value obtained by changing the gradation value by the correction value is read, and dots are formed in the formation units on the medium in accordance with the read creation ratio.

17. A printing method according to claim 1,
wherein image data for printing the image is prepared, and the image data has a gradation value of the darkness for each dot formation unit formed on the medium;
if a correction value is not associated with the formation units,
then a creation ratio corresponding to the gradation value of the formation units is read from a creation ratio table in which gradation values are associated with dot creation ratios, and dots are formed in the formation units on the medium in accordance with the read creation ratio; and
if a correction value is associated with the formation units,
then a dot creation ratio corresponding to the gradation value of the formation unit is read from a creation ratio table obtained by changing the creation ratio of the above-mentioned creation ratio table by the correction value, and dots are formed in the formation units on the medium in accordance with the read creation ratio.

18. A printing method according to claim 16,
wherein the dot creation ratio indicates a proportion of a number of dots formed inside a region that has a uniform gradation value and that is provided with a predetermined number of the formation units, to that predetermined number.

19. A printing method according to claim 1,
wherein all lines in the correction pattern are printed based on the same gradation value.

20. A printing method according to claim 19,
wherein an average value, across all lines, of darkness measurement values measured line by line is taken as a target value of darkness; and
a correction ratio obtained by dividing a deviation between this target value and the darkness measurement value of each line by the target value is taken as the correction value.

21. A printing method according to claim 16,
wherein the nozzles can form dots of a plurality of sizes; and
the relation between the creation ratios and the gradation values is given for each of the sizes in the creation ratio table.

22. A printing method according to claim 1,
wherein a darkness of the correction pattern is measured optically using a darkness measurement device.

23. A printing method according to claim 3,
wherein the print processes in which the carrying operation differs from one another are print processes in which the pattern according to which the carry amount of each carrying operation changes is different from one another; and
the print processes in which the dot formation operation differs from one another are print processes in which the pattern according to which the nozzles that is used in each dot formation operation changes is different from one another.

24. A printing method for printing an image onto a medium, the method comprising:
printing a correction pattern by ejecting ink from a plurality of nozzles moving in a predetermined movement direction and forming, in an intersecting direction intersecting the movement direction, a plurality of lines extending along the movement direction and constituted by a plurality of dots;
measuring a darkness of the correction pattern line by line; and
printing the image with a plurality of the lines formed in the intersecting direction, while correcting the darkness of each line in accordance with correction values each corresponding to the darkness of each of the measured lines;
wherein a plurality of the lines are formed in the intersecting direction by repeating in alternation a dot formation operation of forming dots on the medium by ejecting ink from a plurality of the nozzles moving in the movement direction and a carrying operation of carrying the medium in the intersecting direction;
a printing apparatus printing the image onto the medium,
includes a plurality of types of processing modes for respectively executing print processes in which at least one of the carrying operation and the dot formation operation differs;
prints, with at least two of the processing modes, a correction pattern corresponding to each of the processing modes on a medium, and has the correction values, which are obtained by measuring the darkness of the correction pattern line by line, in correspondence with each line; and
corrects the darkness of the image line by line, in accordance with the correction values corresponding to each line of the image, when printing the image in any of the processing modes with which the correction pattern was printed;
the correction pattern corresponding to each of the processing modes is printed to fit on a single medium;
a plurality of the nozzles is lined up along the intersecting direction to constitute a nozzle row;
a printing apparatus printing the image onto the medium comprises the nozzle row for each color of ink, the correction value is prepared for each of the colors by printing the correction pattern for each of the colors, and the darkness of the image is corrected color by color, based on the correction values for each of the colors;
the at least two processing modes include at least either a downstream edge processing mode for printing an image at an edge portion on a downstream side, with respect to the intersecting direction, of the medium, and an upstream edge processing mode for printing an image at an edge portion on an upstream side, with respect to the intersecting direction, of the medium;
the downstream edge processing mode and the upstream edge processing mode respectively are modes for printing an image provided without a margin at the edge portion;
the correction pattern printed by the upstream edge processing mode is printed at the edge portion on the upstream side of the medium;
the correction pattern printed by the downstream edge processing mode is printed at the edge portion on the downstream side of the medium;
the at least two processing modes include an intermediate processing mode for printing an image on a portion between the edge portion on the upstream side of the medium and the edge portion on the downstream side of the medium with respect to the intersecting direction;
the intermediate processing mode and at least one of the downstream edge processing mode and the upstream edge processing mode have a different carry amount in the carrying operation;
there is also a correction value for a region that is judged to be further upstream than the edge portion on the upstream side, or for a region that is judged to be further downstream than the edge portion on the downstream side in the intersecting direction of the medium on which the image is printed; and
this correction value is obtained by arranging the medium at a position corresponding to the region, printing the correction pattern on this medium, and measuring the darkness of this correction pattern line by line;
ruled lines extending along the movement direction for specifying a line during the measurement when measuring the darkness of the correction pattern line by line are formed in the correction pattern at a predetermined spacing in the intersecting direction;
image data for printing the image is prepared, and the image data has a gradation value of the darkness for each dot formation unit formed on the medium;
if a correction value is not associated with the formation units,
then a creation ratio corresponding to the gradation value of the formation units is read from a creation ratio table in which gradation values are associated with dot creation ratios, and dots are formed in the formation units on the medium in accordance with the read creation ratio; and
if a correction value is associated with the formation units,
then when reading the creation ratio corresponding to the gradation value from the creation ratio table, the creation ratio corresponding to a value obtained by changing the gradation value by the correction value is read, and dots are formed in the formation units on the medium in accordance with the read creation ratio;
the dot creation ratio indicates a proportion of a number of dots formed inside a region that has a uniform gradation value and that is provided with a predetermined number of the formation units, to that predetermined number;
all lines in the correction pattern are printed based on the same gradation value;
an average value, across all lines, of darkness measurement values measured line by line is taken as a target value of darkness; and
a correction ratio obtained by dividing a deviation between this target value and the darkness measurement value of each line by the target value is taken as the correction value;
the nozzles can form dots of a plurality of sizes, and
the relation between the creation ratios and the gradation values is given for each of the sizes in the creation ratio table;
a darkness of the correction pattern is measured optically using a darkness measurement device;
the print processes in which the carrying operation differs from one another are print processes in which the pattern according to which the carry amount of each carrying operation changes is different from one another; and
the print processes in which the dot formation operation differs from one another are print processes in which the pattern according to which the nozzles that is used in each dot formation operation changes is different from one another.

25. A printing apparatus printing an image onto a medium, comprising:
nozzles for ejecting ink; and
a controller for making a plurality of the nozzles that move in a predetermined movement direction eject ink to form, in an intersecting direction intersecting the movement direction, a plurality of lines extending along the movement direction and constituted by a plurality of dots, to print a correction pattern, the controller printing the image with a plurality of the lines formed in the intersecting direction, while correcting a darkness of each of the lines in accordance with correction values each corresponding to a darkness of each line in the correction pattern.

26. A printing system, comprising:
a computer; and
(a printing apparatus connected communicably to the computer; the printing apparatus including:
nozzles for ejecting ink; and
a controller for making a plurality of the nozzles that move in a predetermined movement direction eject ink to form, in an intersecting direction intersecting the movement direction, a plurality of lines extending along the movement direction and constituted by a plurality of dots, to print a correction pattern, the controller printing the image with a plurality of the lines formed in the intersecting direction, while correcting a darkness of each of the lines in accordance with correction values each corresponding to a darkness of each line in the correction pattern.

27. A test pattern comprising:
a correction pattern constituted by a plurality of lines;
wherein the correction pattern is printed by ejecting ink from a plurality of nozzles moving in a predetermined movement direction and forming, in an intersecting direction intersecting the movement direction, a plurality of lines extending along the movement direction and constituted by a plurality of dots; and
a darkness of the correction pattern is measured line by line in order to obtain correction values each corresponding to the darkness of each line.

28. A printing method according to claim 17,
wherein the dot creation ratio indicates a proportion of a number of dots formed inside a region that has a uniform gradation value and that is provided with a predetermined number of the formation units, to that predetermined number.

29. A printing method according to claim 17,
wherein the nozzles can form dots of a plurality of sizes; and
the relation between the creation ratios and the gradation values is given for each of the sizes in the creation ratio table.
